(19) United States
(12) Patent Application Publication
(10) Pub. No.: US 2009/0049422 A1
(43) Pub. Date: Feb. 19, 2009

(54) METHOD AND SYSTEM FOR MODELING AND DEVELOPING A SOFTWARE APPLICATION

(76) Inventors: Joseph Hage, Reno, NV (US); Raymond Lin, San Jose, CA (US); Craig H. Macy, Reno, NV (US)

Correspondence Address: HOLLAND & HART, LLP, P.O BOX 8749, DENVER, CO, 80201, US

(21) Appl. No.: 12/119,471

(22) Filed: May 12, 2008

Related U.S. Application Data
(60) Provisional application No. 60/928,925, filed on May 10, 2007.
(60) Provisional application No. 60/975,740, filed on Sep. 27, 2007.

(51) Int. Cl. G06F 9/44

(52) U.S. Cl. 717/104

(57) ABSTRACT

A method and system for modeling and developing software applications. Modeling and developing a programmatic interface includes defining an application framework with property, behavior and event elements, creating enabling services and system entities each including at least one element, listing the enabling services and system entities themselves as elements, providing a user interface that enables a user to define business entities, include such entities among the elements, and define relationships among entities created by the user and the elements, and generating a software application that provides the programmatic interface.

### RELATED CASES

This patent application claims priority from Provisional patent application No. 60/928,925 filed 10 May 2007, the entire contents of which are incorporated herein by this reference, and from Provisional patent application No. 60/975,740 filed 27 Sep. 2007, the entire contents of which are incorporated herein by this reference.

### BACKGROUND

This invention relates to computers, and particularly to ways of creating software applications for computers.

Every computer has a basic set of components including a central processor, an input such as a keyboard, an output such as a display, memory such as a magnetic disc or a random—access memory, and a computer program that makes the other components do something useful. Of course, many computers have several such components, and one computer may have hundreds of programs. Some of these programs are very simple. Some work in isolation. Others are more complex and are commonly referred to as software applications; an example is a computer game such as Tetris.

Many software applications do not work in isolation; rather, they interact with each other. An example is a word processor such as Microsoft Word that may include a text editing application, a help application, a dictionary application (for spell checking), an arithmetic application (for keeping count of pages and words), and so on. A more complex example is an airline reservation system that may include a database application to keep track of customer names and contact details, an accounting application to compute fares, an application to collect fares by interacting with a computer system of a credit card issuer, etc.

Creating new software applications has grown more difficult as the desired uses have become more sophisticated and the frameworks and technology for implementing them have become more complex. Working successfully in this environment has come to require technical knowledge of database design, entity relationships, object modeling, graphical user interfaces, middleware technology, programming languages, operating systems, prototyping tools, and the like.

A person who wants to develop a new software application often has a clear vision of a desired end result. In a business setting, the opportunity may be fleeting, the market window small, the funding limited, and the programming talent unavailable or hard to find. Establishing a development environment and a knowledgeable team capable of tackling a large design project has never been easy. Business opportunities have actually been lost because of the time, effort and expense involved in creating a needed software application.

The traditional way to create new software has been to write it in a programming language. The first programs were written in low-level languages such as assembly language, a tedious process at best even for very simple programs. Higher-level languages such as BASIC, FORTRAN and C were a substantial improvement but have not solved the problem of simplifying and accelerating the development of new software applications.

Many solutions have been proposed. One of these is object-oriented programming (OOP). The basic concept of OOP is to write software according to a model of objects to be represented. Many software applications have been created using an OOP language such as C++, C#, Visual Basic or Java. An “object” in such an application is typically a structured software entity having attributes (data) and functions (methods). For example, in a computer card game, there might be a “dealer” object and a “player” object. The dealer object has attributes such as number of players and current state of the card deck and functions such as shuffling the deck and dealing the cards. The player object has attributes such as name of player and functions such as placing bets. OOP focuses on modeling real-world interactions and attempts to create “verbs” and “nouns” which can be used in intuitive ways, ideally by end users as well as by programmers coding for those end users. There are numerous textbooks and other references covering various aspects of OOP, of which two recent examples are Daniel Solis, Illustrated C# 2008, A press (Springer-Verlag) 2008, ISBN-13: 978-1-59059-954-9, page 47, and Patrice Pelland, Build a Program Now! Microsoft Visual Basic 2008, Microsoft Press 2008, ISBN-13: 978-0-7356-2541-9, page 5.

Many OOP languages are instances of fourth-generation languages (4GL), and these are discussed in many references such as McNurlin & Sprague, Information Systems Management in Practice (6th Ed.), Prentice-Hall 2003, ISBN 0-13-101139-1, Chapter 9, “Technologies for Developing Systems”. Internet references for 4GL that were current as of the filing date of this application include:
http://en.wikipedia.org/wiki/4GL,
http://findarticles.com/p/articles/mi_m0SMG/is_n11_v18/ai_{—}21105586,
http://www.sybase.com products/development/powerbuilder,
http://www.salesforce.com/platform,
http://www.djangoproject.com,
http://www.etelos.com/about/about.espx?show=13307&tab 1=on, and
http://www.genexus.com portal/hgxpp001.aspx?2,31,591,OE,0,MNU;E;130;6;MNU.

Component-based software engineering, also known as component-based development and as software componentry, is a branch of software engineering that practices decomposition of a system into functional or logical components with well-defined interfaces. A component represents a higher level of abstraction than an object. Unlike objects, components can share state and communicate by exchanging messages carrying data. A feature of a component, compared to devices such as procedures, functions or objects, is that a component is a run-time reusable entity as opposed to a design-time reusable entity. This type of software design states that software should be developed by gluing prefabricated components together, as is often done in such fields as electronics and mechanics. This type of design is often considered as a new kind of programming and is not readily adaptable to end-user design.

Another approach makes use of “best-of-breed” components and libraries. Some Internet references that were current as of the filing date of this application include:
http://www.rpath.com/corp/resources/Why-rPath-Registration.html, http://www.ilog.com/, and
http://www.acresso.com/products/licensing/flexnet_manager.htm.

Many attempts have been made to make it easier to develop software applications. Aspects of some of these attempts are described in the following U.S. patents and published patent applications:
U.S. Pat. No. 5,642,511, “System and method for providing a visual application builder framework”, Chow et al.;
U.S. Pat. No. 6,182,277, “Methods and apparatus for declarative programming techniques in an object oriented environment”, DeGroot et al.;
U.S. Pat. No. 6,199,195, “Automatically generated objects within extensible object frameworks and links to enterprise resources”, Goodwin et al.;
U.S. Pat. No. 6,560,770, “Extending the attributes of an application generated using a fourth generation programming tool”, Saxena et al.;
U.S. Pat. No. 6,564,368, “System and method for visual application development without programming, Beckett et al.;
U.S. Pat. No. 6,789,252, “Building business objects and business software applications using dynamic object definitions of ingrediential objects”, Burke et al.;
U.S. Pat. No. 7,020,869, “Business rules user interface for development of adaptable enterprise applications”, Abrari et al.;
U.S. Pat. No. 7,047,518, “System for software application development and modeling”, Little et al;
U.S. Pat. No. 7,089,583, “Method and apparatus for a business applications server”, Mehra et al.;
U.S. Pat. No. 7,203,938, “Development tool, method, and system for client server applications”, Ambrose et al.;
U.S. Pat. No. 7,266,565, “Table-oriented application development environment”, Diab;
U.S. Published Application 2004/0,181,771 A1, “Framework for supporting business software applications”, Anonsen et al.;
U.S. Published Application 2005/0,027,559 A1, “Generic framework for applying object-oriented models to multi-tiered enterprise applications”, Rajan et al; and
U.S. Published Application 2005/0,154,742 A1, “Business software application generation system and method”, Roth et al.
   There is still a need for an efficient way to develop software applications.

### SUMMARY OF THE INVENTION

Briefly and in general terms, the invention resides in a method and system of developing software applications. A method of developing a programmatic interface includes defining an application framework with property, behavior and event elements, creating enabling services each a conceptual representation of an operational capability, each such service including among its characteristics at least one element, creating system entities each a conceptual representation of an object, each such entity including among its characteristics at least one elements, including these services and entities among the elements such that any of them can include among its characteristics any other, providing a user interface that enables a user to define business entities, include such entities among the elements, and define relationships among entities created by the user and the elements, and generating a software application that provides the programmatic interface.

An environment for developing a programmatic interface in a computer system includes predefined enabling services and system entities, a user interface by which a user can define a business entities and relationships among business entities, system entities and enabling services, and an engine that generates a software application implementing any business entities and relationships defined by the user in the programmatic interface.

### BRIEF DESCRIPTION OF THE DRAWINGS

FIG. 1 is a diagrammatic flow chart of a method embodying the invention.

FIG. 2 is an environment for developing a software application according to the principles of the invention.

FIG. 3 is a conceptual representation of embodiments of the invention.

FIG. 4 shows examples of system entities (also referred to herein as business entities).

FIG. 5 shows examples of enabling services.

FIG. 6 shows representations of business entities and entity types.

FIG. 7 shows representations of enabling services and entity types.

FIG. 8 shows implementations of both entities and services as entity types.

FIG. 9 shows a pool of entity types.

FIG. 10 shows the “Auditing” Enabling Service composed of one base Entity Type and three other sub-Entity Types.

FIG. 11 shows definitions of enabling services in an entity types pool.

FIG. 12 is a general illustration of logic in embodiments of the invention.

FIGS. 13, 14 and 15 illustrate aspects of the Type System.

FIG. 16 shows base entity types.

FIG. 17 shows a value entity boxed into a named entity.

FIG. 18 shows a named entity.

FIG. 19 shows view entities.

FIG. 20 shows a container entity.

FIG. 21 shows details of a container entity.

FIG. 22 illustrates inheritance.

FIG. 23 shows a data engine.

FIG. 24 shows details of a data engine.

FIG. 25 shows management of entity concurrency.

FIG. 26 show storage of a commit count when an entity is loaded.

FIG. 27 depicts a “dirty buffer”.

FIG. 28 shows entity caching.

FIG. 29 shows entity referencing.

FIG. 30 shows a Where-Used relation.

FIG. 31 shows details of the Where-Used relation.

FIG. 32 shows transaction stacks.

FIG. 33 shows a mapping between entity types and generated classes.

FIG. 34 shows an algorithm to create an entity type.

FIG. 35 shows an algorithm to delete an entity type.

FIG. 36 illustrates localization.

FIG. 37 shows two available versions of a property.

FIG. 38 illustrates an aspect of Notification.

FIG. 39 illustrates another aspect of Notification.

FIG. 40 illustrates resource examples.

FIG. 41 shows search engine enabling service.

FIG. 42 shows the append method.

FIG. 43 illustrates file management enablement service.

FIG. 44 illustrates a relationship between file repositories and schemas.

FIG. 45 illustrates tokens in file management.

FIG. 46 illustrates version control enabling service.

FIG. 47 shows categorization of events.

FIG. 48 illustrates multiple schema support.

FIG. 49 illustrates method invocation.

FIG. 50 shows a web publishing method.

FIGS. 51 through 57 are screen shots demonstrating use of an embodiment of the invention.

### DESCRIPTION OF THE EMBODIMENTS

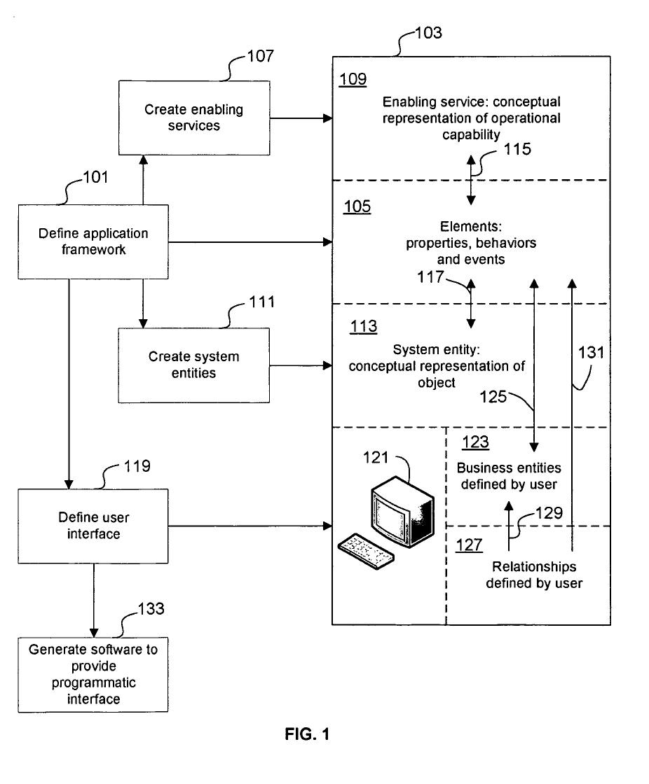

Broadly, the invention provides a method and system for modeling and developing a software application. FIG. 1 illustrates, in a diagrammatic flow chart, an embodiment of a method of developing a programmatic interface according to the principles of the invention. The method includes defining (101) an application framework (depicted diagrammatically as 103) that includes a plurality of property, behavior and event elements 105.

The method includes creating (107) a set of enabling services 109, and creating (111) a set of system entities 113 in the application framework 103. Each enabling service is a conceptual representation of an operational capability and includes among its characteristics one or more of the included elements 105 as indicated by a line 115 between the enabling services 109 and the elements 105. Similarly, each system entity is a conceptual representation of an object and includes among its characteristics one or more of the included elements 105 as indicated by a line 117 between the entities 113 and the elements 105. Each such service and entity is itself listed among the elements such that any service or entity can include among its characteristics any other of said services and entities, as indicated by the bidirectional arrowheads on the lines 115 and 117.

A user interface is defined (119) in the application framework 103. This user interface is indicated conceptually as a computer terminal 121, but the interface need not be embodied in hardware. The interface enables a user to define one or more business entities 123 each of which can include among its characteristics any of the elements as indicated by a line 125 between the business entities 123 and the elements 105. The user can choose to include any such business entity among the elements so that the business entity can thereupon be included as a characteristic of any other business entity defined by the user, as indicated by the bidirectional arrowheads on the line 125.

The user also can define relationships 127 among any business entities 123 defined by the user and any of the elements 105 as indicated by a line 129 between the business entities 123 and the elements 105 and a line 131 between the relationships 127 and the elements 105.

Then a software application that includes the business entities and relationships defined by the user is generated (133) to provide the desired programmatic interface.

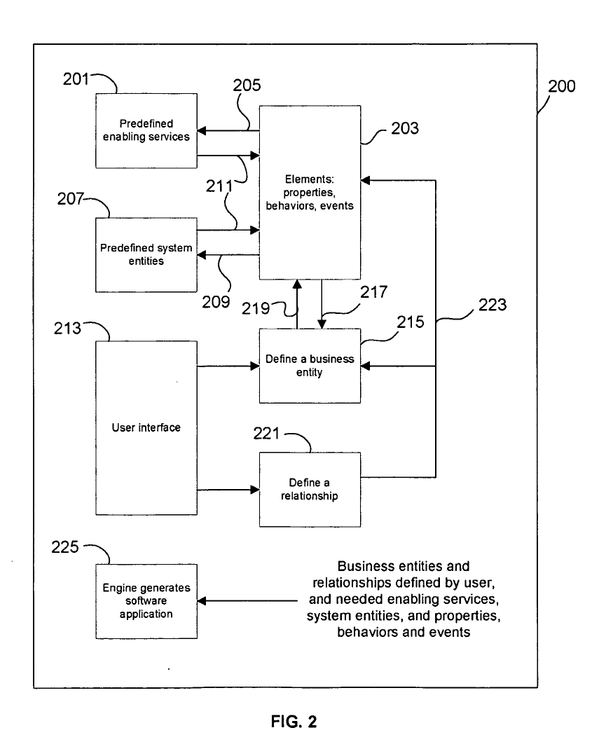

In a computer system, an embodiment of the invention provides an environment generally 200 for developing a desired programmatic interface as shown in diagrammatic form in FIG. 2. The environment includes predefined enabling services 201 each a conceptual representation of an operational capability. Each enabling service has at least one element selected from among properties, behaviors and events 203 as indicated by an arrow 205. The environment includes predefined system entities 207 each a conceptual representation of an object. Each system entity has at least one element selected from among the properties, behaviors and events 203 as indicated by an arrow 209. The enabling services 201 and system entities 207 themselves are among said properties, behaviors and events, as indicated by arrows 211, such that any enabling service and business entity can include among its elements any other such entity and service.

The environment includes a user interface 213. The user interface has a feature 215 by which a user can define a business entity that has at least one element selected from among the properties, behaviors and events as indicated by an arrow 217. Once the user has defined a business entity, the user can include that business entity among the properties, behaviors and events 203 as indicated by an arrow 219.

The user interface 213 has a feature 221 by which the user can define a relationship between any of the properties, behaviors and events, including any business entity created by the user, as indicated by an arrow 223.

The environment includes an engine 225 that generates a software application implementing any business entities and relationships defined by the user, together with any needed system entities, enabling services and other properties, behaviors and events in the desired programmatic interface.

Various embodiments of the invention will now be described in more detail. In this discussion, the term “concept” refers to a model of a thing and the term “entity” refers to a specific instance of a concept. For example, “contract” might be a model of a thing, and a specific contract between Company A and Company B would then be an entity, that is, an instance of the “contract” concept. An entity is often of little value when defined alone; services may be attributed to entities so that the entities can generate value. For example, “routing” and “auditing” might be services that could be attributed to the “contract” concept. A “contract” may derive its value from the attached services that make it useful. When combined within the same context, concepts and services can become enablers of even greater value. In the context of embodiments of the invention, a user can define a business entity, tag it with a service, and define any relationships between the business entity and any other business entities to generate a programmatic interface.

In this discussion the terms “business entity” and “system entity” and their plural forms are used with reference to entities that are defined in a development environment embodying the invention and to entities that may be defined by a user when using the development environment to create a software application. The context will make it clear when one of these terms is used to refer to an entity that is predefined in the system as opposed to one that is created by a high-level user.

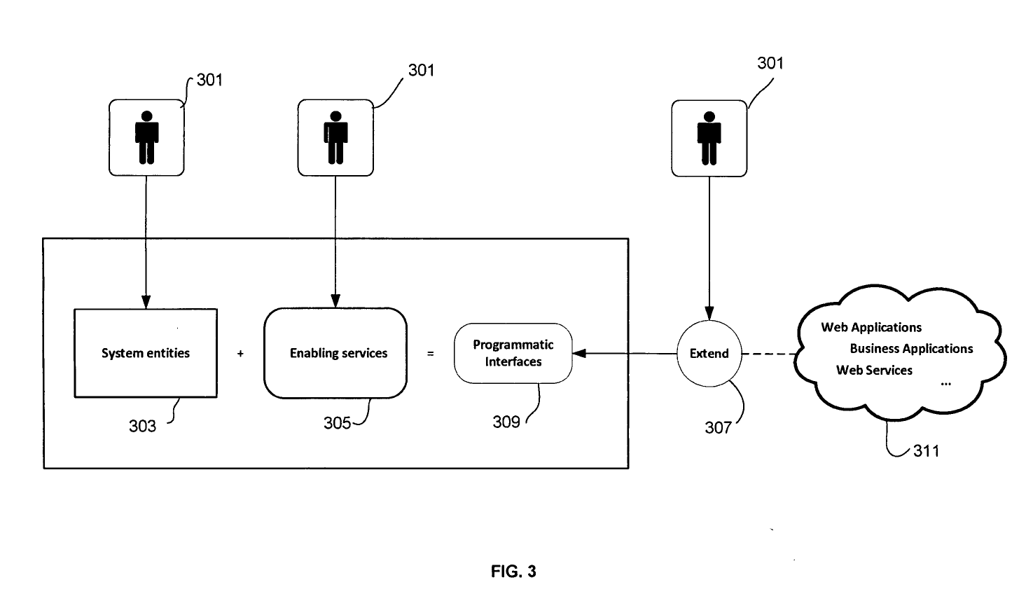

As shown in FIG. 3, embodiments of the invention allow a user 301 to interact with system entities 303 and enabling services 305 to generate 307 programmatic interfaces 309 such as web applications, web services or business applications 311.

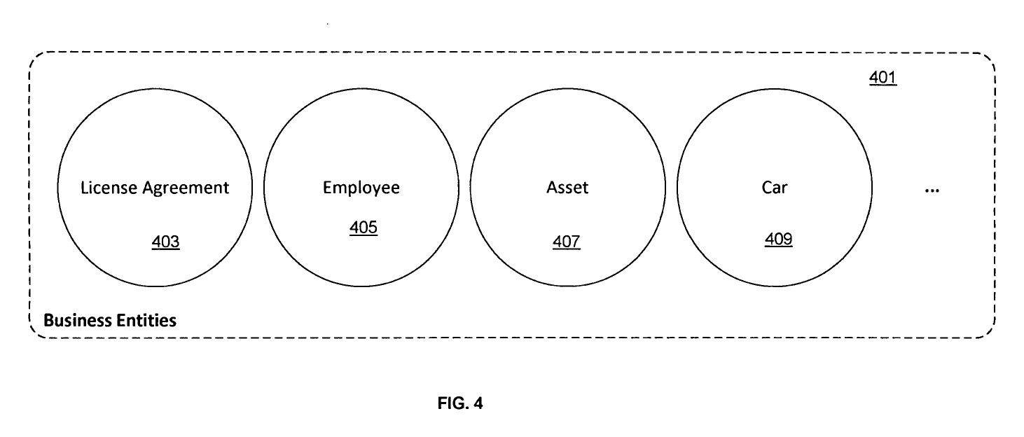

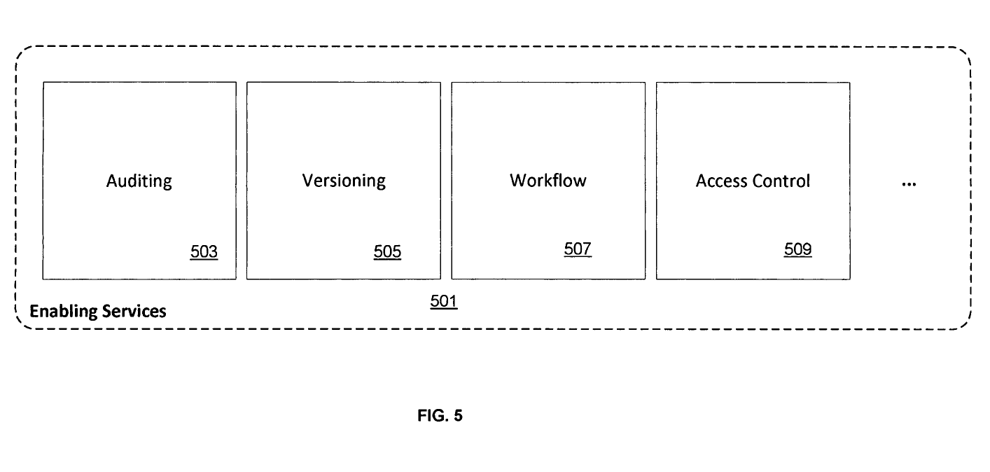

System entities are conceptual representations of objects that are used in operational contexts. FIG. 4 shows different examples of system entities 401, including License Agreements 403, Employees 405, Assets 407, and Cars 409, on which different operations can be performed. The operations that can be performed on these entities are defined in a set of Enabling Services. These Enabling Services embody different operational capabilities. Error! Reference source not found. FIG. 5 shows different examples of Enabling Services 501, including Auditing 503, Versioning 505, Workflow 507, and Access Control 509, that system entities 401 can benefit from.

As will now be explained in more detail, users define their business entities and cap them with specific Enabling Services to establish different operational capabilities. The result of this modeling is readily-defined functionalities that are made accessible to users through programmatic interfaces. Programmatic interfaces are client—accessible representations that users, both high-level users and specialists who can access the inner workings of embodiments of the invention, can extend to implement the sets of readily-defined functionalities in an application of choice (e.g., business applications, Web applications, Web services, cloud-based services, or phone applications).

Users can create new business entities and define new enabling services in addition to pre-existing ones provided by a system embodying the invention. They do so by using a Type System.

1.1 Type System

Embodiments of the invention use a Type-based System to implement Business Entities and Enabling Services. Entity Types are instances of the Type System. They are well-defined components with standardized interfaces, used to implement Business Entities and Enabling Services. In defining Business Entities, Entity Types are representations of objects. In defining Enabling Services, Entity Types are representations of functional behaviors that all Business Entities benefit from.

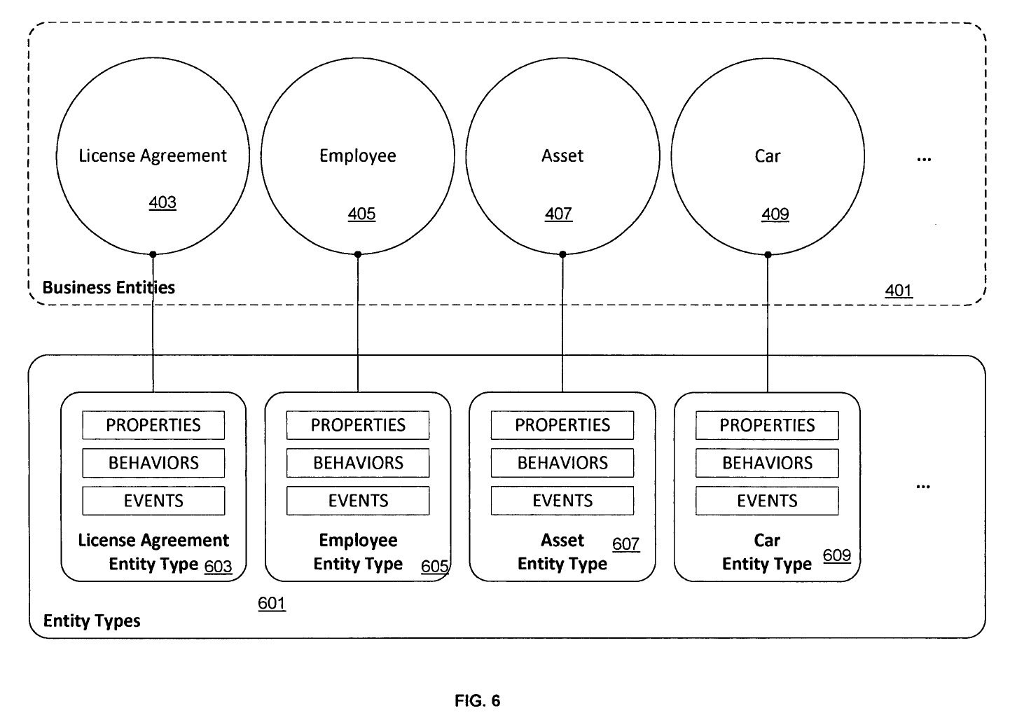

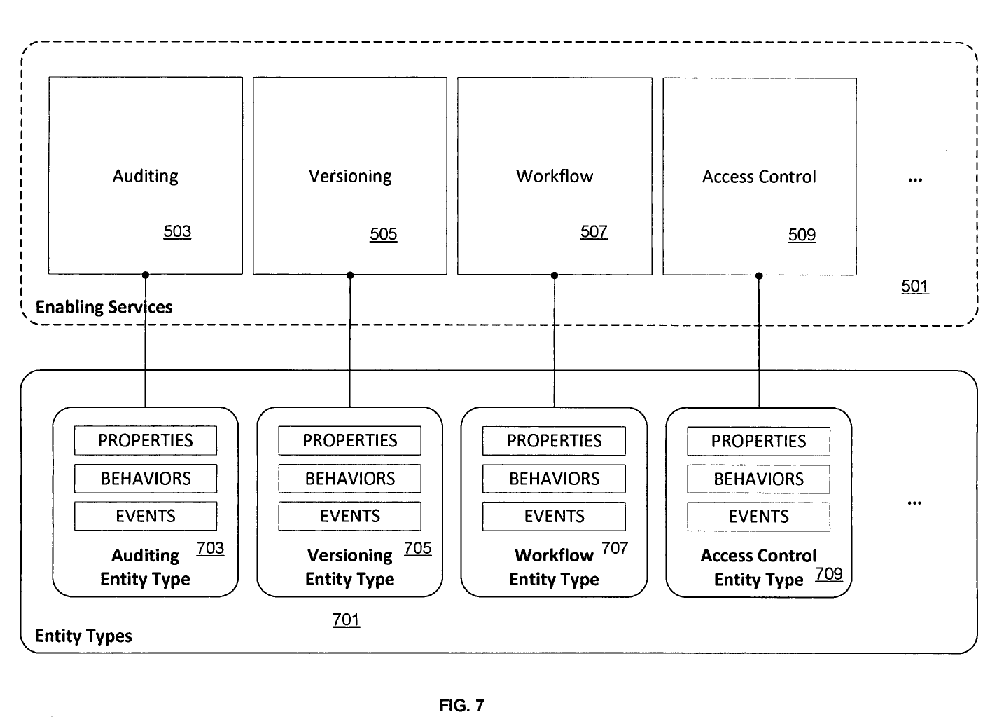

Entity Types have Properties, Behaviors, and Events. The definition of these Properties, Behaviors, and Events identify the Business Entity or Enabling Service that the Entity Type implements. FIG. 6 shows generally at 601 the Entity Type representations 603, 605, 607 and 609 corresponding with the Business Entities 403, 405, 407 and 409, respectively, shown in FIG. 4. Similarly, FIG. 7 shows generally at 701 the Entity Type representations 703, 705, 707 and 709 corresponding with the Enabling Services 503, 505, 507 and 509, respectively, shown in FIG. 5.

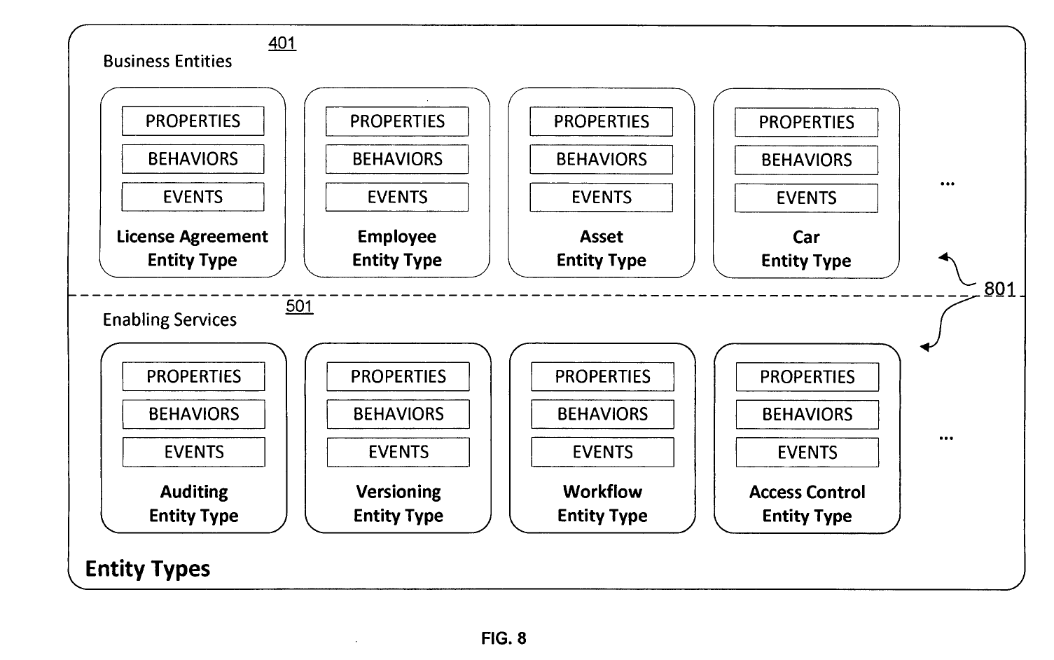

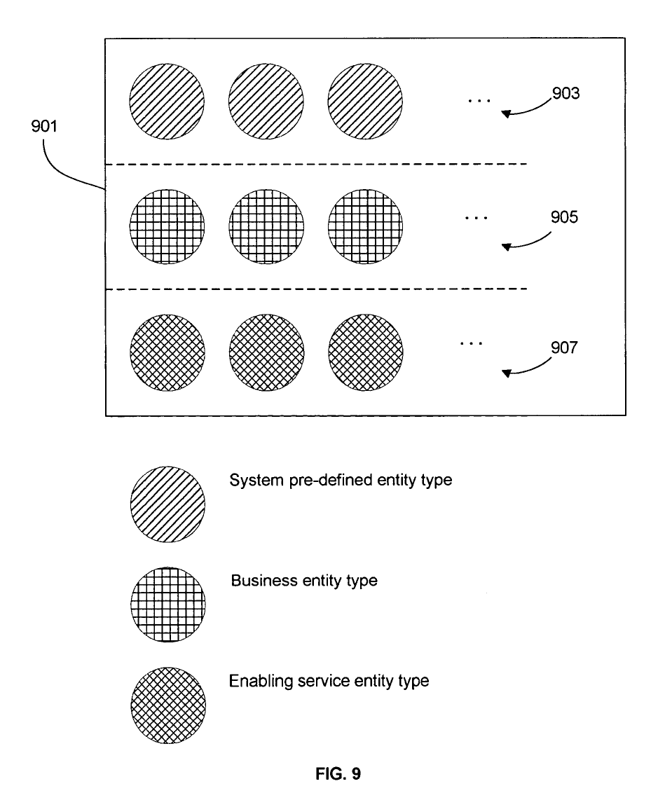

Business Entities and Enabling Services are defined in the same space. FIG. 8 shows how both Business Entities 401 and Enabling Services 501 are implemented in Entity Types generally 801, thus sharing a common representation—that of the Type System. The Type System allows the creation of unique Entity Types to model Business Entity Types, Enabling Services Entity Types, and system-predefined Entity Types (respectively mapping to representations of Business Entities, Enabling Services, and base types that help define the different Entity Types in the system (ref., section 7.1.1)). Error! Reference source not found. FIG. 9 shows how embodiments of the invention host a pool of Entity Types generally 901 including system pre-defined entity types 903, business entity types 905 and enabling service entity types 907 that comprise the necessary components for the development of complete programmatic interfaces.

1.2 Entity Types Relationships

A relationship must be established between a Business Entity and an Enabling Service in order for that Business Entity to benefit from the capabilities offered by that Enabling Service. For example, a relationship must be established between a “License Agreement” Business Entity and the “Auditing” Enabling Service in order for the “License Agreement” instances to benefit from traceability capabilities offered by the “Auditing” service.

This relationship is established by setting the Enabling Service Entity Type as one Property of the Business Entity. The capabilities of the Enabling Service thus become instantly applicable on the Business Entity that it is attached to, and without any further modifications on the Business Entity and Enabling Service. In the above example, “License Agreement” instances benefit from traceability capabilities by setting the “Auditing” Entity Type as one property of the “License Agreement” Entity Type. The same process applies when other Enabling Services are to be enabled on this Business Entity.

1.3 Business Entities Creation

Business Entities are created by extending from the system-predefined base Entity Types, and inheriting their base Properties, Behaviors, and Events. These newly-created Business Entities can redefine the inherited specifications and/or create new ones.

Newly-created Business Entities automatically take part of the Entity Type pool. They become accessible to other Business Entities and Enabling Services that belong to that same Entity Type pool. New Business Entities can be created by extending from, or referencing, already created Business Entities.

1.4 Enabling Services Creation

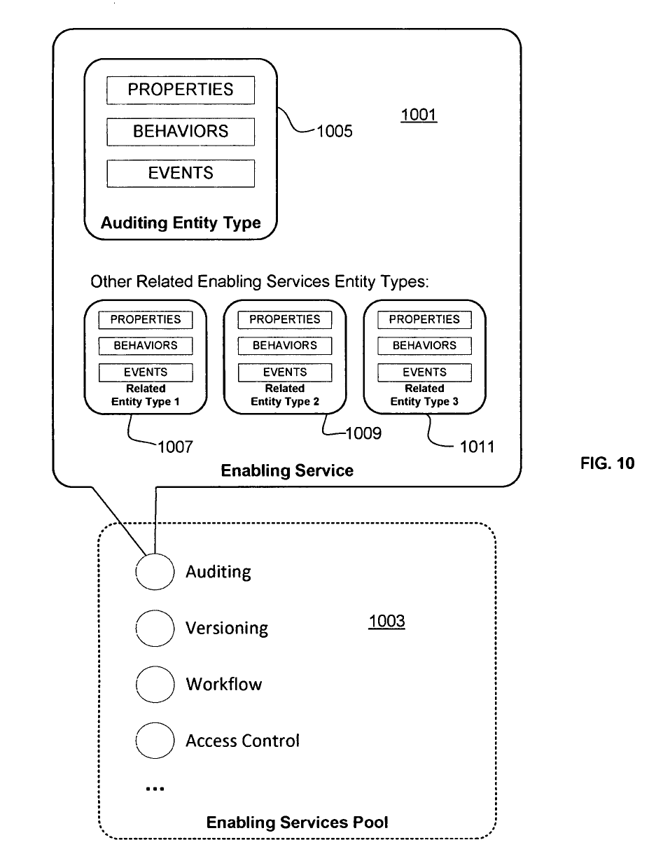

At a minimum, an Enabling Service is implemented in at least one base Entity Type. However, further Entity Types might be required to implement more complicated operational functionalities in an Enabling Service. FIG. 10 shows the “Auditing” Enabling Service 1001 in an enabling services pool 1003 composed of one base Entity Type 1005 and three other sub-Entity Types 1007, 1009 and 1011.

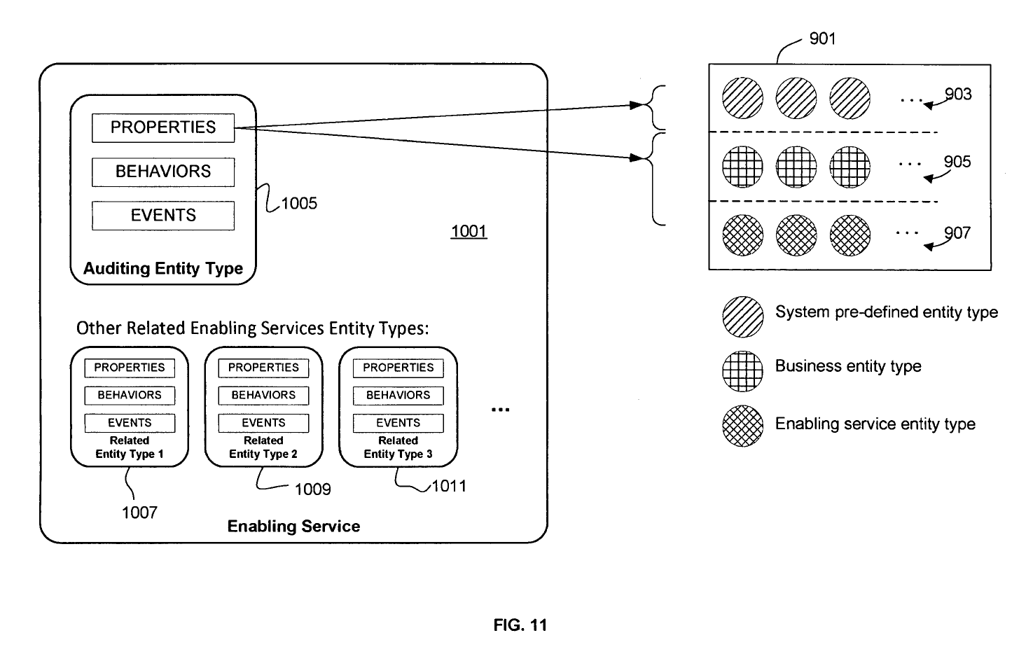

FIG. 11 shows that the Properties of Entity Types such as the auditing entity type 1005 are defined using any of the Entity Types in the pool 901 (including the Business Entity Types 905, Enabling Services Entity Types 907, and system-predefined Entity Types 903). Since Enabling Services Entity Types are included in this pool, then Enabling Services can benefit from the capabilities of other Enabling Services to define their own capabilities by setting the already established Entity Service's matching Entity Type as a new property, i.e., by establishing a relationship between the two Entity Services. Moreover, the Behaviors of the Enabling Services Entity Type are public methods that act on any of the Entity Types in the pool. The implementation footprint of Enabling Services does not cross beyond the context of the Entity Types pool.

### 2. TYPE SYSTEM

In embodiments of the invention, the Type System enables users to transform abstract business concepts into self-contained and maintainable Business Entities that can, in turn, benefit from numerous system-predefined and user-defined services. The Type System enables users to define Business Entities (and reference relationships among them), Enabling Services (and reference relationships among them), and relationships between Business Entities and Enabling Services.

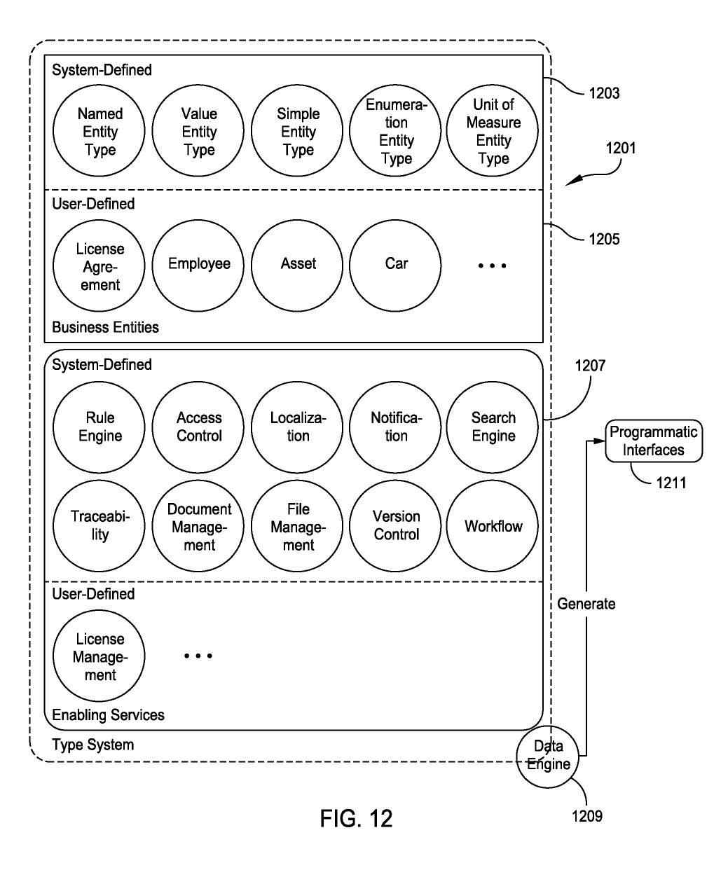

As shown in FIG. 12, when Business Entities 1201 including system-defined entities 1203 and user-defined entities 1205, their inter-dependencies, and their attached Enabling Services 1207, are defined, then a Data Engine 1209 acts on these specifications to generate a uniform and accessible representation of these specifications in a set of Programmatic interfaces 1211. These Programmatic interfaces are accessible to users to render solutions in an application model of choice. All the underlying logic required to run the solution based on the Business Entity and Enabling Services specifications is generated underneath this Programmatic interface.Error! Reference source not found.

2.1 Type Representations

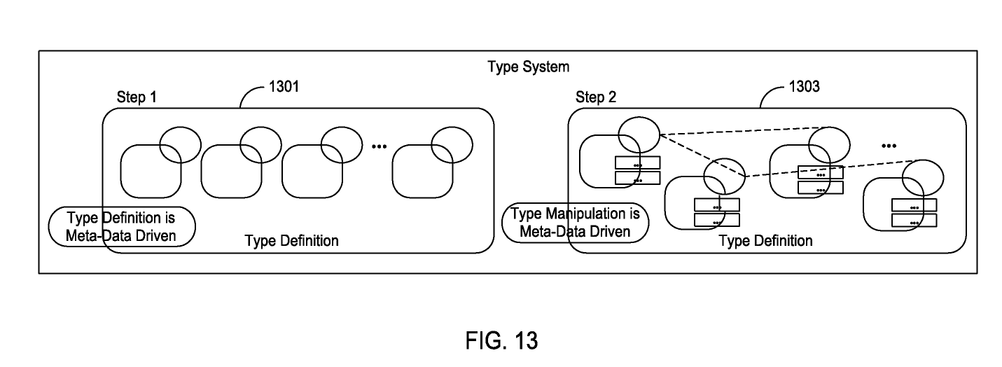

As shown in FIG. 13, users set metadata values to define (1301) Business Entities, and then to manipulate (1303) them by defining references among them and Enabling Services attached to them. These metadata values are entered using any interface, including Extensible Markup Language (XML) or Microsoft Windows forms. Programming logic is not required at this level; rather, a metadata-driven approach is used to model evolving business requirements with flexibility and extensibility.

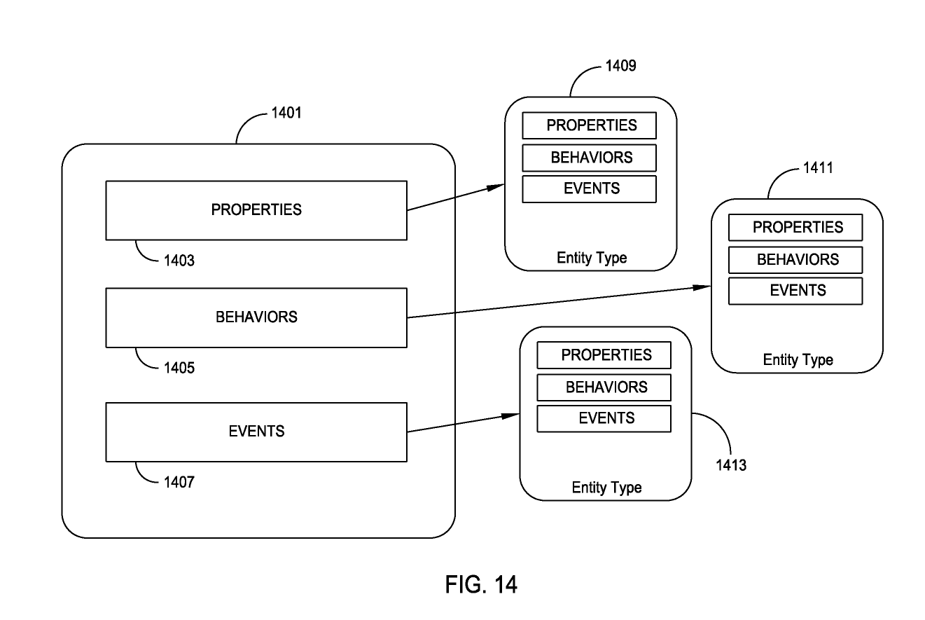

When users enter metadata values to define their Business Entities, Entity Types, for examplethe Entity Type 1401, are created as shown in FIG. 14. Entity Types are system representations of Business Entities, carrying a set of Properties 1403, Behaviors 1405, and Events 1407. These Properties, Behaviors, and Events are in turn modeled as Entity Types (Attribute Entity Type 1409, Method Entity Type 1411, and Event Entity Type 1413 respectively), each with their own set of Properties, Behaviors, and Events.

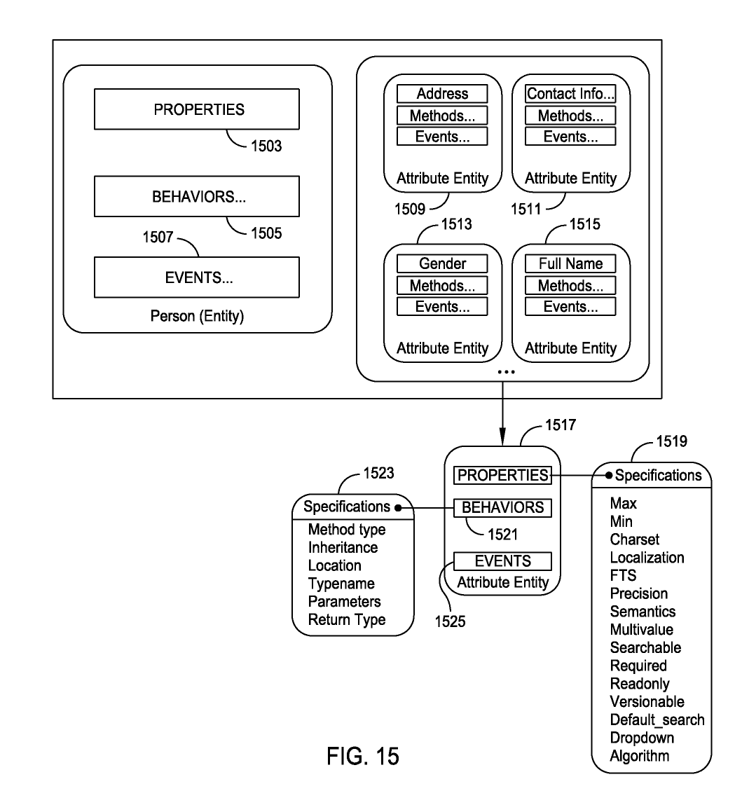

For example, the Property of an Attribute Entity Type can define its own finite set of Properties (e.g., Max, Min, or Searchable Properties); similarly, the Behavior of an Attribute Entity Type can define its own set of Properties (e.g., Method Type, Location, or Parameters) as shown in FIG. 15. A “person” entity 1501 has properties 1503, behaviors 1505 and events 1507. The properties 1503 include attribute entities address 1509, contact information 1511, gender 1513, and full name 1515. These four attribute entities in turn each may have properties 1517 such as described in specifications 1519, behaviors 1521 such as described in specifications 1523, and events 1525 which may also have specifications (not shown).

### 2.1.1 Base Entity Types

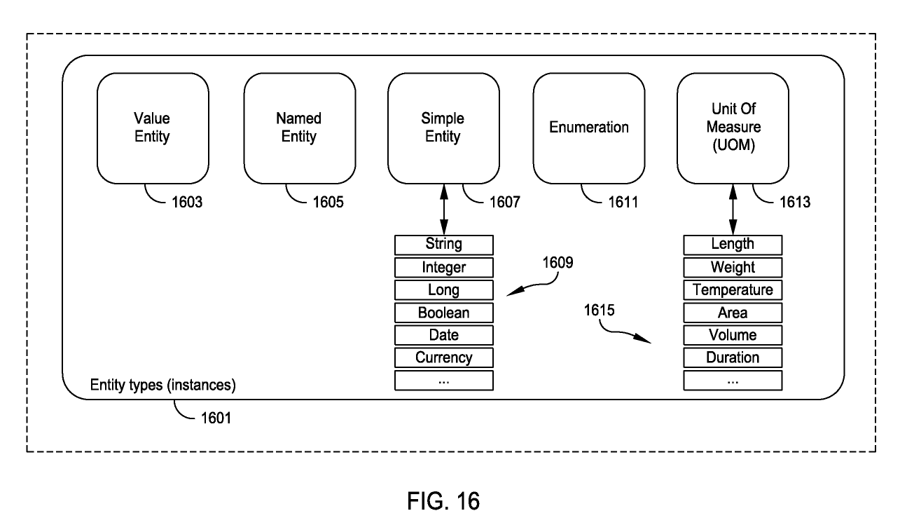

Embodiments carry a finite set of predefined Entity Types. These act as base Entity Types from which other newly-created Entity Types extend. As shown in FIG. 16, the base Entity Types 1601 include the Value Entity 1603, Named Entity 1605, Simple Entity 1607 which has potential characteristics 1609 such as string, integer, long, Boolean, date or currently, Enumeration 1611, and Unit of Measure 1613 which has potential characteristics 1615 such as length, weight, temperature, area, volume or duration. Any user-defined Entity Type, whether it models Business Entities or Enabling Services, must extend from one of these base Entity Types. The following details the specifications of each of these base Entity Types.

### 2.1.1.1 Value Entity

Value Entities are Business Entities that must be referenced by other Business Entities in order for them to exist. They are dependent, non-searchable, and non-referenceable Business Entities that conceptually belong to the Business Entities that reference them only.

For example, “Address” and “Contact Information” are Value Entities that are referenced by the “Person” Named Entity (ref., section 7.1.1.2). The existence of the “Address” and “Contact Information” Value Entities is dependent on the “Person” Business Entity. Moreover, these Value Entities cannot be referenced by any other Business Entity in the Entity pool.

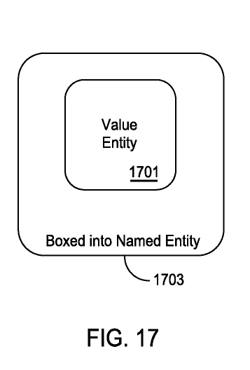

In rare cases, Value Entities must be referenced and used just like Named Entities, i.e., acting as independent and searchable Business Entities. If so, such Value Entities 1701 are “boxed” into a Named Entity 1703 that can, in turn, be referenced, as shown in FIG. 17.

### 2.1.1.2 Named Entity

Named Entities are Business Entities that do not have to be referenced by other Business Entities in order for them to exist. They are independent, searchable, and referenceable Business Entities that can be defined independently of other Business Entities—as opposed to Value Entities that cannot.

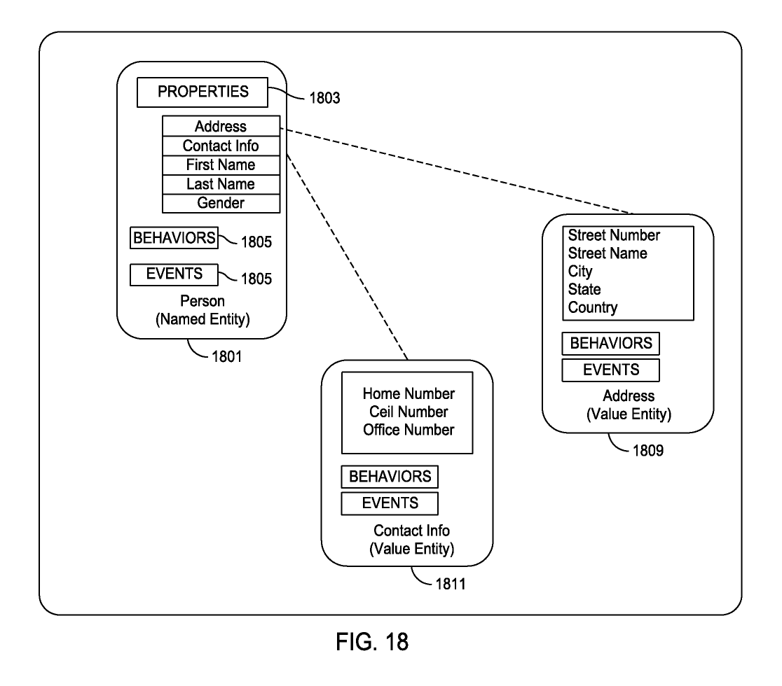

For example, “Person” is a Named Entity 1801 with specific Properties 1803, Behaviors 1805, and Events 1807. Its definition is independent of other Business Entities defined in the Entity pool. Alternatively, the existence of the “Address” 1809 and “Contact Information” 1811 Value Entities depends on that of the “Person” Named Entity 1801 as shown in FIG. 18.

### 2.1.1.3 Simple Entity

Simple Entities are a finite set of all basic scalar Entity Types. These basic scalars include String, Long, Integer, Long, Boolean, Double, Date, Binary, Long Binary, URI, XML, HTML, Decimal, and Currency units. Typically, Properties of Business Entities are Attribute Entity Types that extend from Simple Entities.

For example, the “First Name” and “Last Name” Properties of the “Person” Named Entity are Attribute Entities of the String Simple Entity Type.

### 2.1.1.4 Enumeration

Enumerations are a predefined and finite set of strings. Typically, Enumeration Entity Types are defined and modeled as dropdown lists in client applications.

For example, the “Gender” Property of the “Person” Named Entity is an Attribute Entity of the Enumeration Entity Type, hosting “Male” and “Female” as possible values.

### 2.1.1.5 Unit of Measure

Unit of Measures (UOM) are a finite set of all unit-of-measures. This set includes Length, Weight, Area, Volume, Temperature, and Duration.

Note that all UOM instance values in the client application are stored in normalized values (ref., section 8.3.2.3). Conversions are performed by the Data Engine (ref., section 7.2) when required.

### 2.1.2 Other Entities

In addition to the View and Container Entities defined below, embodiments of the invention implement many Entity Types other than the base Entity Types (ref., section 7.1.1). A subset of these includes the Event Entity (ref., section 9.3), Resources Entity (ref., section 8.5), Search Entity (ref., section 8.6), History Entity (ref., section 8.7), Document Entity (ref., section 8.8), and File Entity (ref., section 8.8.3).

### 2.1.2.1 View Entity

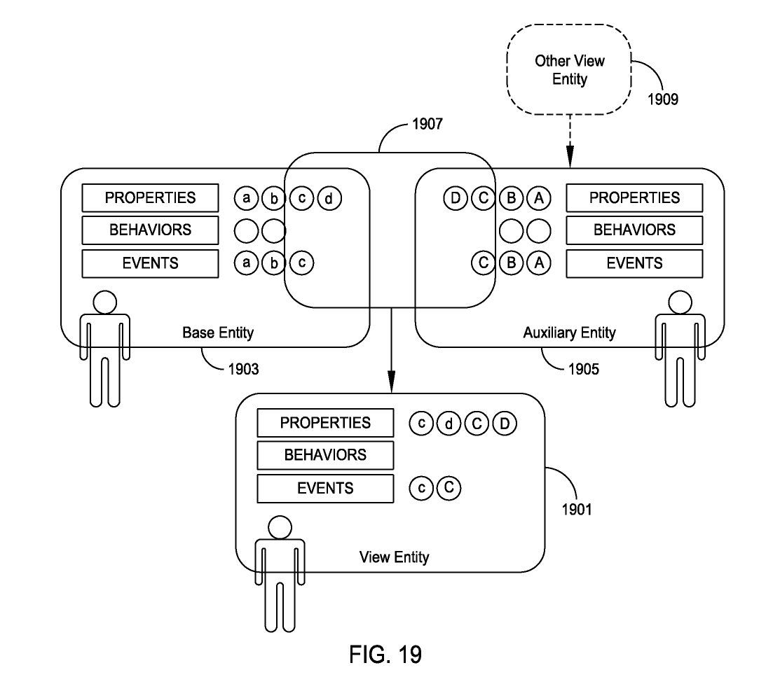

As shown in FIG. 19, a view entity 1901 is a representation of one or two other Business Entities. A view entity is merely a view of one or two Entities (called a base entity 1903 and an auxiliary entity 1905) with access to only a subset 1907 of their Properties, Behaviors, and Events. View Entities do not have their own persistent storage. Instead, they only provide schema support to achieve Property, Behavior, and Event filtering.

Further refinement of access control (ref., section 8.1.3) can be achieved by defining a view entity using another view entity 1909, allowing for better control over segregation, customization, and filtering of Properties, Behaviors, and Events.

When changes are performed on a View Entity, only the values of the Base and Auxiliary Entities are affected since the View Entity is merely a “shadow” representation of other Entities.

### 2.1.2.2 Container Entity

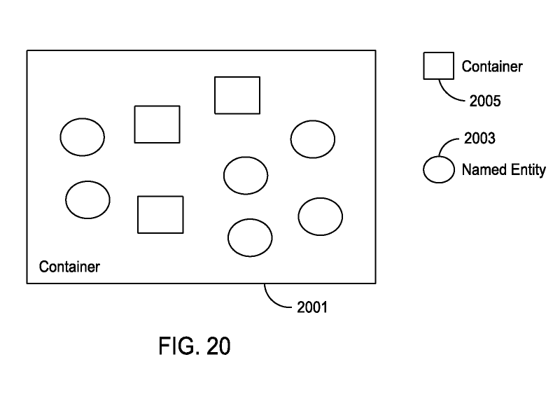

Container Entities are a collection of Business Entities. As shown in FIG. 20, Container Entities 2001 can hold both Named Entities 2003 (ref., section 7.1.1.2) and other Container Entities 2005. They do not hold Value Entities (ref., section 7.1.1.1). Since Container Entities can hold other Container Entities, they can be considered as organizational mediums for Business Entities. Container Entities can be implemented in different scenarios. These include Document foldering (a “Folder” Entity is a Container Entity of “Document” Entity Types), Inbox management (an “Inbox” Entity is a Container Entity of “Tasks” Entity Types), or Notification foldering (a “Notification Folder” Entity is a Container Entity of “Notification Message” Entity Types that expire after a predefined amount of time).

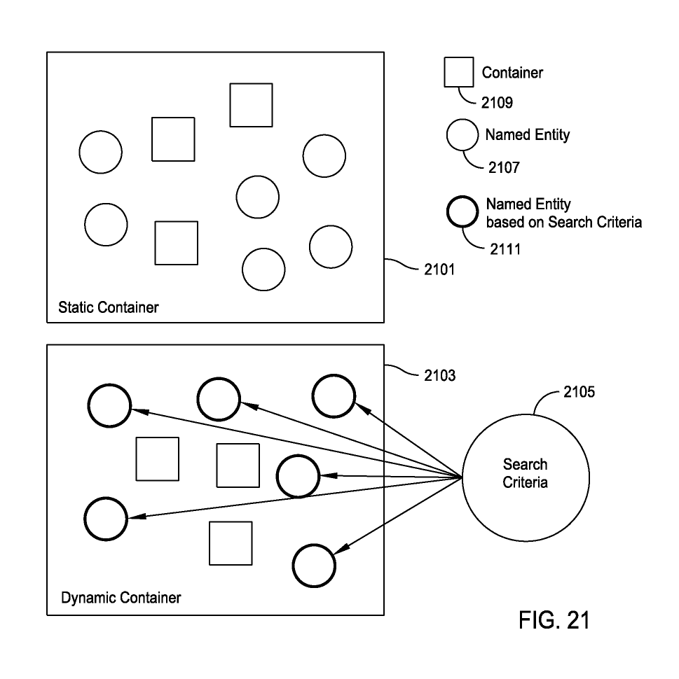

As shown in FIG. 21, a Container Entity can be a static container entity 2101 or a dynamic container entity 2003. Contents of a static Container Entity are explicitly determined; contents of a Dynamic Container are dynamically determined based on search criteria 2105.

Container Entity Types extend from the Named Entity Type (ref., section 7.1.1.2), and so they inherit the Properties and Behaviors of the latter. However, the Container Entity Type is an abstract type that does not have its own instances. Instead, it is defined for the Static and Dynamic Container Entity Types to inherit from. The following details the Properties and Behaviors of each.

The Static Container Entity Type defines the following Properties:
Content Type—the Type of Entities allowed in the container. The default value is set to “Named Entity” which allows all Named Entity Types 2107 to be included in the container. However, users can specify any other user-defined Named Entity and limit the containing space to Entities of that Type.
Contents—a multi-value Attribute Entity of the Named Entities type, containing a list of Entity references (including Container Entity 2109 references if the Restriction Property is set to “Containers” or “Mix”).
Semantic—the semantic relation between the Container and its Entities. Possible values include:
   Reference—Entities are not exclusively contained by the Container. Other Containers can reference the same Entity at any time.
   Exclusive—Entities are exclusively contained by the Container. Other Containers cannot reference the same Entity at any time.
   Cascade Delete—Entities are exclusively contained by the Container. Moreover, if the Container is deleted, then all Entities that it contains are deleted as well.
Restriction—the restrictions on the Container's contents. Possible values include:
   Containers—the Container can only contain other Containers. In this case, circular Container references are allowed if the Semantic Property is set to “Reference”.
   Entities—the Container can only contain non-Container Entities
   Mix—the Container can contain both Containers and Entities. In this case, circular Container references are allowed if the Semantic attribute is set to “Reference”.

The Static Container Entity Type defines the following Behaviors:
Add—add a Container or an Entity to the current container.
Remove—remove a Container or an Entity from the current container.
List—inherited from the Named Entity Type, and redefined to return a list of all Entities in the container.
Delete—inherited from the Base Type, and redefined to handle cascade delete if the Semantic Property is set to “Cascade Delete”.

The Dynamic Container Entity Type defines the following Properties:
Content Type: Other Containers 2109 and Named Entities Based on Search Criteria 2111.
Search—references a Search Entity (ref., section 8.6).

The Dynamic Container Entity Type defines the following Behavior:
List—inherited from the Named Entity Type, and redefined to execute a search and return a list of Entity IDs that match the specified search criteria.

Static and Dynamic Container Entity Types can be used as a base type for other user-defined Container Entity Types. The following are implementation examples of the sample Static and Dynamic Containers use cases outlined earlier:
Document Foldering—create a “Folder” Entity Type as a subtype of the Static Container Entity Type. Override its inherited New Behavior to set the Semantics Property to “Reference”, the Restriction Property to “Mix”, and the Content Type Property to “Document” (assuming a Document Entity Type is already defined in the Entity Types pool).
Inbox Management—create an “Inbox” Entity Type as a subtype of the Dynamic Container Entity Type. Override its inherited New Behavior to set the Search Property to “Tasks” (assuming a “Tasks” Search Entity Type is defined in the Search Engine (ref., section 8.6) and its search condition filters all active “Tasks” Entities that belong to the user in question). The advantage of making this a Dynamic Container is that the Tasks do not have to be explicitly added to the Container and that, as Tasks are being completed, they are automatically deleted from the Container.

### 2.1.3 Type Hierarchy & Object-Relational Mapping

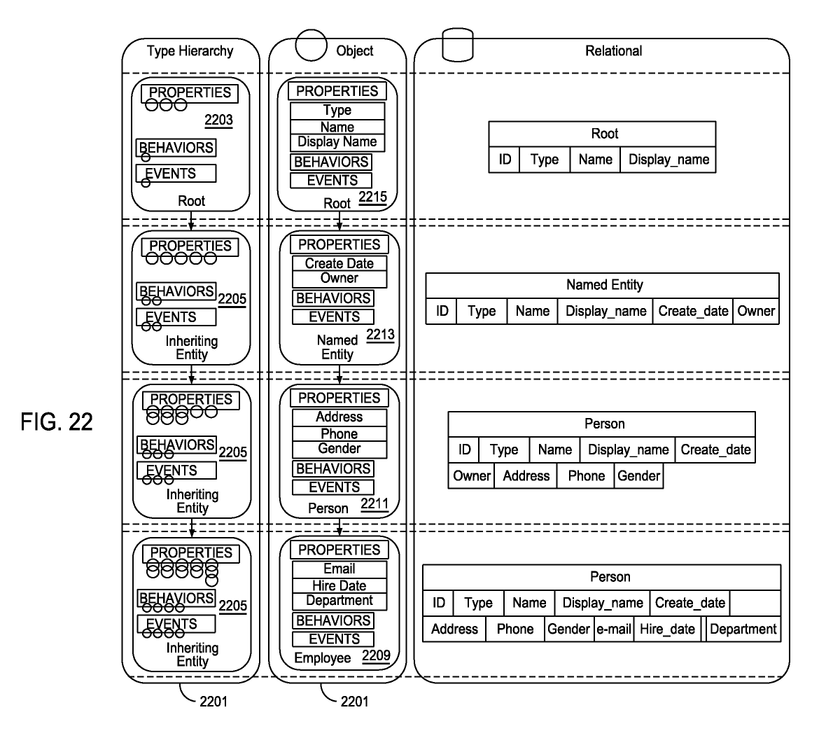

Business Entities can inherit and redefine Properties, Behaviors, and Events from other parent Business Entities as shown in FIG. 22. Entity Type hierarchies such as the hierarchy 2201 can be defined. However, the Root Entity 2203 is not derived from any other Entity Type. It defines the basic Properties, Behaviors, and Events that all inheriting Entity Types 2205 have in common.

For example, in the Entity Type hierarchy 2207, the “Employee” Named Entity 2209 inherits the “Address”, “Phone”, and “Gender” Properties from the “Person” Named Entity 2211. In turn, the “Person” Named Entity 2211 inherits the “Create Date” and “Owner” Properties from the system-defined Named Entity 2213. Finally, the system-defined Named Entity inherits the “Type”, “Name”, and “Display Name” Properties from the system-defined Root Entity 2215.

2.2 Data Engine

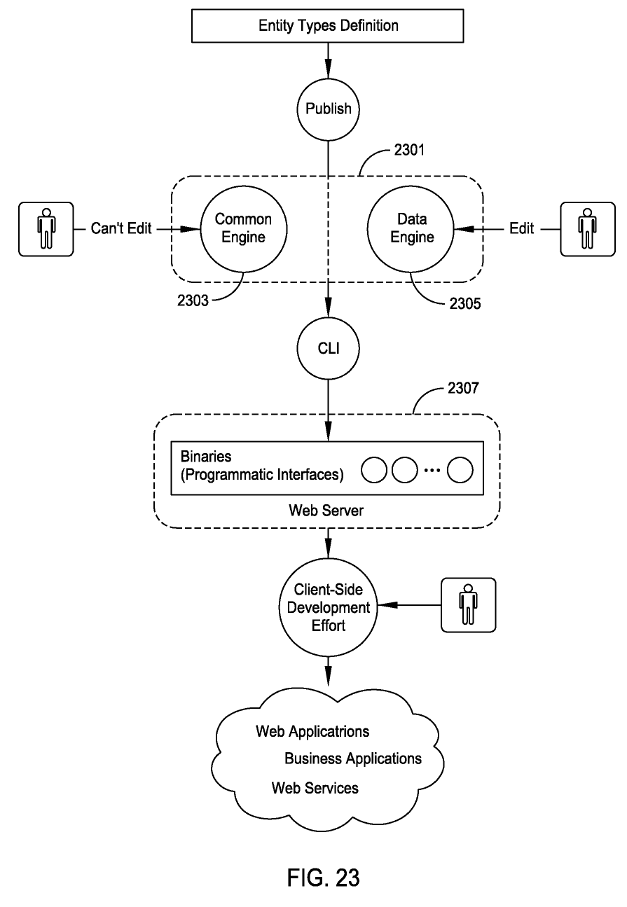

A Data Engine according to embodiments of the invention is shown in FIG. 23. Operating under the guidelines of the Type System, the Data Engine 2301 defines, generates, and manipulates Entity Types and their Entity instances. The Data Engine drives the abstraction logic required to implement a meta-driven approach to application development.

The Data Engine provides the following high-level capabilities: Automates generation of code to establish a strong-typed development environment; Standardizes method invocations and encapsulates connectivity details; and Simplifies the application deployment process.

When Entity Types are defined and maintained, the Data Engine automatically generates two sets of corresponding public C# classes¹: the Common Engine Project 2303 and the Data Engine Project 2305 (ref., section 7.3). These classes—or Programming interfaces, provide users with visibility and access control over the Entity Types (Business Entities and Enabling Services alike) to extend the modeled system and instantiate in the application of choice. ¹The public classes generated by the Data Engine do not necessarily have to be implemented using the C# programming language. Alternatively, they could be generated in XML, or the Java, C++, or BASIC programming languages. The Data Engine may generate a set of programmatic interfaces regardless of the underlying technology used.

When the two Projects are generated, the Data Engine makes use of the Command Line Interface (CLI) to invoke the .Net compiler to compile these two projects. These compiled projects are then loaded into the Web Server 2307 for users to benefit from.

### 2.2.1 Basic Types

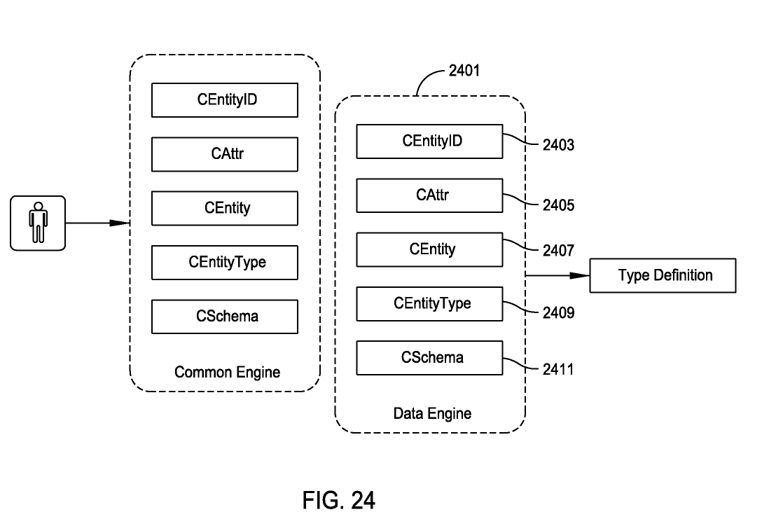

As shown in FIG. 24, based on the Entity Types defined by the user, and the references established among them, the Data Engine 2401 generates the basic public C# classes¹ that represent the Programmatic interface.

The following sections list these public classes in the C# programming language.

### 2.2.1.1 Entity ID—CEntityID Public Class

An Entity ID can uniquely identify each Entity. Unique 64-bit integer identifiers can be used. Run-time environments make use of CEntityID 2403 class instances.

The CEntityID public class defines the following Properties:
ID—unique identifier of the Entity.
Type—identifier of the Entity's Type.
Name—invariant internal name of the Entity.
Display Name—user-readable name of the Entity.

The CEntityID public class definition is:

```
public class CEntityID
{
  public Int64 entityType { get; set; }
  public Int64 entityID { get; set; }
  public string name { get; set; }
  public string displayName { get; set; }
}
```

### 2.2.1.2 Attribute—CAttr Public Class

The CAttr 2405 public class helps represent Property value instances. Moreover, the CAttrList public class defines an array of CAttr instances, allowing Property lookup by both Name and ID.

The CAttr public class defines the following Properties:
Attribute ID—unique identifier (in CEntity form) of the Attribute Entity that contains in turn the meta-data of the Property.
Attribute Value—Entity Type of the Attribute Entity.

The possible Attribute values are:
String—a String value defined by the C# System.String datatype.
Long String—a Long String value defined as a Value Entity. At run time, actual value instances are defined by the C# CLongString class.
Date—a Date value defined by the C# System DateTime datatype. All date and time values are stored in normalized Greenwich Mean Time (GMT) format in both the persistent data source and C# runtime representations (ref., section 8.3).
Duration—a Duration value defined as a Value Entity. The Duration class definition is:

```
public class CDuration : CEntity
{
  public double DurationValue { get; set; }
  public CEnumeration DurationUnit { get; set; }
}
```

Currency—a Currency value defined as a Value Entity. The Currency class definition is:

```
public class Currency : CEntity
{
  public double CurrencyValue { get; set; }
  public CEnumeration CurrencyUnit { get; set; }
}
```

UOM—a Unit Of Measure value defined as a Value Entity. The UOM class definition is:

```
public class CUom
{
  public double Measure { get; set; }
  public CEnumeration Unit { get; set; }
}
```

Decimal—a Decimal value defined as a Value Entity. The Decimal class definition is:

```
public class CDecimal
{
  public Int32 I { get; set; }
  public Int32 N { get; set; }
  public override string ToString { return I.ToString( ) + ‘E’ +
  N.ToString( ); }
}
```

Integer—an Integer value defined by the C# Int32 class.
Long—a Long value defined by the C# Int64 class.
Boolean—a Boolean value defined by the C# bool type.
Binary—a Binary value defined by the C# byte[ ] type. Note that maximum length constraints are required when defining the type.
Long Binary—a Long Binary value defined as a Value Entity. At run time, actual value instances are defined by the C# ClongBinary class.
Enumeration—an Enumeration value defined by the Enumeration class. The Enumeration class definition is:

```
public class CEnumeration : CEntityID
{
  public Int64 ID { get; set; }
  public Int64 TypeID { get; set; }
  public string Value { get; set; }
  public string Display_name { get; set; }
}
```

Value Entity—a Value Entity defined by the CEntity class (ref, section 7.2.1.3). A Value Entity is passed by value—as opposed to by Reference.
Named Entity—a Named Entity defined by the CEntity class (ref, section 7.2.1.3). A Named Entity is passed by reference: the Attribute value contains an instance of CEntityID.
Multi-Value—a collection of data elements of the same type (including Named Entities).

At run time, this collection is defined by the C# CArray class. CArray supports direct access of array data elements by array index. The CArray class definition is:

| | |
|---|---|
| public class CArray | |
| { | |
| public Int64 ValueID { get; set; } | // unique ID of collection |
| public Int64 ValueType { get; set; } | // type of data collection |
| public Chash ValueSet { get; set; } | // data collection |
| } | |

The CAttr public class definition is:

```
public class CAttr
{
  public CEntityID AttrID { get; set; }
  public object AttrValue { get; set; }
}
public class CAttrList : CHash { }
```

### 2.2.1.3 Entity-CEntity Public Class

The CEntity 2407 public class provides access to all Entities, irrespective of their Types.

The CEntity public class defines the following Properties:
Entity ID—unique class instance of the Entity (ref., section 7.2.1.1).
Attributes—list of Properties of the Entity (ref., section 7.2.1.2).
Is Deleted?—specifies if the Entity is marked as deleted or not². ² Some embodiments do not physically delete Entities from the persistent data source. Instead, they are marked as “deleted” (logical delete operation) to avoid the orphaning of records.

The CEntity public class definition is:

```
public class CEntity
{
  public CEntityID ID { get; set; }
  public CAttrList attributes { get; set; }
  public bool IsDeleted { get; set; }
}
```

### 2.2.1.4 Entity Type—CEntityType Public Class

The CEntityType 2409 public class helps define and instantiate Entity Types. It inherits from CEntity and provides Property and Behavior lookup capabilities.

The CEntityType public class defines the following Behaviors:
Get Attribute—returns the Attribute Entity given either its name or ID.
Get Attribute ID—returns the Attribute Entity ID of the given Attribute name as defined by the Entity Type.
Is Valid Attribute?—specifies if the Attribute is defined by the Entity Type or not.
Get Method—returns the Method Entity given either its name or ID.
Get Method ID—returns the Method Entity ID of the given Behavior name as defined by the Entity Type.
Is Valid Method?—specifies if the given Method Entity ID is defined by the Entity Type.

The CEntityType public class definition is:

| | |
|---|---|
| public class CEntityType : CEntity | |
| { | |
| public CEntity GetAttribute(CEntityID attrID) | { } |
| public CEntity GetAttribute(string name) | { } |
| public CEntityID GetAttributeID(string name) | { } |
| public bool IsValidAttribute(CEntityID attrID) | { } |
| public CEntity GetMethod(CEntityID mthID) | { } |
| public CEntity GetMethod(string name) | { } |
| public CEntityID GetMethodID(string name) | { } |
| public bool IsValidMethod(CEntityID mthID) | { } |
| } | |

### 2.2.1.5 Schema—CSchema Public Class

The Schema public class models a single-root Entity Type hierarchy and provides Entity Type hierarchy lookup capabilities. An instance of this class resides in each user active session providing Entity Type lookup capabilities. User sessions will access the same CSchema 2411 instance if they are accessing the same schema.

The CEntityType public class defines the following Properties:
Entity Types—the Entity Types modeled in the Schema.
Entity Type IDs—the Entity Types IDs modeled in the Schema.
Get Type—returns the Entity Type given either its name or ID.
Get Type ID—returns the Entity Type ID in CEntityID form given its name or ID.
Get Attributes—returns the list of Properties of the given Entity Type ID.
Get Base Type—returns the parent Entity Type ID of the given Entity Type.
Derive From—specifies if the given Entity Type derives from the given base type Entity Type.

The CSchema public class definition is:

```
public class CSchema : CEntity
{
    public CHash EntityTypes { get; set; }
    public CEntityID EntityTypeID { get; }
    public CEntityType GetType(string name);
    public CEntityType GetType(Int64 typeid);
    public CEntityID GetTypeID(string name);
    public CEntityID GetTypeID(Int64 typeid);
    public CAttrList GetAttrList(Int64 typeid);
    public CEntityID GetBaseType(CEntityID current);
    public bool DeriveFrom(CEntityID current, CEntityID basetype);
}
```

### 2.2.2 Entity Concurrency & Updating

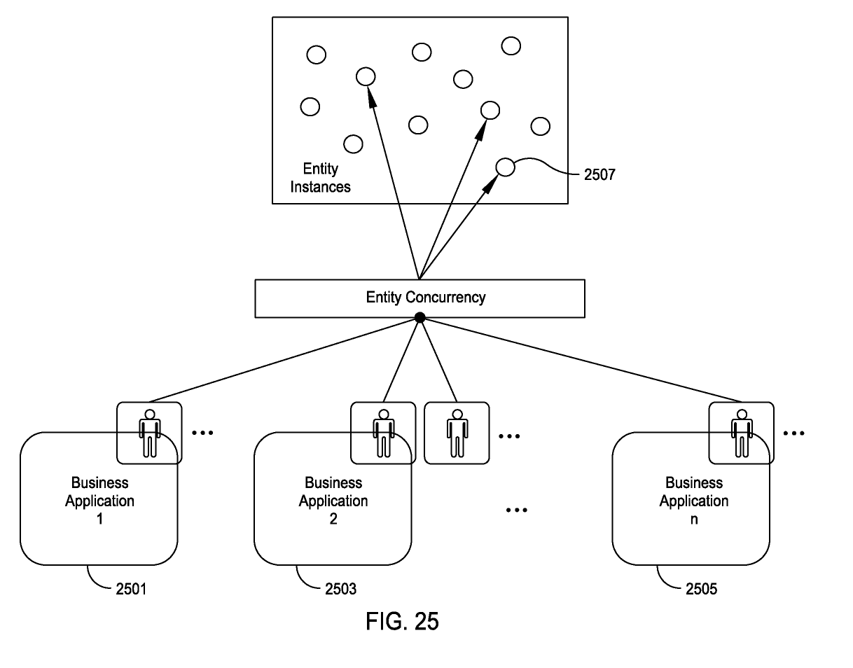

As shown in FIG. 25, proper management of Entity concurrency allows different applications, for example n different applications of which 2501, 2503 and 2505 are representative, possibly hosted on different machines that are remotely located from one another, to establish simultaneous user sessions and to access and modify the same Entity such as the entity 2507.

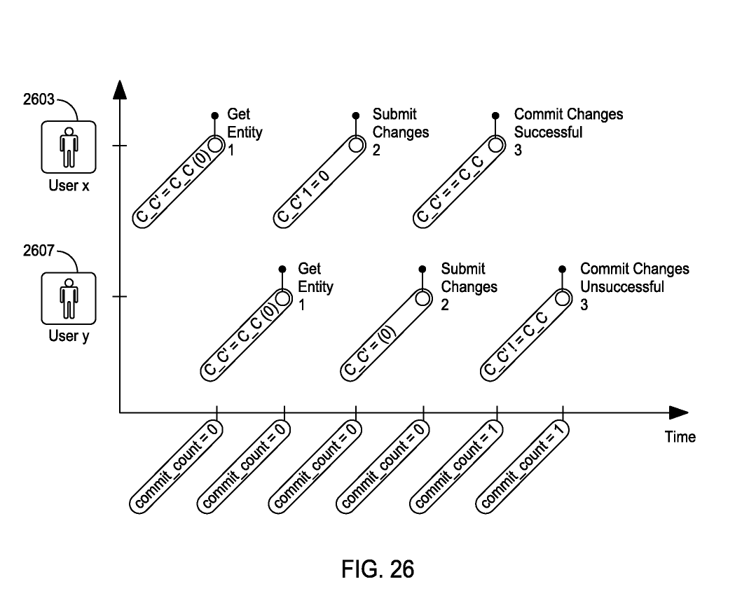

A commit_count numeric Property is attached to each Entity. This Property acts as a monolithically increasing number that increments whenever an update is committed on the Entity. As shown in FIG. 26, when an Entity 2601 from a first user 2603 is loaded, the value of its commit_count Property at the time is stored. Then when another Entity 2605 from a second user 2607 is loaded, the value of its commit_count is also stored. Before committing any changes to this Entity, the stored commit_count value is compared with the latest one in the system. In the example of FIG. 26, the latest commit_count would be the value that was stored when the Entity 2605 was loaded. If the values match, then the changes are committed. If they do not, then a change was performed on this Entity by a separate user-session prior to committing the new ones, and the new changes cannot be committed in order to avoid overwriting Property values.

The use of the commit_count approach enables different user sessions to modify the same Entity concurrently—an Entity is not required to be locked whenever a user session modifies it. Instead, committing Entity changes is performed in a serial fashion.

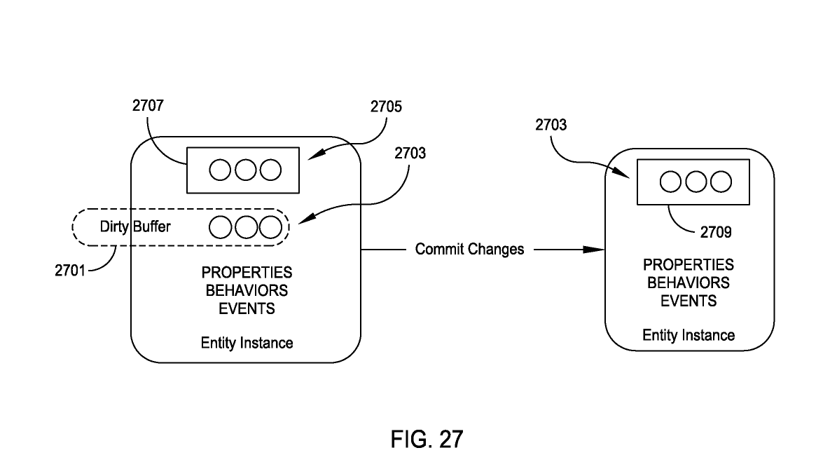

As shown in FIG. 27, a “dirty buffer” 2701 stores new values such as new Properties values 2703 when changes are performed on values such as original Properties values 2705 of an Entity 2707, leaving the original Properies values 2705 intact. If the commit process is allowed to complete, then the values 2703 in the dirty buffer 2701 are used to update the Property values appropriately in the updated Entity 2709. If the commit process is not allowed to proceed, then the original values are retained. In both cases, the dirty buffer is cleared whether the commit process is allowed or not.

### 2.2.3 Entity Cache

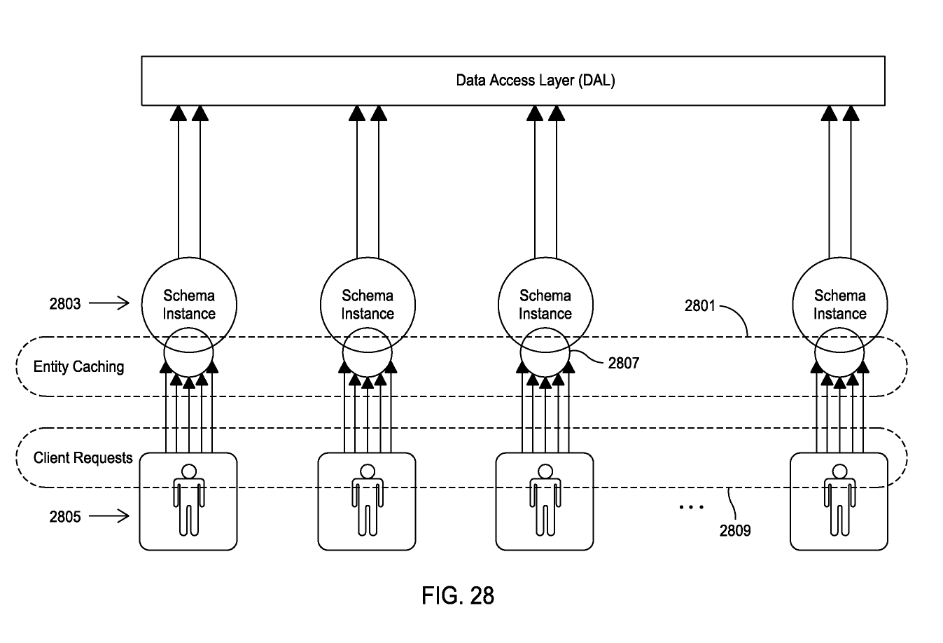

As shown in FIG. 28, entity caching 2801 is implemented at the Schema level 2803 (ref., section 7.2.1.5). Each active user session 2805 is coupled with a small, and easily maintained, container such as the container 2807 that caches the most recently accessed Entities.

The Entity cache does not implement complex synchronization. Instead, it achieves its ultimate aim by minimizing the database queries that result from client application requests 2809.

### 2.2.4 Entity Boxing

Value Entities can be boxed and treated like Named Entities (ref., section 7.1.1.1). Boxing is implemented through the “Boxing” Boolean Attribute Entity. If the Boolean Attribute Entity value is set to “true” in a Value Entity, then the Properties of this Value Entity are treated as if they belonged to a Named Entity.

### 2.2.5 Entity Referencing

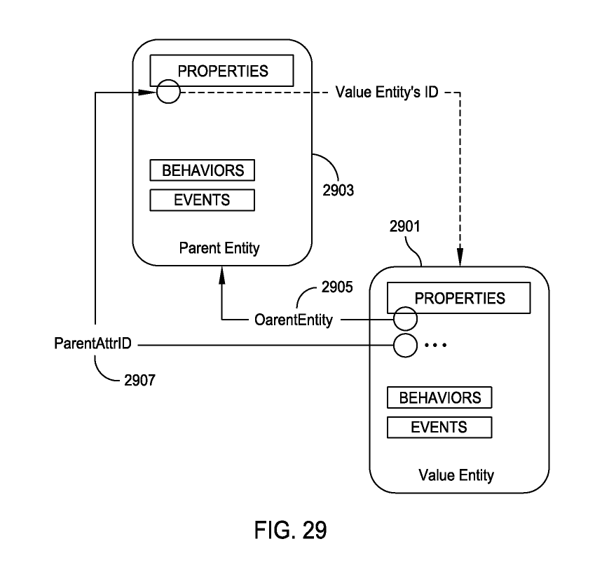

As shown in FIG. 29, entity referencing can be achieved by defining a Value Entity 2901 as an attribute of another Entity—the latter now called the Parent Entity 2903. Parent-child relationships between Entities are established though the ParentEntity 2905 and ParentAttrID 2907 Properties of the referenced Value Entity.

When creating a new Value Entity, the ParentEntity Property is initially set to null. When this Value Entity is assigned as a Property of a Parent Entity, then the ParentEntity Property is set to the ID of the Parent Entity. In turn, the value of the ParentAttrID is set to the ID of the Property in the Parent Entity that references the Value Entity.

The same logic applies for Collection of Entities when assigned to a Property of another Value Entity.

### 2.2.5.1 Where-Used Relations

The Data Engine has visibility over all parent-child relationships. It maintains and validates these relationships through the Where-Used Relations concept. When a Value Entity is referenced by a Parent Entity through a Property of the latter, then a Where-Used Relation exists between the Entity Value and the Parent Entity that references it.

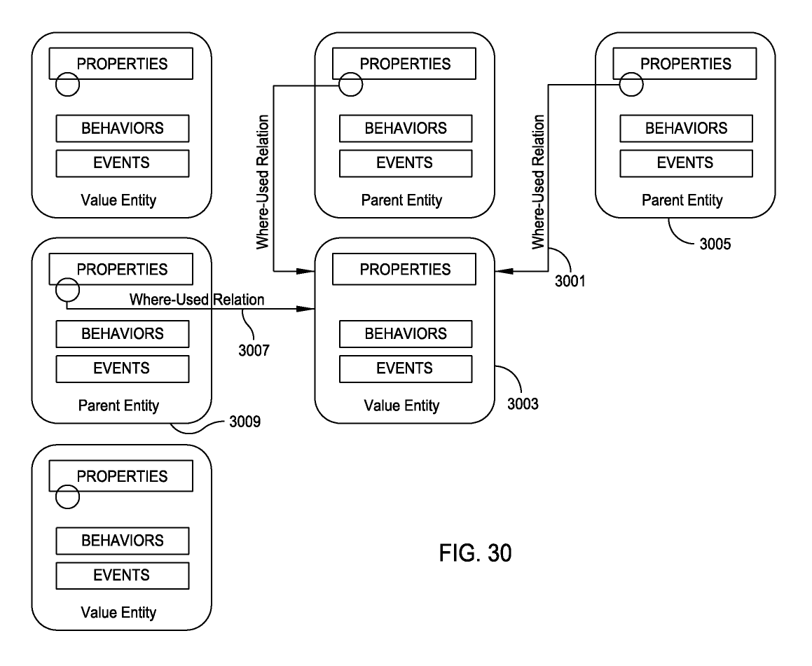

As shown in FIG. 30, the Data Engine automatically creates a Where-Used Relation instance 3001 whenever a Value Entity 3003 is assigned to a Property of a Parent Entity such as the Parent Entity 3005. Similarly, a Where-Used Relation instance 3007 is created when the Value Entity 3003 is assigned to a Property of the Parent Entity 3009, and so on. The Relations 3001 and 3007 are stored in a persistent data source with the following information:
Entity ID—ID of the referenced Value Entity.
Reference Entity ID—ID of the Parent Entity.
Reference Attribute ID—ID of the Property of the Parent Entity that references the Value Entity.

The Data Engine provides capabilities to determine all Parent Entities that reference a given Value Entity.

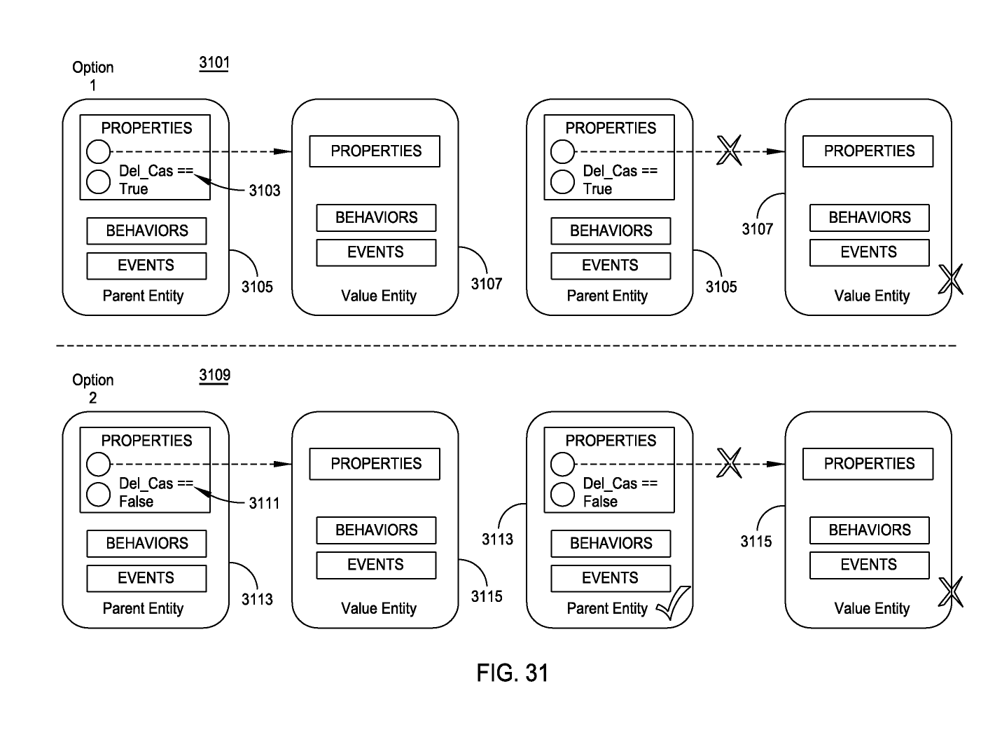

The Data Engine supports cascade delete capabilities whenever referenced Value Entities are deleted. A Del_Cas Boolean Attribute Entity attached to the Parent Entity determines whether or not to delete the Parent Entity whenever the referenced Value Entity is deleted, i.e. when the Where-Used Relation is broken. In FIG. 31, Option 1 (3101) has the Del_Cas Property value 3103 set to “true”. As a result, the Parent Entity 3105 is deleted when the Value Entity 3107 is deleted. Alternatively, Option 2 (3109) has the Del_Cas Property value 3111 set to “false”. As a result, the Parent Entity 3113 is not deleted when the Value Entity 3115 is deleted.

### 2.2.6 Data Access Layer (DAL)

Every Entity Type has a corresponding persistent data source Table, Table View, and Stored Procedure:
Table—stores all instances of the Entity Types
Table View—the result of a join operation between the Table and Table View of the Parent Entity Type (reference FIG. 22)
Stored Procedure—retrieves the entire Entity from the database through one database call

### 2.2.7 Transaction Management

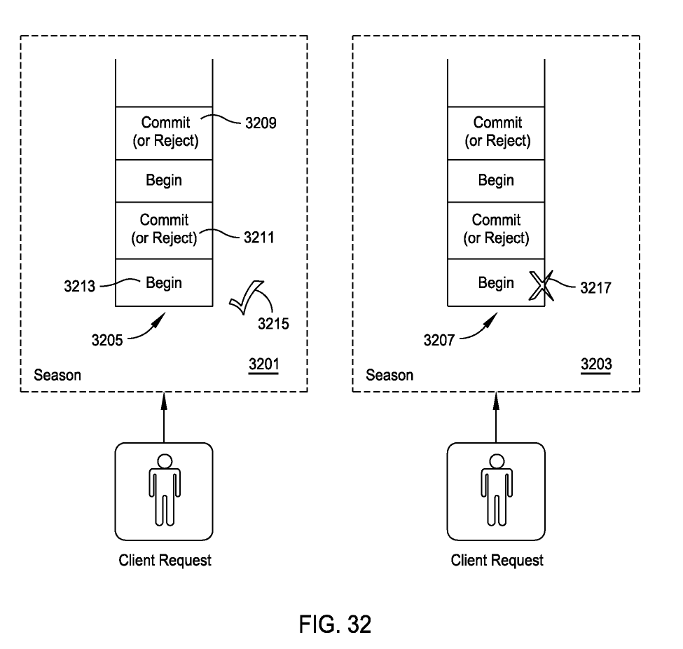

As shown in FIG. 32, each user session 3201, 3203 stores a stack 3205, 3207, respectively, for all outstanding and nested transactions to perform. Transactions are either committed 3209 or rolled back (rejected) 3211. Prior to committing or rolling back a transaction, a “Begin” token 3213 is attached to a transaction. When the transaction is being committed, or rolled back, the system validates 3215 that the transaction in question is indeed the most recent transaction. If not, then a “Begin”/“End” mismatch 3217 is encountered and the stack is emptied until a “Begin”/“End” match.

### 2.2.8 The Helper Class

The Data Engine also defines a finite set of static methods that enable easier use of the methods defined in the Engine. These static methods are implemented in the Helper class and provide the following capabilities:
Acquire handler to the current Schema
Acquire handler to a Schema specified by its Name
Instantiate an Entity of a specified Entity Type
Instantiate an Entity of a specific Entity Type specified by Name
Delete an Entity specified by its handler
Delete an Entity specified by its Entity ID
Delete an Entity specified by its 64-bit internal ID
Acquire handler to an Entity specified by its Entity ID
Acquire handler to an Entity specified by its 64-bit internal ID
Acquire handler to an Entity specified by its 64-bit internal ID and Entity Type ID
Acquire handler to an Entity specified by its Entity Type Name and Entity Name
Save an Entity into a persistent data source
Return all Entities that belong to the specified Entity Type and that match the specified condition
Return all Entities the specified Property of which matches at least one of the given value set

2.3 Code Generator

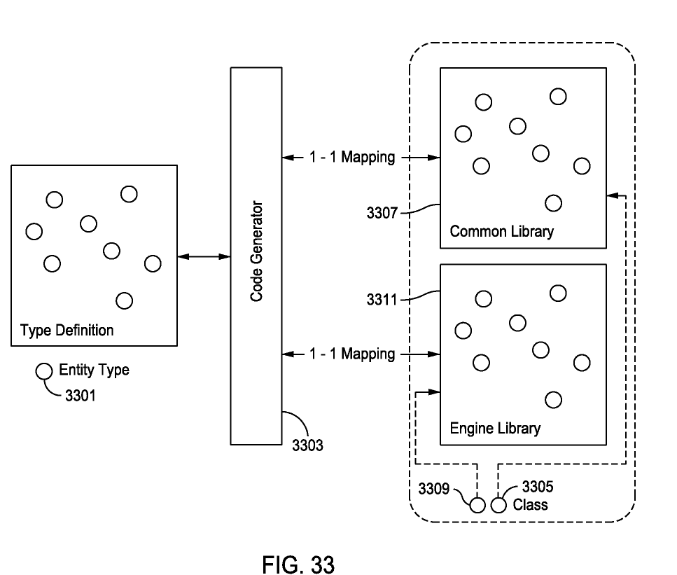

The Code Generator helps generate server-side classes. These classes are generated based on the Entity Type definitions performed by the user at the level of the Type System. As shown in FIG. 33, for every Entity Type 3301 defined, the Code Generator 3303 creates two matching classes: one 3305 in the Common Library 3307, and another 3309 in the Engine Library 3311. There is a one-to-one mapping between the Entity Types defined in the Type System and the generated classes in both the Common and Engine libraries.

### 2.3.1 Common Library

The classes in the Common Library define the strong-typed constructors, property declarations, and constant declarations of every Entity Type defined in the system. The modification of these classes is not allowed.

For each Entity Type defined in the Type System, the Code Generator creates three C# files¹:
<Entity Type Name>.builder.cs—contains two constructors and property definitions.
<Entity Type Name>Collection.builder.cs—contains a collection class.
Constants.builder.cs—contains all constant declarations.

### 2.3.2 Engine Library

Users can edit the classes in the Engine Library. Business logic is implemented in defined Method Entity Types. The Code Generator creates method stubs, with the correct method signature, based on the method's definition in the Type System.

For each Entity Type defined in the Type System, the Code Generator creates two C# files¹:
<Entity Type Name>.builder.cs—in addition to other methods, this file contains one C# method for every method in the user-defined Entity Type. These C# methods take a single CArg as a parameter and their returned type is also CArg. These methods are wrappers for the methods in the <Entity Type Name>.cs files and they are used for marshalling and un-marshalling parameters when actual methods are being invoked over the network. Note that this file is completely created by the Code Generator, and users must not modify it.
<Entity Type Name>.cs—this file contains C# methods with the formal parameter list and returned type that match the method definitions in the user-defined Entity Type. The user must update these methods with proper implementations.

### 2.3.3 Code Generator Modules

Five modules define the Code Generator. These include:
Builder Helper—defines for the ProjectInfo class as well as other common methods.
Csc Compiler—invokes the command-line compiler to generate the Common and Engine Library DLLs.
Common Builder—generates code for Common Library DLLs.
Engine Builder—generates code for the Engine Library DLLs.
Project Builder—manages the project.

### 2.3.3.1 Builder Helper

The BuilderHelper.cs defines the following classes:

ProjectInfo.cs—this class contains the following Properties:
Path—the relative path of the project in the corresponding Solution
Project File Name—the name of the project file (*.csproj)
Project GUID—the Globally Unique IDentifier (GUID) of the project
Default Name Space—the default namespace of the project BuilderHelper.cs—this class contains the following Methods:
Add Project—creates a new project in the solution.
Add Reference—adds reference for the project.
Backup File—backups existing files, if any.
Build Project—invokes the Csc Compiler to compile the project.
Get Package GUID—returns the GUID of the current solution.
Get Project Info—returns project information from the current solution.
Get Project References—returns project references.
Get Project Source Files—returns a list of all documents in the project.
Get Relatively Path—returns relative path for the directory.

CommonBuilder.cs—this class contains the following Methods:
Create Entity Type File—creates the common class that corresponds to the given entity type. All attributes in the Entity Type are declared as C# properties. This method returns the project list that the generated class needs to reference.
Create Constants File—creates Constants.cs, that contains all Constant declarations for the Entity Type and its attributes.
Create Collection File—creates the collection module that declares a collection for the given Entity Type.

EngineBuilder.cs—this class contains the following Methods:
Create Engine Class—creates the Engine class that corresponds to the given Entity Type. This class consists of two parts: one is based on the CArg parameter convention and the other is based on the actual user-defined parameter list for the method. This method returns the project list for the generated class needs to reference.

CscCompiler.cs—this class contains the following Properties and Method:
CscExe—absolute path for the C# Csc compiler.
Output Path—path of the output file directory.
Output File Name—name of the output file.
Source Files—list of files to be compiled.
Source Folders—list of directories to be compiled.
References—list of DLLs that must be referenced.
Compile (Method)—invoke the compiler tool based on the pre-set property values

ProjectBuilder.cs—this class contains the following Methods:
Add To Project—adds a file to the given project.
Create Assembly File—creates the Assembly.cs file.
Create Common Project—creates the Common project.
Create Engine Project—creates the Engine project.
Create Project File—creates the Project file (*.csproj).
File Is Exist In Project—determines whether the file is already in the project or not.
Remove From Project—removes a file from the Project.

### 2.3.4 Code Generation Algorithm

Two different Code Generation algorithms are defined when creating and deleting an Entity Type. These are detailed below.

### 2.3.4.1 Create a New Entity Type

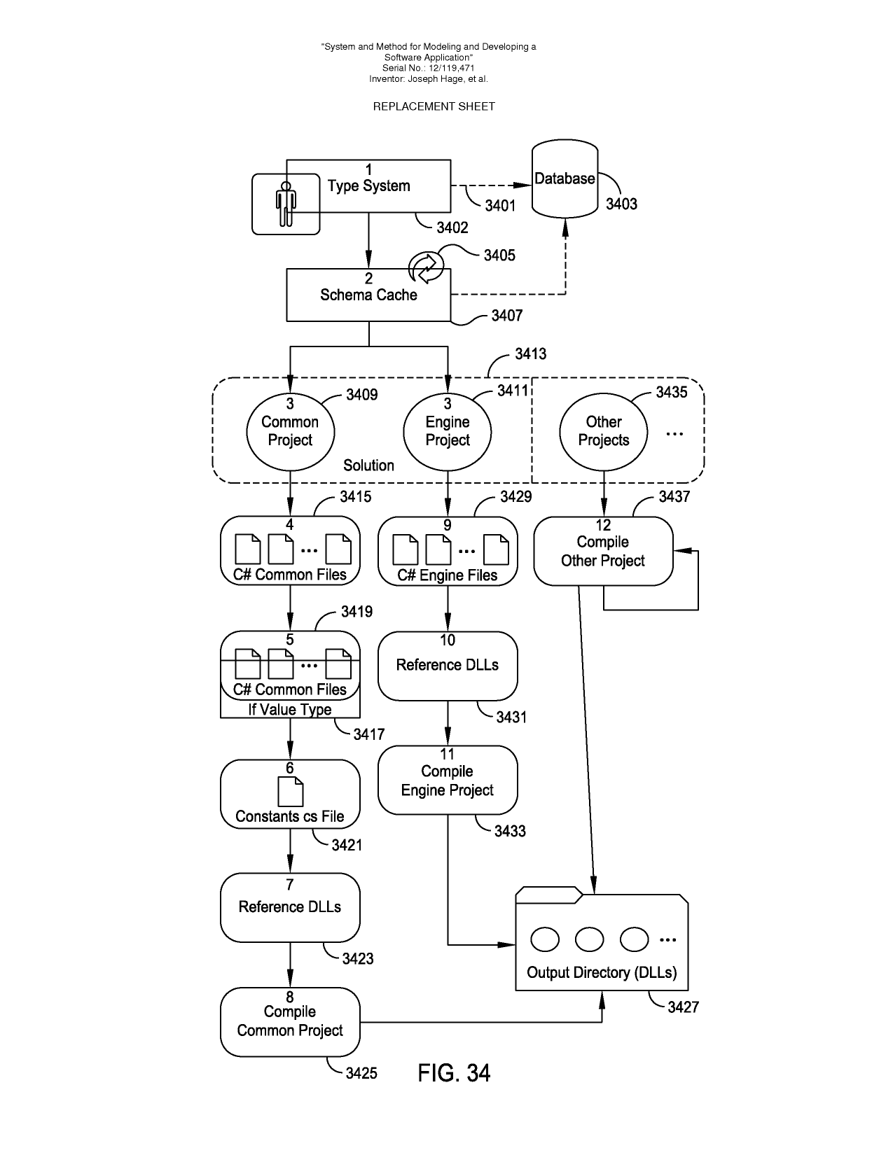

FIG. 34 shows the following algorithm that is defined when a user creates a new Entity Type and publishes the changes:
1. Save 3401 the Entity Type information 3402 into the database 3403.
2. Reload 3405 the Schema cache 3407 from the database.
3. Retrieve the corresponding Common 3409 and Engine 3411 project information from the current Solution file 3413. If these projects do not exist, create these projects and add them to the Solution.
4. Generate the C# source files 3415 for Common and add them to the Common project.
5. If the Entity Type is a Value Type 3417, then generate the corresponding Collection C# file 3419 and add that to the Common project.
6. Generate Constants.cs 3421 based on the Type definition in the new Schema and add the file to the Common project.
7. Check to see whether any necessary DLLs 3423 are already being referenced by the project. If not, then add these into the project's reference list.
8. Call the Compile method in the CscCompiler class to compile the files in the Common project 3425, and copy the DLL into the Output directory 3427 under the current directory.
9. Generate the C# files for Engine 3429 and add them to the Engine project.
10. Check to see whether any necessary DLLs 3431 are already being referenced by the project. If not, add these into the project's reference list.
11. Call the Compile method in the CscCompiler class to compile the files in the Engine project 3433, and copy the DLL into the Output directory 3427 under the current directory.
12. Loop through other projects 3435 in the current solution and re-compile 3437 every project that references the Common and Engine projects that have just been compiled.

### 2.3.4.2 Delete a New Entity

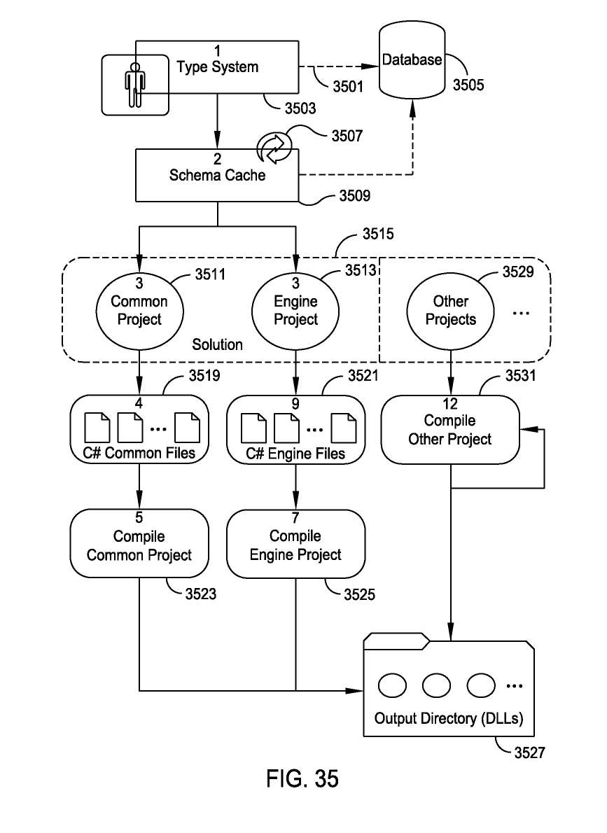

FIG. 35 shows the following algorithm that is defined when a user deletes a new Entity Type and publishes the changes:
1. Save 3501 the new Entity Type information 3503 into the database 3505.
2. Reload 3507 the Schema cache 3509 from the database.
3. Retrieve the corresponding Common 3511 and Engine 3513 project information from the current Solution file 3515.
4. Remove corresponding C# files from the Common project 3519 and Engine project 3521.
5. Call the Compile method 3523 in the CscCompiler class to compile the files in the Common project and Compile method 3525 to compile the files in the Engine project, and copy the DLL into the Output directory 3527 under the current directory.
6. Loop through other projects 3529 in the current solution and re-compile 3531 every project that references the Common and Engine projects that have just been compiled.

### 3. ENABLING SERVICES

Embodiments of the invention host a set of predefined Enabling Services. These include the Rule Engine, Access Control, Localization, Notification, Resources Management, Search Engine, Traceability, Document Management, and File Management.

The following details the implementation of each of the above-mentioned Enabling Services. It highlights the different Business Entities, their Properties, Behavior implementation, and their relationship with other Entity Types and components of the system.

3.1 Rule Engine

### 3.1.1 Definition

The Rule Engine Enabling Service defines and executes business rules at the level of Business Entities. The Rule Engine also provides the required abstraction to let users maintain these business rules with little source code maintenance involvement.

Business rules help define the Property values of Business Entities automatically based on editable rules and conditions. Business rules also govern the behavior of workflows (ref., section 8.11) by defining the transition rule conditions between each node in workflows.

Business rules are utilized at two different levels:
Calculated Attributes—Properties of Business Entities can be set as user-defined expressions or algorithms (ref., section 8.1.1.1). The Rule Engine Enabling Service processes these expressions and algorithms, determines their resulting value, and populates the Property values accordingly. Moreover, the Rule Engine Enabling Service is constantly aware of any changes performed on Business Entities to help calculate their Property values accordingly, assuming the latter make use of user-defined expressions or algorithms.
Condition Evaluation—the Rule Engine Enabling Service also evaluates algorithms and conditions that are attached to Workflow transitions. The Boolean values returned by the Rule Engine Enabling Service upon processing these algorithms and conditions govern the transition rules of a Workflow.

### 3.1.1.1 Algorithm Specifications

The algorithms that can be attached to Business Entity Properties and Workflow transition rules are defined as String values. The String abides by the following grammar:

| | |
|---|---|
| algorithm: | expr ; |
| plusminus: | ‘+’ \| ‘−’ ; |
| muldiv: | ‘*’ \| ‘/’ ; |
| compare: | ‘=’ \| ‘>’ \| ‘<’ \| ‘>=’ \| ‘<=’ \| ‘<>’ ; |

| | | |
|---|---|---|
| andor: | ‘and’ | \| ‘or’ ; |

| | |
|---|---|
| condition: | expr compare expr \| |
| | ‘(’ condition ‘)’ \| |
| | condition andor condition ; |
| aggr: | ‘COUNT’ \| ‘SUM’ \| ‘AVERAGE’ ; |

| | |
|---|---|
| aggregation: | aggr ‘(’ attribute ‘,’ condition ‘)’ ; |

| | |
|---|---|
| uomliteral: | TO_CURRENCY \| |
| | TO_DURATION \| |
| | TO_WEIGHT \| |
| | TO_LENGTH \| |
| | TO_AREA \| |
| | TO_VOLUMN \| |
| | TO_TEMPERATURE ; |
| uom: | uomliteral ‘(’ numeral ‘,’ literal ‘)’ ; |

| | |
|---|---|
| arglist: | atom \| |

| | arglist ‘,’ atom ; | | |
|---|---|---|---|
| method: | identifier ‘(’ arglist ‘)’ | \| | // local context |

| | |
|---|---|
| identifier ‘:’ Method ; | // global context |

| | | | |
|---|---|---|---|
| attribute: | identifier | \| | // local context |

| | | |
|---|---|---|
| identifier ‘.’ Attribute | \| | // attribute path |

| | |
|---|---|
| identifier ‘:’ identifier ‘.’ Attribute ; | // global context |

| | | | |
|---|---|---|---|
| atom: | numeral | \| | |
| | aggregation | \| | |
| | attribute | \| | |
| | method | | \| |
| | uom ; | | |
| expr: | atom | | \| |

| | | |
|---|---|---|
| expr plusminus expr | | \| |
| expr muldiv expr | \| | |
| ‘(’ expr ‘)’ | | \| |

‘if’ ‘(’ condition ‘)’ ‘then’ expr ‘else’ expr ;

Based on the above grammar and its end Tokens, the Rule Engine Enabling Service can return any of the following data types: integer, long, double, duration, currency, date time, weight, length, temperature, volume, and area.

Moreover, the grammar allows the creation of the following expressions and algorithms:
Arithmetic Operators—these include ‘+’, ‘−’, ‘*’, and ‘/’,
Property References—expressions and algorithms can reference the Properties of other Business Entities and make use of these Property values in their evaluation.
Currency Arithmetic—built-in support for currency-based operations.
Duration Arithmetic—built-in support for duration-related operations.
Unit of Measure (UOM) Arithmetic—built-in support for UOM-related operations. UOMs include Weight, Length, Area, Volume, and Temperature.
Aggregation Methods—these include SUM, AVERAGE, and COUNT operations that can be performed on multi-valued Properties of a Value Entity. Filtering criteria can be tagged to each aggregation method to apply the method on only a subset of these multi-value Properties.
Method Name—expressions and algorithms can contain references to user-defined methods. These methods extend the capabilities of the Rule Engine by implementing more complex user-defined algorithms.

Once the Rule Engine Enabling Service processes an expression or algorithm that is assigned to a Property of a Business Entity, then the resulting value is stored in the database. This will enable other Enabling Services (e.g., Search Engine) to leverage these values in user-implementation of choice.

### 3.1.2 Programmatic Interfaces

Both the Data Engine (ref., section 7.2 and client-side applications benefit from the services of the Rule Engine Enabling Service through the following public method:
public object Calculate(CEntity en, string algorithm);

The “algorithm” String value is defined based on the specifications outlined in section 8.1.1.1.

In some instances, the expressions and algorithm capabilities of the Rule Engine Enabling Service do not satisfy the requirements of the user. In such instances, user-defined methods can help implement these requirements. These custom methods are called through the following public method:
public object CallMethod(string methodName);

### 3.1.2.1 Currency Methods

The following lists the public methods of the Rule Engine Entity Service that relate to Currency operations:

```
  // Return true if the two currency values have the same currency symbol
  public static bool IsSameUnit(Currency a, Currency b);
// Return true if all currency values in the multi-value attribute have the
same currency symbol; ‘condition’ can be used to filter value set.
  public static bool IsSameUnit(CArray vset, string attrname, string
  condition);
  // Return a + b. Currency symbols have to be the same
  public static Currency Add(Currency a, Currency b);
  // Return a − b. Currency symbols have to be the same
  public static Currency Subtract(Currency a, Currency b);
// Return a * b
public static Currency Multiply(Currency a, double b);
// Return a * b
  public static Currency Multiply (double a, Currency b);
  // return a / b; return currency
  public static Currency Divide(Currency a, double b);
  // return a / b; return double
  public static double Divide(Currency a, Currency b);
  // return summation of currency value set; with optional filter
  public static Currency Sum(CArray vset, string attrname, string
  condition);
  // return average of currency value set; with optional filter
      public static Currency Average(CArray vset, string attrname, string
      condition);
```

### 3.1.2.2 Duration Methods

The following lists the public methods of the Rule Engine Entity Service that relate to Duration operations:

```
// return true if the two duration units are the same
public static bool IsSameUnit(Cduration a, Cduration b);
// return true if all duration units in the value set are the same
public static bool IsSameUnit(CArray vset, string subattr, string
condition);
// DateTime + Duration; returns DateTime
public static DateTime Add(DateTime a, Cduration b);
  // Duration + DateTime; returns DateTime
  public static DateTime Add(Cduration a, DateTime b);
  // Duration + Duration; returns Duration; units have to be the same
  public static Cduration Add(Cduration a, Cduration b);
  // DateTime − DateTime; returns Duration in days
  public static Cduration DiffDay(DateTime a, DateTime b);
  // DateTime − DateTime; returns Duration in months
  public static Cduration DiffMonth(DateTime a, DateTime b);
  // DateTime − Duration; returns DateTime
  public static DateTime Subtract(DateTime a, Cduration b);
  // Duration − Duration; returns Duration; units have to be the same
  public static Cduration Subtract(Cduration a, Cduration b);
  // Duration * constant; return Duration
  public static Cduration Multiply(Cduration a, double b);
  // Constant * Duration; return Duration
  public static Cduration Multiply(double a, Cduration b);
  // Duration / Constant; return Duration
  public static Cduration Divide(Cduration a, double b);
  // Duration / Duration; return Constant
  public static double Divide(Cduration a, Cduration b);
  // return summation of duration value set; with optional filter
  public static Cduration Sum(CArray vset, string attrname, string
  condition);
  // return average of duration value set; with optional filter
public static Cduration Average(CArray vset, string attrname, string
condition);
```

### 3.1.3. Reference

Reference the provisional document DMS0000044 for more details on the Rule Engine Enabling Service.

3.2 Access Control

### 3.2.1 Definition

The Access Control Enabling Service implements an authorization security layer that controls access to defined Business Entities. It acts on every method invocation initiated by the user to validate access privileges. The Access Control Enabling Service thus operates within the boundaries of the Method Dispatcher (ref., section 11).

Users benefit from the Access Control Enabling Service to determine access restrictions for system and user-defined Entity Types, Entities, Properties, and Behaviors. It helps setup Entity Type-based permissions to define access rights to all, or a subset, of Entities. Is also helps setup Entity-based permissions to define access rights to specific Entity Type instances.

Access Control is enforced as part of the method dispatching mechanism. That said, user permissions are checked only once for every explicit method invocation-including when a dispatching call can in turn invoke more than one internal method, including base methods, pre-triggers, and post-triggers.

### 3.2.2 Related Entity Types

The following is a set of definitions and semantics defined within the context of the Access Control Enabling Service. Entity Types required for the implementation of this Enabling Service are also listed:
Permissions—a security token that provides its holder with access to a method on an Entity Type or on an Entity. An Entity Type-based Permission consists of a reference to a Method Entity, an Entity Type, and a qualifying condition. Alternatively, an Entity-based Permission consists of a reference to a Method Entity, an explicit Entity reference, and optionally a view type that provides Property-level security.
Roles—a Role Entity groups a set of Permissions together. These Permissions can be either Entity Type-based, Entity instance-based, or both. A role can also contain other roles.
Role Assignments—a role may be assigned to a Resource (ref., section 8.5) through the Roles Property of the Resource. Such an assignment can be enabled or disabled. The assignment can also carry an expiration date time. Role assignment is modeled by the Role Assignment Entity Type.
Entity Type—Based Access Control Semantics—the semantic of the Entity Type-based access control is that a user who has the Permission can invoke the specified method on an Entity of the specified Entity Type and the Entity matches the specified condition before method invocation. In case of a View Entity Type, such access may be limited only to Properties that are exposed by the Entity View Type.
Entity-Based Access Control Semantics—the semantic of Entity-based access control is that a user who has the Permission can invoke the specified Behavior on the specified Entity. Such access may be limited only to Properties that are exposed by the View Type, if specified.
Conditional Permissions—for Entity Type-based permissions, an optional condition may be imposed to qualify the Permission with a certain condition. This is done by using the Condition Property on the Permission instance. The value of the Property will be fed to the Rule Engine (ref., section 8.1) for Boolean evaluation at run time.
Access Denial—a Permission is never meant to deny access. The absence of certain Permissions to a user implies that the user does not have Permission for a certain task.
Fine-Granularity Access Control—some methods require Property-level access control. This can be achieved through definitions of views (ref., section 7.1.2.1). A View Type can be defined to expose a subset of Properties of one or two Entity Types. This is an effective way to provide fine-grain access control at Property level.
Wild Cards—wild cards are supported for Entity Type-based access control. If method is null, the Permission applies to all Behaviors. If Entity Type is null, the Permission applies to Entities of all types. If condition is null, the permission unconditionally applies to all Entities of the specified type. A super-user Permission can therefore be defined with an Entity Type-Based Permission instance with null method, null Entity Type, and null condition.
Base Method, Pre-Trigger, and Post-Trigger—a Permission to invoke a Behavior also assumes Permission to invoke the Behavior's pre-trigger or post-trigger, if any (ref., section 11). For example, if Behavior 1 is defined as a pre-trigger of Behavior 2, and User A has Permission to invoke Behavior 2, then User 2 automatically has the permission to invoke Behavior 1 when Behavior 2 is invoked.

However, some service-layer methods support batch operations, meaning a single method can be called on multiple Entities in the same method invocation. In these cases, access control is checked for every single Entity. If any of these Entities fails the check, then the entire method invocation fails.
Entity Type Inheritance—if the specified Entity Type in a Permission is a Base Entity Type (ref., section 7.1.1), then it applies to all instances of this type as well as all of the derived types.
Nested Roles—a role can contain other roles as nested roles or sub-roles. Nested roles are supported through the Roles Property of the Role Entity Type. When a Role is assigned to a Resource, then the Resource assumes Permissions in the Role as well as those in all the nested Roles.
Users and Groups—a role can be assigned to a group (ref., section 8.5). A user who belongs to a user group will automatically assume all roles assigned to the group.
Nested Groups—a group can contain other groups as nested groups or sub-groups. Nested groups are supported through the Groups Property of the Group Entity Type. A Resource who belongs to a Group assumes all Roles assigned to the Group as well as all Roles assigned to Groups that contain this Group, also known as parent Groups.
Session Permission Descriptor—when a client session (ref., section 7.2.1.5) is created upon user login, the system performs the following steps:
   1) Compile a list of Group IDs that the user belongs to (including parent Groups)
   2) A list of roles and sub-roles that are assigned to the current user and all these groups will be compiled
   3) A hash table is created, containing all Permission instances for these roles. The hash key for the hash table is the Method ID. Permissions with the same Method ID will be chained linearly in the same hash slot. This hash table will be encapsulated into a session permission descriptor. The session permission descriptor represents the current user's permission rights for the duration of the session
Demand a Permission Match with Session Permission Descriptor—when a client application requests to invoke a certain method on a certain Entity on behalf of a user session, the system performs the following steps:
1) The method dispatcher calls the Access Control Enabling Service to request a Permission match
2) The Access Control Enabling Service performs a hash table lookup in the user's Permission descriptor using the method ID as the key. The lookup will return a list of Permissions for this method.
3) The Access Control Enabling Service then linearly scans this list to see whether a Permission exists that matches the current Entity. Permission to invoke the method will be granted if such a Permission match is found
Early binding—the Permission descriptor is constructed and loaded into memory at the time a user logs in. The permission descriptor remains unchanged throughout the duration of the user session. This implies that any permission assignment changes after a user signs in will not be in effect until the assignee logs out the system

### 3.2.3 Programmatic Interfaces

The Access Control Enabling Service defines the following public methods:
Demand—called by the method dispatcher (ref., section 6) to perform the run-time access control check. It returns “true” if the current session has the Permission to invoke the given Behavior on the given Entity, or “false” otherwise.
This method performs a hash table lookup to determine if there is a Permission match. The hash key is the method Entity ID. The data item to be hashed for each table slot is a chain of permissions.
   public static bool Demand(CEntityID method, CEntityID entity);
This method calls one of the two private methods, depending on whether a permission lookup is performed on an Entity Type or an Entity:
   //check type-based security
   private bool DemandTypeBased(CentityID mth, CentityID en, CEntity typebased);
   //check entity-based security
   private bool DemandEntityBased(CentityID mth, CentityID en, CEntity enbased);
Load Permissions—loads the current Resource's Permissions and caches them in the hash table. This hash table will then be maintained in the session table on the service side. The permission hash table is also called permission descriptor. This method is called when a user logs into the system.
   public static void LoadPermissions( );
This method calls three private methods:

// Returns all Groups the current Resource belongs to, including the sub-
groups private void LoadGroupsByUser ( )
// Returns all Roles assigned to a resource, including the sub-roles
private void LoadRolesByResource ( )
// Returns all Permissions of a given role
private void LoadPermissionsByRole ( )

This method uses the following algirithm:

LoadGroupsByUser( );
For each Group found and for current Resource {

LoadRolesByResource( );
For each Role found {

LoadPermissionsByRole( )
For each permission {

Insert into Permission descriptor

}

}

}

Get Search Filter—if a user has the permission to load Entities of a certain Type, and the permission defines a certain condition, then the condition will need to be passed to the Search Engine (ref., section 3.6) as a search filter to limit the Entities that are returned to the user when an arbitrary search is performed on the Entity Type.
These search filters, if available, will be appended to the Where clauses of SQL statements to further limit the number of entities returned from the database. The method to obtain search filters is:
   public static ArrayList GetSearchFilters(string typename);
This method will perform a search in the current user's session Permission descriptor to see if search filtering is necessary.
The Search Engine calls this method before executing any query. If the method returns null, then the current user cannot see any of the Entities in the type, and the Search Engine then returns no Entities to the user. If the method returns an empty list, then the current user can see all Entities in the type, and the Search Engine will not apply any Permission filter to the query criteria. If the method returns a list with filters, then the current user can see a subset of all Entities in the type:
   If only one filter is returned, it will be appended to the SQL Where clause with an And operator
   If more than one filter is returned, they will all be appended to the SQL, one at a time, and all will be connected with the UNION ALL clause

### 3.2.4 Reference

Reference the provisional document DMS0000045 for more details on the Access Control Enabling Service.

3.3 Localization

### 3.3.1 Definition

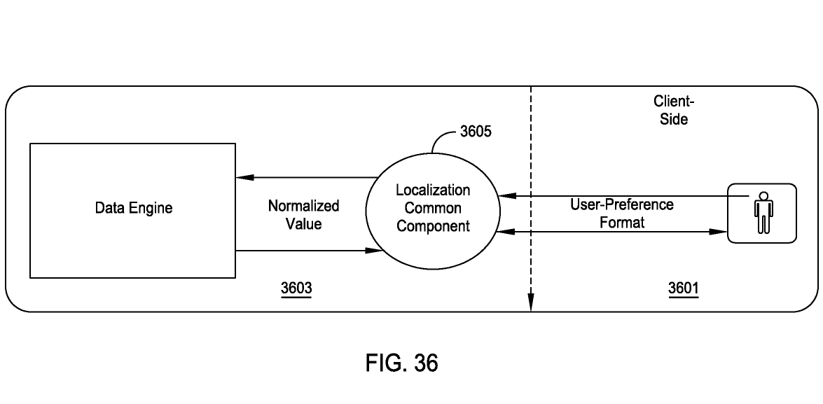

The Localization Enabling Service provides the necessary application customization capabilities to match different user cultural preferences. As shown in FIG. 36, when values flow from the client-side 3601 into a system 3603 embodying the invention, they are normalized by the Localization Enabling Service 3605 and stored in the database accordingly. Based on the user's preferences, these normalized values are reformatted, or recalculated, and passed to the client layer.

### 3.3.2 Related Entity Types & Programmatic Interfaces

The Localization Enabling Service provides multi-lingual, date/time format, number format, currency format, unit of measure, and time zone preferences support.

The following details the Entity Types required for the support of these preferences, along with the provided Programmatic Interfaces to benefit from the Localization capabilities.

### 3.3.2.1 Multi-Lingual Support

The Localization Enabling Service enables Business Entities to host the same Property values in different languages. It achieves multi-language support within a Business Application by creating different versions of Property values within the same Entity (ref., section 3.10).

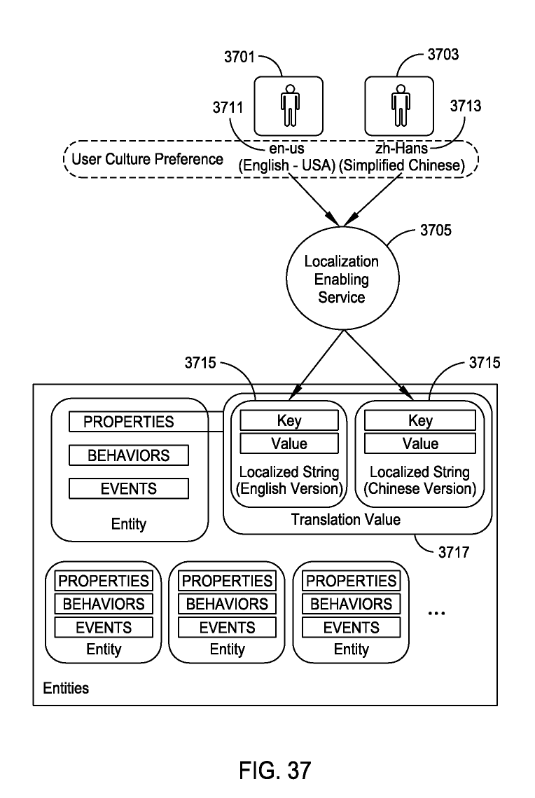

Localizable Attribute Entities have different versions hosting different languages of the same Property value. If the user's preferences do not specify what Culture to load, then the Localization Enabling Service loads the Property version of the default Culture. For example, FIG. 37 shows two available versions of a Property, including English 3701 and Chinese 3703. The Localization Enabling Service 3705 returns either the English 3707 or the Chinese 3709 Property value depending on the chosen Culture (i.e., en-us 3711 or zh-Hans 3713).

The Localization Enabling Service 3705 supports both Neutral and Specific Cultures. While a Neutral Culture represents a region-independent language (e.g., English or Chinese), a Specific Culture represents a region-specific language (e.g., American English or Simplified Chinese).

The Localization Enabling Service defines a new Value Entity Type called Localized String 3715. In turn, the Localized String Entity Type defines two Properties:
Key—String defined in the “<culture name>-<attribute name>-<sequence number>” format:
   <culture name>—the Neutral or Specific Culture associated with the Property value
   <attribute name>—the Internal Name of the Property
   <sequence number>—the non-negative sequence number specifying the index of a multi-value attribute set. The sequence number is set to 0 for single-value Localizable Attribute
Value-String that contains the localized value

In addition, a new Translation Value 3717 multi-value Property is added to the system-defined Root Entity (ref., section 2.1.3). The Translation Value Property is of the Localized String Entity Type. It contains all localized strings of all supported languages of the current Entity.

To load the localized strings of an Entity, the following public method is provided:
public string GetLocalizedStrings(CEntityID attrid, string culture, CArray transattr);

This method will return a localized string for the specified Property based on the given Culture. The “transattr” parameter contains all translated strings of the current Entity, and this method simply performs a lookup in this parameter and returns the relevant string from it.

### 3.3.2.2 Date/Time & Number Format

Date/time and number format preferences are defined through the user's preference settings. The Localization Enabling Service saves the date/time and numbers in normalized form (i.e., in the GMT time zone for time values). When the value is loaded to display on the client side, it is converted to the correct date/time and number format based on the user-preferred time zone.

When a client application issues a search request that includes a time-based Property as a search condition, then the Localization Enabling Service transforms the user-specified time value from the user-preferred time zone into the GMT format before passing it to the Search Engine (ref., section 3.6) for processing.

### 3.3.2.3 Unit of Measure

The Localization Enabling Service handles Unit of Measure (UOM) values. UOM includes weight, length, area, volume, and temperature. All these values are stored in normalized form without unit qualifications.

The normalized UOM units are initially set in the Localization Component much like selecting the default Culture.

### 3.3.3 Reference

Reference the provisional document DMS0000046 for more details on the Localization Enabling Service.

3.4 Notification

### 3.4.1 Introduction

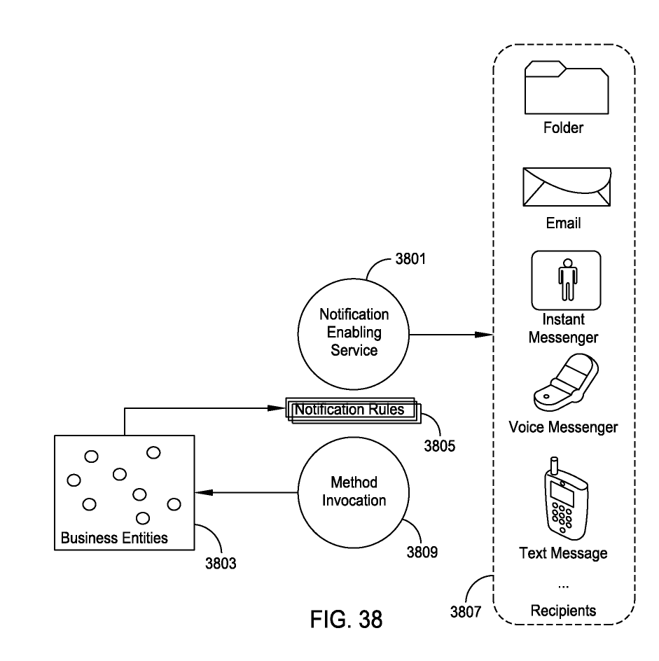

As shown in FIG. 38, the Notification Enabling Service 3801 is a message communication carrier for Business Entities 3803 to communicate with each other. To that end, the Notification Enabling Service defines both Notification Rules 3805 and Notification Processes (not shown): Notification Rules specify what resources 3807 to notify in the occurrence of an event on an Entity; Notification Processes represent the execution of such rules.

For example, a Notification Rule can be set up between two Business Entities such that when an event occurs to one of these Business Entities, then a method invocation 3809 is triggered on the other Entity.

### 3.4.2 Related Entity Types

Notification Rules are implemented by a Value Entity Type called Notification. The Notification Entity Type defines the following Properties:
Initiator—an Attribute Entity of type Resource (ref., section 3.5), containing the Resource that creates the notification rule.
Notification Events—a multi-value Attribute Entity of type Method, containing the Method IDs of the methods that represent notification events. Any of these events can trigger the Notification Enabling Service to act.
Upon Success—an Attribute Entity of type Boolean, controlling whether or not to send notifications based on the success or failure of the invoked notification event.
Creation Date—an Attribute Entity of type Date, containing when the notification rule is created.
Expiration Date—an Attribute Entity of type Date, containing an optional expiration date for the Notification Rule.
Delivery—a multi-value Attribute Entity of type Delivery, specifying how notification messages are delivered. The Delivery Value Entity Type defines the following Properties:
   Delivery Type—an enumeration Entity Type, specifying the delivery mechanism (e.g., email, instant message, folder, voice message, or text message).
   Recipients—a multi-value Attribute Entity, identifying the recipients that will receive the notification message.
Comment—an Attribute Entity of type String, containing an arbitrary text message.
Message—an Attribute Entity pointing to a Message Template Entity, and providing a mechanism for users to specify customized notification messages.

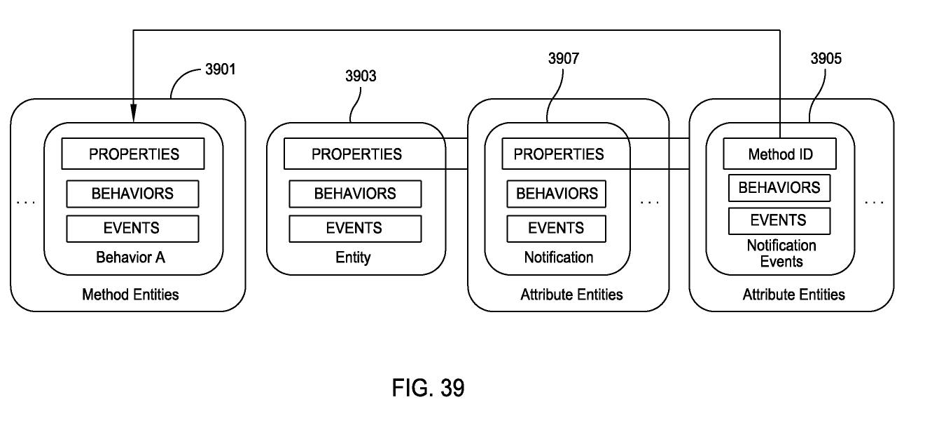

When an Entity defines a multi-value Property of type Notification, then the notification service is enabled for that type. As shown in FIG. 39, when a method 3901 of an entity 3903 is invoked, the Notification Enabling Service checks the Notification Events Property 3905 of the Notification Value Entity 3907 which, in turn, is a Property of the current Entity 3903—to locate the ID of the current method. If the Method ID is found, then a notification is triggered.

Notification messages are different for emails and folders:
Email Notification-email bodies are defined by Message Template Entity Types. For example, different emails are sent based on the Upon Success Property value of the Notification Rule Entity Type:
   If Upon Success is set to True, then the following email is sent: “<user> invoked <method name> on <entity type name> <entity name> on <datetime> with success status.”
   If Upon Success is set to False, then the following email is sent: “<user> invoked <method name> on <entity type name> <entity name> on <datetime> with failure status. Error message is <error message>.”
Message Template Entity Types define parameterized notification message templates. This Entity Type defines only one Property: a “Message Body” that contains the text message along with its parameterized placeholders. Moreover, it implements the following public method that returns the properly filled text message:
   public static string GetMessageText(CEntityID msgTemplate, CEntity bizEntity);
Folder Notification notifications are stored in the database using the Notification Message Entity Type. This type defines the following Properties:
   Message Body—an Attribute Entity of type String, containing a notification message.
   Recipients—a multi-value Attribute Entity of type Resource, containing the recipients of the notification message. A recipient can be a User or a Group. If a recipient is a Group, then every user in the group will receive the message. If a User belongs to multiple Groups and the message targets these Groups, then only one message will show up in the user's notification folder.
   Read—a multi-value Attribute Entity of type User, containing individual users that have read and dismissed the notification message.
In addition, the Notification Message Entity Type defines one method:
   Mark Read—allows a user to dismiss the message so it does not show up in the notification folder again.
The notification messages are grouped into the recipient's Notification folder. The folder is implemented as a Dynamic Container (ref., section 2.1.2.2).

### 3.4.3 Programmatic Interfaces

The following lists the public methods implemented by the Notification Enabling Service:
Add Notification—adds/removes a Notification Entity to/from an Entity that must trigger a notification rule. This method takes two arguments: The ID of the entity (CENtityID) that owns the notification rule, and the Entity (CEntity) that represents the notification rule.

public CArg AddNotification(CArg arg);
public CArg RemoveNotification(CArg arg);

Add/Remove Notification Rule—adds/removes a notification rule to/from a Notification Entity.

public void AddNotificationRule(CEntityID eid, CEntity rule);
public void RemoveNotificationRule(CEntityID eid, CEntityID ruleid);

Send Notification—this method takes three arguments: The ID of the entity (CENtityID) that owns the notification rule, the ID of the method (CENtityID) to identify the event that triggers notification delivery, and a status (Boolean) to indicate whether the event was successfully invoked or not.
This method retrieves all Notification Rules for the given Entity, and for each Notification Rule whose Notification Event contains the Method ID that is specified in the ‘mid’ argument, and the corresponding Upon Success Property equals to ‘status’, then a notification will be delivered based on the delivery behavior specified by the rule.
   public void SendNotification(CEntityID eid, CEntityID mid, bool status)
Another Send Notification method implementation is provided, overloading the previous one. This method takes four arguments: The ID of the entity (CENtityID) that owns the notification rule, the Entity internal name (String) and Method internal name (String) pinpointing the Method that identifies the event that triggers notification delivery, and a status (Boolean) to indicate whether the event was successfully invoked or not.

public void SendNotification
(string etname, string mthName , CEntityID eid, bool status)

### 3.4.4 Reference

Reference the provisional document DMS0000048 for more details on the Notification Enabling Service.

3.5 Resources Management

### 3.5.1 Introduction

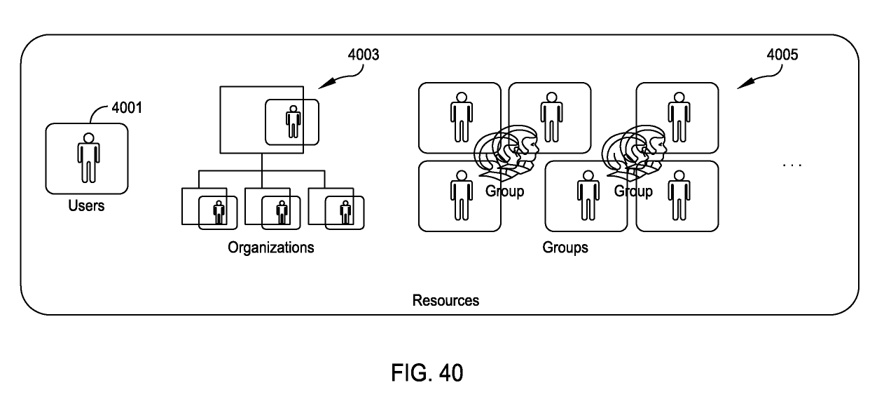

Resources are defined as identifiable entities that can be assigned ownerships, granted permissions, and handed tasks to complete. As show in FIG. 40, Resource examples include Users 4001, Organizations 4003, or Groups 4005.

### 3.5.2. Related Entity Types

Resource Entity Types are defined to model Resources. The Resources Entity Type derives from the Named Entity Type and is considered as a base type. It defines the following Properties:
GUID—a Globally Unique Identifier (GUID) for proper integration with Active Directory (AD) or Lightweight Directory Access Protocol (LDAP).
Assigned Roles—a multi-value Attribute Entity of type RoleAssignments. This Property encases all roles and permissions assigned to the Resources Entity.
Audit Trail—a multi-value Attribute Entity of type History, representing the audit trail of the Resources Entity (ref., section 3.7).

A subset of the following Entity Types derive from the Resource Entity Type. However, they all take part in defining the Resources Management module:
SysGroup Type—a collection of Resources. This Entity Type defines the following Properties:
   Sponsor—a Attribute Entity of the Resource type, representing the sponsor of the group.
   Groups—a multi-value Attribute Entity of the SysGroup type, representing subgroups of the current group. The Groups Property allows group hierarchy build-up. Also, users can belong to different groups.
   Users—a multi-value Attribute Entity of the SysUser type, representing a set of users in the group.
   Description—an Attribute Entity of the String type, allowing the group Sponsor to add arbitrary text.
SysUser Type—a human Resource. This Entity Type defines the following Properties:
   Username—an Attribute Entity of the String type, containing the user's unique login ID. Note that in case of AD integration, the Username value must match the login ID of the corresponding user account in the AD system.
   Password—an Attribute Entity of the PasswordInfo type, containing the actual password, the last refresh time, and a reference to password policy. Note that in case of AD integration, the password value must match the password of the corresponding user account in the AD system.
   Distinct Approval Password—an Attribute Entity of the Boolean type, specifying whether a password can be used for both login password and approval password (ref., section 3.11).
   Approval Password—an Attribute Entity of the PasswordInfo type, containing the user's approval password (ref., section 3.11).
   Groups—a multi-value Attribute Entity of the SysGroup type, containing all the groups that the user is a member of.
   Profile—an Attribute Entity of the UserProfile type, defining all possible user-settable preferences.
   UserInfo—an Attribute Entity of the UserInfo type.
   HRInfo—an Attribute Entity of the HRInfo type.
   SystemInfo—an Attribute Entity of the SystemInfo Type.
PasswordInfo Type—a Value Entity holding password-related information for Entities of the SysUser type. This Entity Type defines the following Properties:
   Password—an Attribute Entity of the String type, containing the password text.
   Last changed—an Attribute Entity of the Date type, containing a timestamp of the last date the password changed.
   Policy—an Attribute Entity of the PasswordPolicy type, specifying the password policy that the current password must follow.
PasswordPolicy Type—implements different password definition policies. This Entity Type defines the following Properties:
   Maxexpiration—an Attribute Entity of the Duration type, specifying how often a password must change.
   Encrypt Policy—an Attribute Entity of the String type, specifying how to encrypt the password string.
   Pwd Input count—an Attribute Entity of the Integer type, specifying the number of password failures before the system locks the user out.
   Pwdcomplexity—an Attribute Entity of the PwdComplexity type, specifying additional constraints about password policy.
PwdComplexity Type—specifies additional constraints for password policy. This Entity Type defines the following Properties:
   Allowusername—an Attribute Entity of the Boolean type, specifying whether a password can contain the username wholly or partially.
   Minimumlength—an Attribute Entity of the Integer type, specifying the minimum length of a password.
   Uppercase—an Attribute Entity of the Boolean type, specifying whether the password can contain uppercase letters or not.
   Lowcase—an Attribute Entity of the Boolean type, specifying whether the password can contain lowercase letters of not.
   Digits—an Attribute Entity of the Boolean type, specifying whether the password can contain digit letters of not.
   Peculiarletter—an Attribute Entity of the Boolean type, specifying whether the password can contain peculiar letters (e.g., @, #, and ˜) or not.
UserProfile Type—specifies user system-preferences. This Entity Type defines the following Properties:
   Culture Info—an Attribute Entity of the Enumeration Type, containing the name of the culture (ref., section 3.3.2.1).
   UI preferences—an Attribute Entity of the Value type, allowing users to define their own UI-related preferences.
UserInfo Type—models user personal information. This Entity Type defines the following self-explanatory Properties:
   Last name; First name; Middle name; Home phone; Work phone; Mobile phone;
   Email1; Email2; Address; and Birthday.
HRInfo Type—models the user's work-related information that is typically managed by the human resource department. This Entity Type defines the following self-explanatory Properties:
   Hire date; Department; Job title; Salary; Resume; and Picture.
   Manager—an Attribute Entity of the SysUser type.

### 3.5.3 Reference

Reference the provisional document DMS0000049 for more details on Resource Management.

3.6 Search Engine

### 3.6.1 Introduction

The Search Engine Enabling Service provides search capabilities on the level of Business Entities.

### 3.6.2 Related Entity Types

The Search Engine defines the Search Entity Type to embody search specifications (i.e., search conditions, search space, pagination control, etc.). The Search Entity Type can be either transient (i.e., representing a quick and ad-hoc search) or permanent (i.e., representing a saved search).

The Search Entity Type represents the following search behaviors:
Property-Based Search—the Search Entity returns results based on searches performed on specific Entity Properties.
Keyword-Based Search—the Search Entity returns results based on searches performed on keywords attached to Entities.
Content-Based Search—the Search Entity returns results based on searches performed on Entity document contents.

From a User Interface perspective, the Search Engine Enabling Service provides the following search capabilities:
Web-Like Search—users enter search criteria in one textbox and click on the submit button to initiate a search. The Search Engine Enabling Service triggers a Keyword-Based Search and returns the resulting Entities.
Simple Search—users select a particular Entity Type and enter search conditions on one specific Property of the selected Entity Type. The Search Engine Enabling Service triggers a Property-Based Search and returns the resulting Entities.
Template Search—users select a particular Entity Type and enter search conditions on one or more Properties of the selected Entity Type. The Search Engine Enabling Service triggers a Property-Based Search and returns the resulting Entities.
Advanced Search—users select one or more Entity Types and enter search conditions on one or more Properties of any of the selected Entity Types. The Search Engine Enabling Service triggers a Property-Based Search and returns the resulting Entities. Advanced searches allow the users to store in a persistent data source the search conditions for later use.

The Search Entity Type defines the following Properties:
Search Type—an Attribute Entity of the Named or Value type, specifying the type of Entities to search on. While no explicit join operations are supported, implicit joins can be performed by searching on View Entities (ref., section 2.1.2.1). For Web-Like Searches, the search space is limited to all Named Entities.
Fields—a multi-value Attribute Entity of the Entity ID type, containing all IDs of Attribute Entities to search on.
Criteria—a multi-value Attribute Entity of the Criteria type, specifying the search criteria. The Criteria Entity Type defines the following Properties:
   Criteriaorder—order of the multi-value collection.
   Field—Property name
   Operation—relational operator
   Constant—constant value
   Andor—whether this is an “and” or an “or”-based search
SQL Criteria—the SQL search condition. This is essentially the “Where” clause that will be passed into the database server during search execution. SQL Criteria as a string is generated when Criteria is submitted to the service layer. SQL Criteria is re-generated by the Search Engine Enabling Service whenever the Criteria changes.
Page Size—the number of Entities to place in each results page. This is helpful for UI search result pagination logic.
Order By—a multi-value Attribute Entity with two fields, Attribute ID and a Boolean value, indicating whether the ordering of the search results is in ascending or descending fashion.

The Search Engine Enabling Service supports the following list of relational operators:

| Searchable | | |
|---|---|---|
| Property Type | Relational Operator | SQL Operator |
| String | Like | Like % const % |
| | Starts with (% not required) | Like const % |
| | Equal to | = |
| | Not Equal to | <> |
| | Not start with | Not like const % |
| | Not like | Not like % const % |
| Long, integer | Equal to | = |
| | Not equal to | <> |
| | Greater than | > |
| | Greater than or equal to | >= |
| | Less than | < |
| | Less than or equal to | <= |
| | Between (2 contants req'd) | Between const and const |
| Date | Greater than | > |
| | Greater than or equal to | >= |
| | Less than | < |
| | Less than or equal to | <= |
| | Between (2 contants req'd) | Between const and const |
| Boolean | Equal to | = |
| | Not equal to | <> |
| Long String | Like | Like % const % |
| | Starts with (% not required) | Like const % |
| Binary | Not supported | |
| Long Binary | Not supported | |
| Enumeration | Equal to | = |
| | Not Equal to | <> |
| Multi-value | Contains (multiple constants | Subquery |
| attributes | possible) | |
| | Not contain (multiple | Subquery |
| | constants possible) | |

The Search Engine Enabling Service supports the following list of logical operators:
NOT; AND; OR

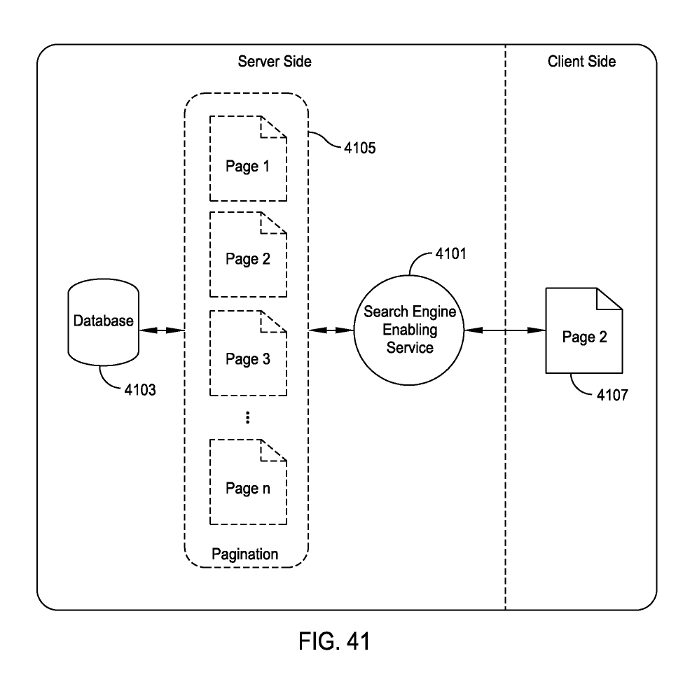

As shown in FIG. 41, the Search Engine Enabling Service 4101 queries the database 4103 and returns results in batches 4105, as opposed to loading the entire set of results and clogging the application server and client layers. Each search request is processed and the results are sent back to the client in a page 4107 containing a number of Entities that match the search criteria. The number of Entities per page is determined by the Page Size Property of the Search Entity Type. By providing access to database pages in any random order, the Search Engine Enabling Service avoids the processing strain encountered when querying for large data sets.

### 3.6.3 Programmatic Interfaces

The Search Entity Type implements the following search execution public methods:
GetCount—receives the number of Entities that match the search criteria.
Execute—retrieves a set of Entities that match the search criteria.
   public CEntity[ ] Execute(Int32 pageID);
   In the above method, the pagelD argument is the page number that the client requires the Search Engine Enabling Service to fetch. The following is a sample code that fetches the entire search result by page:

```
public static void CallExecute(Enproxy enpx, CEntity search)
{
    CArg arg;
    arg.Instance = search;
    for (Int32 pageID = 0; ; pageID++)
    {
        arg.SetParameter(“pageID”, pageID);
        CArg result = enpx.DispatchMethod(“search”, “Execute”, arg);
        CEntity[ ] ens = (CEntity[ ]) result.Result;
        If (ens.Length == 0) break;
        // process search result
    }
}
```

The Search Engine Enabling Service can also search within soft-deleted Entities. To that end, the Search Entity Type implements the following methods:
ExecuteSoftDeleted—retrieves a set of soft-deleted Entities that match the search criteria.
GetSoftDeletedCount—receives the number of soft-deleted Entities that match the search criteria.

### 3.6.4 Reference

Reference the provisional document DMS0000050 for more details on the Search Engine Enabling Service.

3.7 Traceability

### 3.7.1 Introduction

The Traceability Enabling Service logs all activities performed on Business Entities. It is useful for auditing all history transactions performed on Business Entities.

### 3.7.2 Related Entity Types

The Traceability Enabling Service implements the History Value Entity Type.

All Business Entities that want to benefit from the traceability service must implement the History Entity Type as part of their Properties. A History Entity is a history record showing the activities performed on the Business Entity.

The Traceability Enabling Service abides by the following requirements:
Read-Only Access-History Entity Types are read-only to maintain history record integrity and avoid tampering efforts. Read-Only Access is achieved through the Access Control Enabling Service (ref., section 3.1.3). However, History Entities can be purged by privileged users only.

Per-Entity Access-History Entities are typically retrieved in a batch, i.e., all History Entities that belong to a particular Business Entity are retrieved at the same time.

Automatic Instantiation—the Traceability Enabling Service automatically instantiates History Entities on behalf of users whenever Business Entities go through transactional processing.
Schema Entity Changes-Entity Types enable the traceability functionality by defining a multi-value attribute of the History Entity type. In addition, a Boolean-typed Log Property is added to the Method Entity Type. A value of “true” indicates that invoking this method instantiates a History entity. A value of “false” indicates otherwise.

The History Entity Type defines the following Properties:
Entity—ID of the History Entity.
Entity name—Name of the History Entity.
Event—Entity ID of the method.
Event name—display name of the method.
Event User—Entity ID of the user who invoked the method.
User name—Display Name of the user who invoked the method.
Event Date—date/time the method was invoked.
Event Status—whether the invocation is successful or not.
Event Details—any arbitrary information. If method invocation fails, this field contains the resulting error code and error message.

### 3.7.3 Programmatic Interfaces

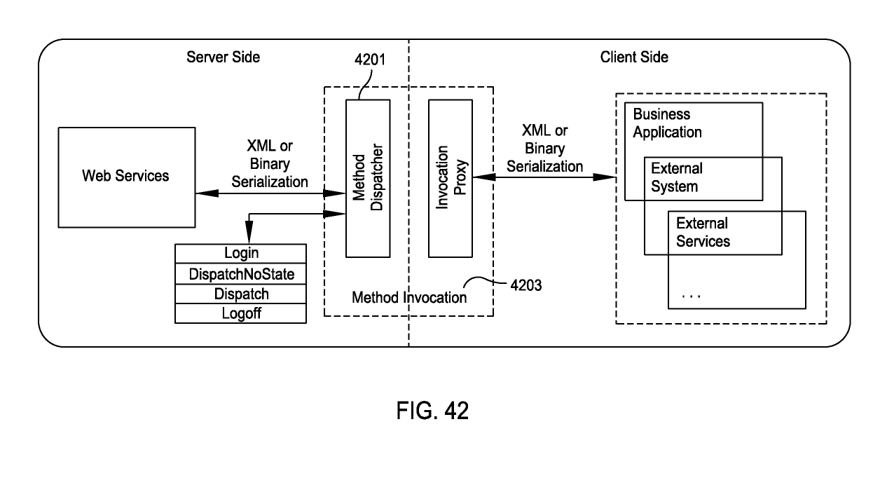

The History Entity Type also defines the following Methods:
Append—instantiates a History Entity Type if the given Method is subject to history logging. As shown in FIG. 42, the Append method is called directly from the Method Dispatcher 4201 (ref., section 6) after a method invocation 4203 returns. That said, if the current Entity Type defines a multi-value attribute of the History type, and if the current method's Log Property is set to true, then the Traceability Enabling Service creates a History Entity and appends it to the Entity's History Property.
   public static void Append(CEntitylD entity, CEntitylD method, string details);
Purge—deletes History Entities of a given Entity. If the Keep attribute is greater than 0, then the most recent Keep days of History Entities will not be purged.

public static void Purge(CENtityID entity, Int32 keep);
public static void Purge(CENtityID entity, System.DateTime date);

### 3.7.4 Reference

Reference the provisional document DMS0000051 for more details on the Traceability Enabling Service.

3.8 Document Management

### 3.8.1 Introduction

The Document Management Enabling Service centralizes the storage and retrieval processes of documents. It enables document foldering and filing, type definition, attribute and content-based searching, content repository and distributed repositories, version control, routing, subscription and publication, audit trail, and access control.

Note that Enabling Services—other than the Document Management provide some of the before-mentioned capabilities. These include:
Data Engine (ref., section 2.2)—the Document Management Enabling Service relies on the Data Engine to provide basic access to Entity Types, multi-value Properties, and other basic constructs.
Container Manager (ref., section 2.1.2.2)—the Document Management Enabling Service relies on the Container component to provide document Foldering capabilities.
Search Engine Enabling Service (ref., section 3.6)—the Document Management Enabling Service relies on the Search Engine Enabling Service to provide both Property and content-based searching capabilities.
Version Control Enabling Service (ref., section 3.10)—the Document Management Enabling Service relies on the Version Control Enabling Service to provide document versioning capabilities.
Workflow Enabling Service (ref., section 3.11)—the Document Management Enabling Service relies on the Workflow Enabling Service to provide document routing capabilities.
Notification Enabling Service (ref., section 3.4)—the Document Management Enabling Service relies on the Notification Enabling Service to provide document publication and subscription capabilities.
File Management Enabling Service (ref, section 3.9)—the Document Management Enabling Service relies on the File Management Enabling Service to provide document content repository capabilities.
Access Control Enabling Service (ref, section 3.2)—the Document Management Enabling Service relies on the Access Control Enabling Service to enforce permission controls on documents.
Traceability Enabling Service (ref, section 3.7)—the Document Management Enabling Service relies on the Traceability Enabling Service to provide audit trail capabilities.

### 3.8.2 Related Entity Types & Programmatic Interfaces

The Document Management Enabling Service defines the Document Named Entity Type to implement the document-related services.

The Document Entity Type defines the following Properties:
Subject—an Attribute Entity of the String type, containing the subject of the document
Description—an Attribute Entity of the String type, containing a brief description of the document
Related Documents—a multi-value Attribute Entity of the RelatedDocument Type, containing a list of related documents
Status—an enumeration indicating the current status of the document
Files—a multi-value Attribute Entity of the version-specific Attachment type (ref., section 3.8.3). No additional effort is required to integrate with the File Management Enabling Service, other than that to define the Attachment Property for the Document Entity Type. The following methods are available for Document Entities once the Attachment Property is defined:
   Upload—uploads a physical file
   Download—downloads a physical file
Versioning—an Attribute Entity of the Versioned Type, added to enable version control capabilities. Versioning capabilities are handled by the Version Control Enabling Service (ref., section 3.10). No additional effort is required to integrate with the Version Control Enabling Service, other than that to define the Versioning Property for the Document Entity Type. The following methods are available for Document Entities once the Versioning Property is defined:
   Checkout—creates a new version for modification
   Checkin—commits the new version
   Cancel—aborts the new version
   GetVersions—gets a list of all versions
Workflow—an Attribute Entity of the Process Instance Type, added to enable workflow capabilities. With workflow support, Documents can be routed to users, groups, departments, or any other Resource (ref., section 3.5) for reviews and approvals. The Workflow Enabling Service (ref., section 3.11) that is associated with the Document Entity Type through the Workflow Property provides this routing capability. The following methods are available for Document Entities once the Workflow Property is defined:
   Set Workflow—instantiates a workflow process instance
   Forward—completes the current activity
   Get Workflow Status—gets a list of state transitions for the process instance
   Show Workflow—gets a bitmap image of the transition diagram
Notification—an Attribute Entity of the Notification Entity Type, added to enable subscription and publication capabilities. With notification support, Documents can be published and subscription to notification events so that users can receive notifications when particular event occurs on the Document. The Notification Enabling Service (ref., section 3.4) that is associated with the Document Entity Type through the Notification Property provides this capability.

History—an Attribute Entity of the History Type (ref., section 3.10), added to enable audit trail and traceability. The Audit Trail Enabling Service that is associated with the Document Type through the History Property provides this capability.

Note that specific Document Entity Types can be created as subtypes of the Document Entity Type to introduce additional version-invariant or version-specific Properties, based on specific business requirements.

The Document Management Enabling Service also defines the following Entity Types:
DocumentVersion Entity Type—the shadow version-specific type for Document is DocumentVersion, which derives from Versioned Type. This type defines one version-specific Property (additional version-specific Properties can be added to this Type based on specific business needs):
   Files—a multi-value Attribute Entity of the Attachment type. This Property is defined as multi-value since each document version can contain multiple physical files
RelatedDocument Entity Type—a Value-typed Entity Type. An instance of this type represents a loosely-coupled relation between two document entities. This type defines the following Properties:
   Document—an Attribute Entity of the Document type. The Property contains a reference to a Document that the current document relates to.
   Version Number—an Attribute Entity of the String type, indicating a specific version of a Document that the current document relates to. If the Property value is empty, then the default version is the latest version.

### 3.8.3 Reference

Reference the provisional document DMS0000052 for more details on the Document Management Enabling Service.

3.9 File Management

### 3.9.1 Introduction

The File Management Enabling Service provides capabilities related to physical files. It provides capabilities other than those provided by the Document Management Enabling Service (ref, section 3.8) that operates at a higher abstraction level, i.e., on Entity Types as opposed to physical operating system files.

The File Management Enabling Service implements the following capabilities:
Basic file contents retrieval and storage
Basic file information management
Automatic file foldering
Unique file identification
Optimized file content upload and download
Automatic deletion or archiving of unreferenced files
Support of transactional control of file storage
Support of file content encryption
Support of file content compression
Support of multiple file locations and automatic content replication
Secured file directory
Support of content-based search

The File Management Enabling Service benefits from the capabilities of other Enabling Services. These include:
Access Control Enabling Service—the File Management Enabling Service exclusively accesses all physical files. The Access Control Enabling Service enforces user permissions to these files through the Business Entities that the files are attached to.
Document Management Enabling Service—the Document Management Enabling Service benefits extensively from the capabilities that the File Management Enabling Service provides.

### 3.9.2 Related Entity Types

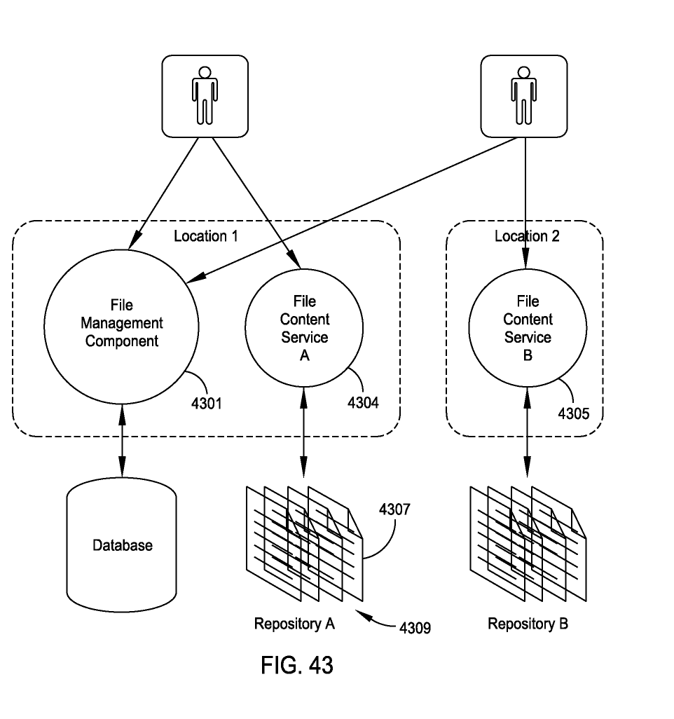

A file defines property information (e.g., ID, name, type, size, etc.) and actual file content. As shown in FIG. 43, the File Management Enabling Service implements two sub-components to handle these two separate characteristics of a file: a transactional File Management Component 4301, and File Content Services such as File Content Service A (4303) and File Content Service B (4305) (independent Web service components that manage file content).

These two components act on the File Entity Type to implement file-related services. A File Entity references only one physical file such as a file 4307 in the file repository such as Repository A (4309). However, many File Entity instances can reference the same physical file. File Entity instances are usually embedded in other Entities (e.g., Documents).

The File Entity Type defines the following Properties:
File name—a human readable name of the file. Note that the actual file name in the file repository is different from this value.
File size—the size of the physical file.
File type—the extension of the physical file.
File ID—a unique identifier that is used to locate the physical file. For a newly-created file, this identifier has the same value as the Entity ID of the File Entity.

### 3.9.3 Programmatic Interfaces

The File Entity Type defines the following public methods in the File Management Component:
Upload—sends a file to File Content Service.
Download—retrieves a file from the File Content Service.
Open—initiates a stream-oriented upload or download.
Read—retrieves a portion of a file from the File Content Service. This method can be used for downloading a file into a stream.
Write—sends a portion of a file to the File Content Service. This method can be used for uploading a file from a stream.
Close—terminates a stream-oriented download or upload.

The File Entity Type defines the following public methods in the File Content Service:
Get FCS Info—receives a URL that identifies a File Content Service Web service and a security token from the File Management Service. The token can be used for one file upload or download.
Get FMS Info—returns the File Management Service password and current timestamp. Note that this method requires File Content Service authentication.
Get Valid FileID—returns a list of valid File IDs from the schema. This method provides basis for the File Content Service to clean up unreferenced files from its repository. Note that this method requires File Content Service authentication.

The File Management Enabling Service does not store file content in databases but in operating system file systems. 64-bit integer numbers, combined with unique schema names, uniquely identify each file in the repository. That said, and for security considerations, the actual file name is not familiar to the user: the actual file name in the repository follows the “<schema name>_<file ID>.<file extension>” naming scheme. In this scheme, <schema name> is the name of the schema under which the file is created and used, <file ID> is the File ID attribute of the File Entity instance, and <file extension> is the native file extension specified in the File Entity instance in the File Type Property.

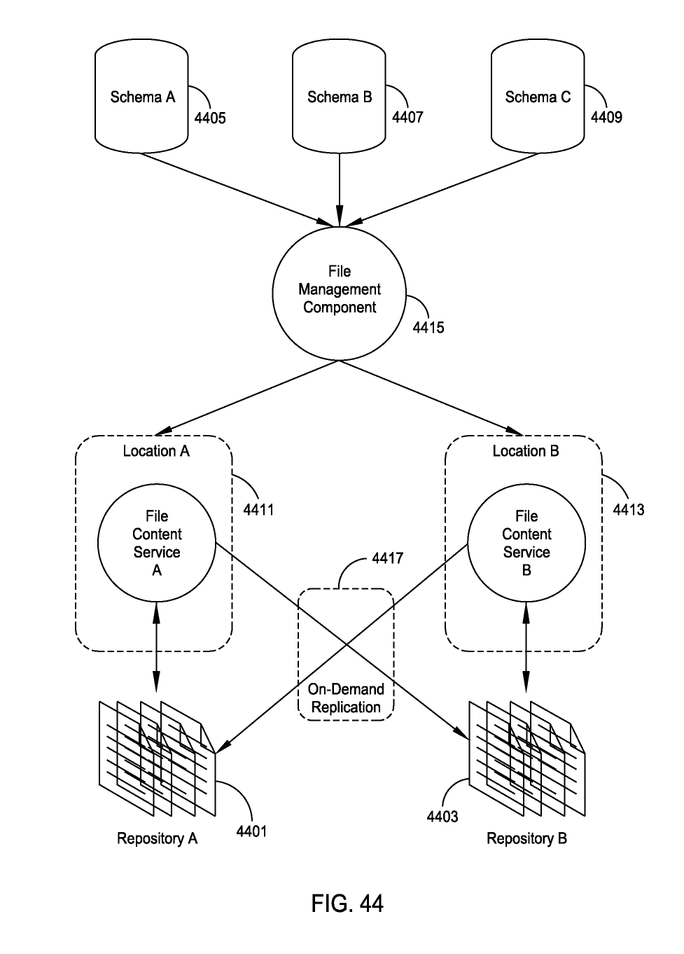

Since schema names qualify the file names, then multiple schemas in the same, or different, databases can share the same file repository. Likewise, a schema can own files that reside in multiple repositories. In effect, and as shown in FIG. 44, the relationship between file repositories 4401 and 4403 and schemas 4405, 4407 and 4409 is many-to-many. The repository 4401 is managed by file content service A (4411) but also receives subject matter from file content service B (4413). Likewise, the repository 4403 is managed by file content service B but also receives subject matter from file content service A. File management component 4415 interacts with the file content services and with the schemas 4405, 4407 and 4409. Both repositories are also responsive to on-demand replication 4417. This architecture provides a flexible foundation to support On-Demand multi-tenant systems.

The File Management Enabling Service maintains a directory (or repository) structure to hold all physical files. The repository is a multi-level secured directory structure that is accessible only by the File Management Enabling Service. The repository can dynamically grow, and the actual level of the directory structure depends on the number of files in the directory. This design allows the File Management Enabling Service to access easily and rapidly a large number of files.

The File Management Enabling Service implements an efficient algorithm that determines the relative file path of a physical file within a repository based on the schema name and the numeric value of the unique file ID.

The File Content Service retrieves and stores file content. To account for a flexible foundation to support On-Demand multi-tenant systems, File Content Services are not deployed necessarily in the same space as other services. However, it must be deployed close-enough to the repository to guarantee fast file access.

A repository can store files from multiple database schemas. One File Content Service can also be used by multiple File Management Components that belong to same or different database schemas. However, a File Content Service is tied to a particular repository. This design is to ensure relative independence of a file repository. Furthermore, for performance reasons, a single file repository can be serviced by multiple File Content Services.

That said, the component does not follow standard method invocation mechanisms (ref., section 6). Instead, it defines directly callable Web methods for file retrieval and storage: Read, Write, and Close. A client application calls first the Upload or Download methods defined in the File Management Component to return a necessary security token to the client application. The client application then dispatches Read, Write, and Close methods to the appropriate File Content Service to complete the file transfer.

### 3.9.3.1 Access Control

The Access Control Enabling Service enforces file access rights based on the user's permissions, as defined in the Access Control Enabling Service. Security is not compromised even though the Access Control Enabling Service is not deployed in the same space as the File Content Service. This is because any file operation requests, upload or download; need to go through the File Management Component first to obtain a security token. The File Management Component then interfaces with the Access Control Enabling Service to ensure the user has the appropriate permissions before any file operations are executed. The File Content Service will serve the file upload or download requests based on the validity of the security token.

The security token consists of four components, and is valid for only one file operation and for one particular file:
1. The name of the schema the file belongs to
2. A secret password—a short string that is agreed upon between the File Management Component and the File Content Service. The password is not persistently stored anywhere and is periodically refreshed
3. The timestamp indicating the time the token is granted
4. The File ID

The File Content Service will cache a secret password and a timestamp for every schema it supports. FCS will contact FM to obtain these two pieces of information when a client application requests to access a file but The File Content Service does not have the File Management Component information.

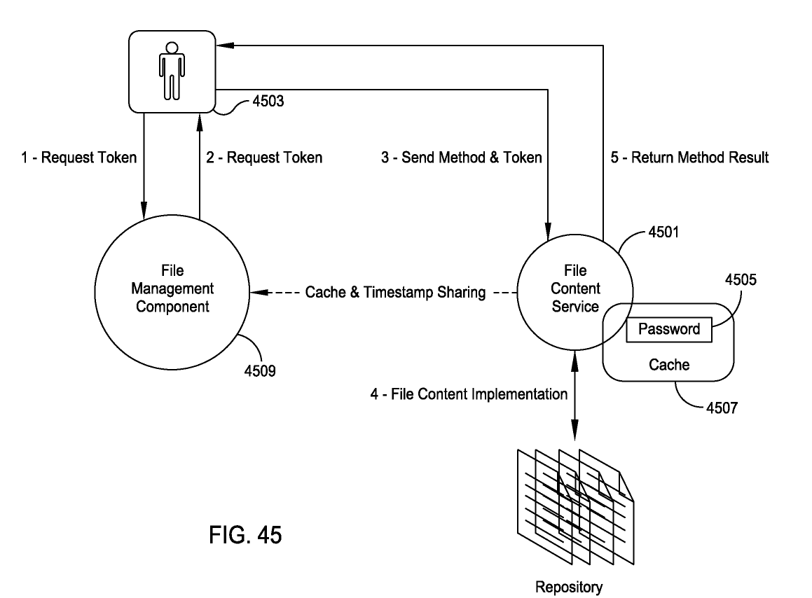

As shown in FIG. 45, when The File Content Service 4501 receives a file download or upload request from a client application 4503, it will extract the security token from the request and decrypt the token. It extracts the schema name and password out of the token, and then compares these values with the password 4505 in its cache 4507. If the File Content Service's password is empty, or if it does not match the one in the security token, then the File Content Service will contact the File Management Component 4509 again to refresh its password. If the password still does not match, then the File Content Service will reject the file operation request. Alternatively, if the password does match, then the File Content Service checks the timestamp to see if the token has expired. Expiration period is hard-coded for 30 seconds. The File Content Service will grant file access only if the token contains the correct password and it has not expired.

At system initialization time, the File Management Component will randomly generate a password and cache it in memory. The File Management Component will also periodically re-generate the password, and allows the File Content Services to retrieve the password along with the File Management Component's current timestamp.

### 3.9.4 Reference

Reference the provisional document DMS0000053 for more details on the File Management Enabling Service.

3.10 Version Control

### 3.10.1 Introduction

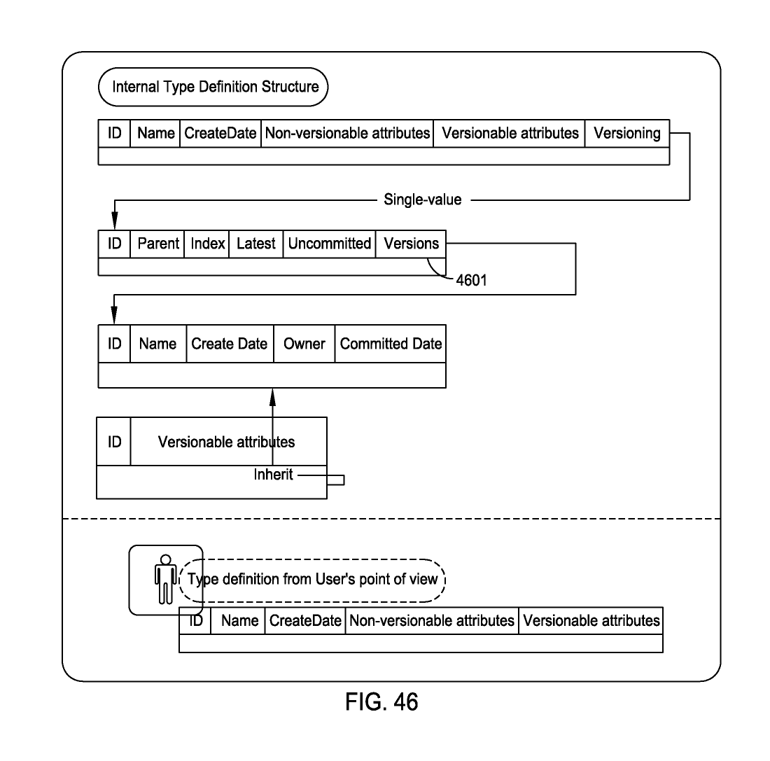

As shown in FIG. 46, the Version Control Enabling Service provides Business Entities with versioning capabilities. Versions 4601 are historical snapshots of Business Entities. These snapshots enable information tracking at various historic periods, culminating in a lifecycle management layer of select Business Entities.

Business Entity versions are snapshots of specific Property values at a particular point in time. The versions of a Business Entity belong conceptually to the same Entity instance. Note that the Version Control Enabling Service provides linear versioning capabilities only; no version branching capabilities are implemented.

Users interact with versioned Entities much as they would with any non-versioned Business Entity. Versioned Entities simply host version-specific and version-invariant Property values. The Version Control Enabling Service abstracts data manipulation complexities by providing methods to manipulate these version-specific Property values.

### 3.10.2 Related Entity Types

The Version Control Enabling Service defines the VersionedEntity Entity Type to implement version control capabilities. Business Entities define a new Property of the VersionedEntity type to benefit from version control capabilities.

The VersionedEntity Entity Type defines the following Properties:
Latest—Entity reference to the latest version of the Entity. Latest version refers to the newest committed version of the Entity.
Uncommitted—Entity reference to the uncommitted version of the Entity. Uncommitted version refers to the newest version that is still being modified.
Versions—a multi-value Attribute Entity of the Version type, containing all versions of the version-specific Properties. Each instance represents one version of the Entity. Entity instances that are stored in this attribute are Entity instances that belong to a subtype of Version. The Version Control Enabling Service creates this type internally when a user-defined Entity Type is created. For example, suppose ABC is a user-defined entity type that requires version control capabilities, then ABCVersion is automatically created by the system and it derives from Version.

The Version Entity Type derives from the Named Entity Type, and defines one additional Property:
Committed Date-contains the time the version is checked in.

The Version Entity Type also utilizes the following Properties that are inherited from Named Entity:
Name, Display_name—Properties used to store the unique version number.
Create Date—stores the time the version is checked out.
Owner—stores the user who checks out the version.

Additional version-specific Properties can be added to a subtype of this type to model user-defined version-specific Properties.

### 3.10.3 Programmatic Interfaces

The VersionedEntity Entity Type defines the following methods:
Checkout—creates a new version for the versioned entity. When created, the new version will acquire the same attribute values as those of the latest version except for the Name, Create Date, and Committed Date Properties:
   The value of Name for the new version can be passed in as a parameter of this method. It can also be null and can be set by users at a later time.
   Version number can be an arbitrary string but needs to be unique within the same entity.
   Create Date will be automatically set in this method to the current date value.
   Committed Date will be set to null.
The newly-created version will be accessible only to the current user and it remains uncommitted or checked out. This method will succeed only if there is no other uncommitted version for the entity. This can be determined by examining the Uncommitted Property of the Versioned Entity. When successful, this method will set Uncommitted to the new version.
Checkin—commits a version. It sets the Committed Date Property of the version to the current date, sets the Uncommitted Property of the Versioned Entity to null, sets the Latest Property to the current version, and copies all version-specific Properties from this version to the corresponding Properties in the Business Entity instance. Checkin means that this version becomes Read Only and another uncommitted version can be created.
Cancel—cancels an outstanding checkout. It removes an uncommitted version and sets the Uncommitted Property of the Versioned Entity to null.
Purge—purges older versions of an Entity. Note that the uncommitted version cannot be purged.
GetVersions—returns a list of version numbers, i.e., a list of references to the Version Entities that are in the Versions Attribute of the Business Entity.

The Version Control Enabling Service also provides the following static methods that are internally called by the Data Engine as post-triggers at various moments:
SaveType—a post-trigger of the Save method on Entity Types. This method is called when a new Versioned Entity type is created.
Save—a post-trigger of the Save method defined on Named Entity. This method is called when a new versioned Entity Instance is created or an existing Versioned Entity instance is modified.
Delete—a post-trigger of the Delete method defined on Named Entity. This method is called when a Versioned Entity instance is deleted.
Load—a post-trigger of the Load method defined on Named Entity. This method is called when a Versioned Entity instance is loaded to the client.

### 3.10.4 Reference

Reference the provisional document DMS0000054 for more details on the Version Control Enabling Service.

3.11 Workflow

### 3.11.1 Introduction

The Workflow Enabling Service implements business processes and provides the required platform to automate work activities attached to these business processes. Moreover, it manages the proper human and resource interactions required to trigger these work activities and successfully complete the workflow.

### 3.11.2 Related Entity Types & Programmatic Interfaces

The Workflow Enabling Service defines the following Entity Types:
Package Entity Type—an Attribute Entity of the Package Entity Type, modeling a set of related workflow process definitions. A Package Entity Type is a container that holds multiple workflow process definitions together so that these process definitions can share certain global data. The Package Entity Type derives from Named Entity, and defines the following Properties:
   Package Header—an Attribute Entity of the Package Header Type, specifying summary information about the package.
   Redefinable Header—an Attribute Entity of the Redefinable Header Entity Type, specifying redefinable information about the package.
   Conformance Class—an enumeration Attribute Entity of the Conformance Class Entity Type, specifying constraints on workflow activity transitions. Possible values are:
      FULL_BLOCKED—workflow transitions support proper splits and joins only; this means that (1) no conditions are allowed in an AND-split, and (2) an XOR-split must have at least one unconditional transition or an OTHERWISE condition.
      LOOP_BLOCKED—workflow transitions do not allow loops.
      NON_BLOCKED—workflow transitions allow any type of joins, splits, and loops.
   External Packages—a multi-value Attribute Entity of the Package Entity Type, containing zero or more references to other workflow Package Entities.
   Participants—a multi-value Attribute Entity of the Resource Entity Type (ref., section 3.5), containing zero or more references to resources that are common to all process definitions within the package.
   Applications—a multi-value Attribute Entity of the Method Entity Type, containing zero or more references to methods that are common to all process definitions within the package.
   DataFields—a multi-value Attribute Entity of the Named Entity Type, containing zero or more references to Business Entities that are common to all process definitions within the package.
   Workflow Processes—a multi-value Attribute Entity of the ProcessDefinition Entity Type, containing references to all process definitions that are included in the package.
   Extended Attributes—a multi-value Attribute Entity of the Name Value Pair Entity Type, containing any name/value pairs that are not structurally supported.
Process Definition Entity Type—an instance of the Process Definition Entity Type models a generic workflow process definition. The Process Definition Entity Type derives from Named Entity, and defines the following Properties:
   Process Header—an Attribute Entity of the Process Header Entity Type, specifying summary information about the process definition.
   Redefinable Header—an Attribute Entity of the Redefinable Header Entity Type, specifying redefinable information about the process definition.
   Formal Parameters—a multi-value Attribute Entity of the Format Parameter Entity Type, specifying parameters that the process definition may define.
   DataFields—a multi-value attribute of the Named Entity Type, containing zero or more references to Business Entities that are related to the process definition.
   Participants—a multi-value Attribute Entity of the Resource Entity Type (ref., section 3.5), containing zero or more references to resources that are related to the process definition.
   Applications—a multi-value Attribute Entity of the Method Entity Type, containing zero or more references to methods that are used by the process definition.
   Activities—a multi-value Attribute Entity of the Activity Entity Type, containing references to all the activities within the process definition.
   Transitions—a multi-value Attribute Entity of the Transition Entity Type, containing references to all the transitions within the process definition.
   Extended Attributes—a multi-value Attribute Entity of the Name Value Pair Entity Type, containing any name/value pairs that are not structurally supported.
   Workflow Map—an Attribute Entity of the Long String type, containing an XML representation of the process definition activity transition diagram.
   Start Message—an Attribute Entity of the Message Template Entity Type, referencing a message template that contains a notification message that will be sent to all participants, specified by the Participants attribute, when a process instance is being started.
   Suspend Message—an Attribute Entity of the Message Template type, referencing a message template that contains a notification message that will be sent to participants, specified by the Participants attribute, when a process instance is being suspended.
   Resume Message—an Attribute Entity of the Message Template type, referencing a message template that contains a notification message that will be sent to participants, specified by the Participants attribute, when a process instance is being resumed.
   Terminate Message—an Attribute Entity of the Message Template type, referencing a message template that contains a notification message that will be sent to participants, specified by the Participants attribute, when a process instance is being terminated.
Activity Entity Type—an instance of the Activity Entity Type models a single step, typically an atomic step, in the process definition transition diagram. This Entity Type derives from Named Entity, and defines the following Properties:
   Description—an Attribute Entity of the String type, containing any arbitrary text that describes the activity.
   Activity Mode—an enumeration Attribute Entity of the Activity Type, specifying the type of the activity. Possible values are:
      ROUTE—a dummy activity that does not define any gated operations; no human intervention is necessary to complete the activity.
      MANUAL—requires human intervention to complete before transitioning to the next activity.
      TOOL—requires an automatic method invocation to complete before transitioning to the next activity.
      SUBFLOW—a sub-workflow. The completion of the sub-workflow is required before transitioning to the next activity.
   Tool—an Attribute Entity of the Tool Type Entity Type, encapsulating necessary information to invoke a method, including a reference to a Method Entity, a list of actual parameters, and any additional name/value pairs. This attribute is ignored if the Activity Mode Property is not set to TOOL.
   Subflow—an Attribute Entity of the Subflow Entity Type, including a reference to a process definition representing the sub-workflow, and a list of parameters that may be necessary to run the workflow process.
   Limit—an Attribute Entity of the Duration Entity Type, specifying a time period within which the activity instance ought to complete.
   Participants—a multi-value Attribute Entity of the Resource Entity Type (ref., section 3.5), containing zero or more references to Resources that act as responsible users for the activity.
   Start Mode—an enumeration Attribute Entity of the Invocation Mode Entity Type, specifying how the activity ought to start. Possible values are:
      MANUAL—this activity is supposed to start manually.
      AUTOMATIC—this activity is supposed to start automatically.
   Finish Mode—an enumeration Attribute Entity of the Invocation Mode Entity Type, specifying how the activity ought to complete. Possible values include:
      MANUAL—this activity is supposed to complete manually.
      AUTOMATIC—this activity is supposed to complete automatically.
   Priority—an enumeration Attribute Entity of the Priority Entity Type, specifying the execution priority of the activity. Possible values are:
      VERY LOW
      LOW
      MEDIUM
      HIGH
      VERY HIGH
   Deadline—an Attribute Entity of the Deadline Entity Type, specifying a deadline condition, an exception that may be thrown when the deadline condition is true, and whether the exception is synchronous or asynchronous.
   Icon—an Attribute Entity of the Binary Entity Type, containing a bitmap file representing an image for the activity.
   Documentation—an Attribute Entity of the String Entity Type, possibly pointing to a help file for the activity.
   Previous Activities—an Attribute Entity of the Transition Specification Entity Type, including a transition style and a set of references to Transition Entity instances. Multiple Transition Entity instances represent a Join transition. The transition style specifies whether this is an AND-Join or an XOR-Join transition.
   Next Activities—an Attribute Entity of the Transition Specification Entity Type, specifying a transition style and a set of references to Transition Entity instances. Multiple Transition Entity instances represent a Split transition. The transition style specifies whether this is an AND-split or an XOR-split transition.
   Extended Attributes—a multi-value Attribute Entity of the Name Value Pair Entity Type, containing any name/value pairs that are not structurally supported.
   Activate Message—an Attribute Entity of the Message Template Entity Type, referencing a message template that contains a notification message that is sent to participants, specified by the Participants attribute, when an activity instance is being activated.
   Reminder Message—an Attribute Entity of the Message Template type, referencing a message template that contains a notification message that is sent to participants when approval time limit has passed.
Transition Entity Type—an instance of the Transition Entity Type models a single transition between two activities. When an activity transitions to more than one activity, multiple Transition Entity instances are used. This Entity Type derives from Named Entity, and defines the following Properties:
   From Activity—an Attribute Entity of the Activity Entity Type, specifying the beginning activity for this transition.
   To Activity—an Attribute Entity of the Activity Entity Type, specifying the ending activity for this transition.
   Description—an Attribute Entity of the String Entity Type, containing any arbitrary text that describes the transition.
   Extended Attributes—a multi-value Attribute Entity of the Name Value Pair Entity Type, containing any name/value pairs that are not structurally supported.
   Condition Specifications—an Attribute Entity of the Condition Specification value type Entity Type, specifying a condition to govern this transition. It consists of two pieces of information: a free-format text expression that evaluates to either TRUE or FALSE, and an enumeration of how the condition applies. Possible values for the enumeration are:
      CONDITION—a regular condition.
      OTHERWISE—a default condition, evaluating to true when all other transitions are evaluated to false.
      EXCEPTION—an exceptional condition.
      DEFAULTEXCEPTION—a default exceptional condition.
Process Instance—while Process Definition models a workflow definition, Process Instance models runtime instances of such a definition. Process Instance is a Reference Entity Type that derives from the Named Entity Type. It defines the following attributes:
   Business entity—an Attribute Entity containing a reference to the Business Entity that the process instance belongs to.
   Process Definition—an Attribute Entity containing a reference to the process definition.
   Process State—an enumeration Attribute Entity of the Process State Entity Type, indicating the current state of the process instance. Possible values are:
      Initiated—the process instance has been created but not yet active.
      Running—the process instance is operational, but no activity instance is active.
      Active—the process instance is running and at least one activity instance is active.
      Suspended—the process instance has been suspended.
      Completed—the process instance has been completed.
      Terminated—the process instance has been terminated.
   Activity Instances—a multi-value Attribute Entity, containing a set of activity instances that belong to the process instance.
   Start Time—an Attribute Entity of the Date Entity Type, indicating the start time of the process instance.
   End Time—an Attribute Entity of the Date Entity Type, indicating the end time of the process instance.
   Parent Activity Instance—an Attribute Entity of the String Entity Type, containing the parent process instance name and activity name that the current process instance belongs to if the process instance is a sub-workflow.
   Workflow Engine Hostname—an Attribute Entity of the String Entity Type, containing the host name of the workflow engine if the process instance is being processed. This attribute serves as a persistent lock for the process instance to prevent multiple workflow engines from processing the same instance at the same time.
The Process Instance also defines the following methods to handle process instances:
   InitializeProcess—instantiates or creates a process instance and sets the state of the instance to Initiated. The method also creates all the activity instances and sets their state to Inactive.
   StartProcess—starts to run a process instance and sets the state to Running. Since all process instances start with the Start activity, which is a dummy activity (activity mode is set to ROUTE), this method will immediately set the next activity or activities to Active, which will inherently set the process instance state to Active also. If the Start Message Property references a valid message template, then a notification will be sent to all participants specified in the Process Definition.
   RestartProcess—similar to the Start method, except it may perform some cleanup tasks before invoking Start. This method may be triggered by the Workflow Manager. It can also be invoked by an end user through the business entity that is associated with the process instance. If the Start Message Property references a valid message template, then a notification will be sent to all participants specified in the Process Definition.
   SuspendProcess—suspends a process instance and sets its state to Suspended. The method also sets the state of all active activity instances to Suspended. Inactive activity instances will remain inactive. This method is triggered by the Workflow Manager. If the Suspend Message Property references a valid message template, then a notification will be sent to all participants specified in the Process Definition.
   ResumeProcess—resumes a suspended process instance and sets its state to Running. The method also sets the state of all suspended activity instances to Active, if any. If any activity instance becomes active, the method sets the process instance to Active. This method is triggered by the Workflow Manager. If the Resume Message Property references a valid message template, then a notification will be sent to all participants specified in the Process Definition.
   TerminateProcess—terminates a process instance and sets its state to Terminated. This method is triggered by the Workflow Manager. If the Terminate Message Property references a valid message template, then a notification will be sent to all participants specified in the Process Definition.
   RunProcess—attempts to process all active activity instances and tries to complete them. See Activity Instance for details about how to complete an activity instance. This method is typically invoked directly by the workflow engine in the background without human intervention. It may also be invoked by the Workflow Manager.
   StartActivity—attempts to set the state of an activity to Active. This method works for activities whose Start Mode is set to MANUAL. This method may be triggered by an end user through the business entity that is associated with the process instance. It can also be invoked by the Workflow Manager.
   CompleteActivity—attempts to push the state of an active activity instance to complete. This method works for activities whose mode is set to MANUAL. This method may be triggered by an end user through the Business Entity that is associated with the process instance. It can also be invoked by the Workflow Manager.
   ShowMap—returns the workflow state transition diagram in bitmap form.
Activity Instance Entity Type—while Activity models workflow activities, Activity Instance models runtime instances of workflow activities. Activity Instance derives from Value Entity Type, and defines the following Properties:
   Activity State—an enumeration Attribute Entity of the Activity State Entity Type, indicating the current state of the activity. Possible values are:
      Inactive—the activity is not active, meaning the workflow engine has not started to process the activity yet.
      Active—the activity is active, meaning the workflow engine has started to process the activity but it has not been completed yet.
      Suspended—the activity is suspended.
      Completed—the activity has been completed.
   Activity—an Attribute Entity of the Activity Entity Type, containing a reference to the corresponding activity entity.
   Start Time—an Attribute Entity of the Date type, indicating the start time of the activity instance. The attribute is null for inactive activity instances.
   End Time—an Attribute Entity of the Date type, indicating the end time of the activity instance. The attribute is null for non-completed activity instances.
   Additional Participants—a multi-value Attribute Entity of the Resource Entity Type (ref., section 3.5), specifying any additional ad-hoc participants that may be responsible for the activity instance. If multiple participants are responsible for a single activity instance, any one of the participants can push the instance to completion.
   User—an Attribute Entity of the User Entity Type, specifying the user who completes the activity instance. The attribute is null for non-completed activity instances.
   Action—an Attribute Entity of the Method Entity Type, specifying the method through which a user completes the activity instance. The attribute is null for non-completed activity instances.
   Subprocess—an Attribute Entity of the Process Instance Entity Type. It specifies the process instance ID of the sub-workflow if the current activity is a subflow.
As a value type Entity Type, an activity instance is not directly manipulated by an end user. Rather, it is manipulated through interfaces or methods defined for the corresponding process instance. Activity instances are created when the corresponding process instance is created. The initial state of activity instances is Inactive. Activity Instance does not define public methods to invoke. However, it does expose certain functionalities that are implemented as C# methods. These C# methods are called from the workflow engine processing logic. They include:
   IsReady—returns TRUE if any or all of the previous activities are in complete state, depending on the transition style of the previous activities. If the transition style of Previous Activities is AND, then all previous activities are required to complete first. If the transition style is XOR, then one of the previous activities is required to complete first. In addition, the corresponding transition condition will also need to evaluate to TRUE. When returning TRUE, this method signals that the current activity instance is ready to be activated. This method only works for Inactive activities. If the state of the activity is anything but Inactive, this method will return FALSE.
   Activate—attempts to run an activity instance. The IsReady method will need to return TRUE before this method is called. How an activity instance is activated depends on the activity mode defined for the activity. There are four distinct cases. If the activity mode is:
      ROUTE—sets the activity instance state to Active.
      MANUAL—sets the activity instance state to Active. If the Activate Message attribute references a valid message template, then a notification will be sent to all participants specified in the Activity.
      TOOL—sets the activity instance state to Active.
      SUBFLOW—sets the activity instance state to Active. It will also instantiate and start a new process instance representing a sub-workflow. The resultant process instance ID will be set to the Subprocess attribute of the activity instance.
   Complete—attempts to push the state of an active activity instance to Completed and End Time to current time. Whether an activity can be completed depends on the activity mode. There are four distinct cases. If the activity mode is:
      ROUTE—set activity state to Completed. If the current activity instance is the End activity, this method also sets the End Time of the process instance to current time. If the Parent Activity Instance attribute of the process instance contains a valid activity instance (which means this is a sub-flow), this method also invokes the Complete method on the parent activity instance to Completed.
      MANUAL—set activity state to Completed if it is invoked directly by an end user. Only a participant of the activity or the delegated user of a participant can invoke this method. The method will do nothing if it is invoked by the workflow engine.
      TOOL—try to invoke a method as specified by the tool attribute of the activity. If the method returns TRUE, the activity state will be set to Completed. If the method returns FALSE, the activity state will be unchanged. The specified method can be invoked asynchronously, and a completion delegate callback will need to be provided to set the activity state to Completed.
      SUBFLOW—sets activity state to Completed. This one is called from the sub-workflow when its End activity has been completed.
   Suspend—suspends an active activity instance. If the activity instance is not Active, this method will not do anything. Depending on the activity mode, there are four distinct cases. If the activity mode is:
      ROUTE—sets the activity state to Suspended.
      MANUAL—sets the activity instance state to Suspended.
      TOOL—sets the activity instance state to Suspended. If the dispatched method has not been completed yet, it is OK not to suspend it. And it is OK to let the delegate callback method be triggered at any time to set the state to Complete.
      SUBFLOW—sets the activity instance state to Suspended. It will also attempt to suspend the sub-workflow.
   Resume—resumes a suspended activity instance. Depending on the activity mode, there are four distinct cases. If the activity mode is:
      ROUTE—sets the activity state to Active.
      MANUAL—sets the activity instance state to Active.
      TOOL—sets the activity instance state to Active.
      SUBFLOW—sets the activity instance state to Active. It will also attempt to resume the sub-workflow.

The Workflow Enabling Service defines three transition types:
Transition Splits—a transition split is defined if an activity has more than one next activity.
An XOR-split means that one of the next activities will be activated when the current activity completes. XOR-splits allow a business process to deviate based on a Business Entity's runtime state information. For simplicity reasons, XOR-splits are only allowed when transition conditions are mutually exclusive. An otherwise-style condition can also be specified. This means that only one of the next activities will be activated. This restriction is similar to setting Conformance Class to FULL_BLOCKED.
An AND-split means that all of the next activities will be activated when the current activity completes. AND-splits allow a business process to be carried on in a parallel fashion. For simplicity reasons, AND-split transitions do not define transition conditions.
This restriction is similar to setting Conformance Class to FULL_BLOCKED.
Transition Joins—a transition join is defined if an activity has more than one previous activity.

An AND-join means that all of the previous activities will need to be completed before the current activity can be activated. AND-joins allow a business process to synchronize on multiple activities. For simplicity reasons, AND-join transitions do not define conditions. This restriction is similar to setting Conformance Class to FULL_BLOCKED.
An XOR-join means that only one of the previous activities will need to be completed before the current activity can be activated. XOR-joins allow a business process to execute based upon one of the many triggering activities. For simplicity reasons, only one of the previous activities can be activated in case of an XOR-join. This is to ensure that other previous activities do not need to be canceled when one is completed.
Transition Loops—a transition loop is defined when Activity A is a next activity of Activity B and Activity B is also a direct or indirect next activity of Activity A.
A transition loop helps implement a repetitive business process. For simplicity reasons, only one activity in the entire transition loop can define an XOR-join transition. This is to ensure that each transition loop allows only one effective entry point.

### 3.11.3 Reference

Reference the provisional document DMS0000055 for more details on the Workflow Enabling Service.

### 4. EVENT MANAGER

The occurrence of an event triggers a subsequent action to perform. In other words, when Event A occurs, then Action B is performed.

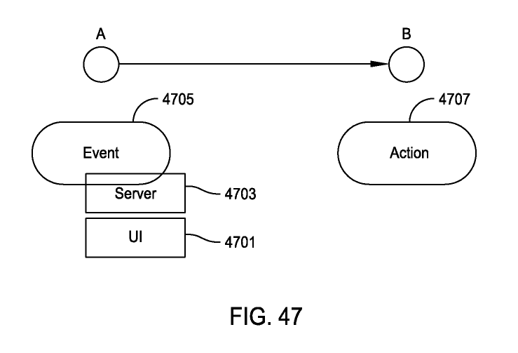

As shown in FIG. 47, the events are categorized into User Interface (UI) 4701 and Server 4703 events 4705. Mouse clicks and key strokes are examples of UI events; time expiration, change of attribute values, and invocation of methods are examples of server events. Typically, a UI event triggers a client-side action 4707 or a Web service call to the server. Alternatively, server events trigger actions that are executed on the server side.

The following details an example of the UI and Server events supported by the Universant Business Server and the resulting actions that are triggered with the occurrence of these events.

4.1 User Interface Events

For every UT field or button, the following trigger events may be defined:
Validation Expression—the regular expression (ref., section 4.11) that specifies the valid character sequence of the field.
Related fields—the set of fields that are related to the current field and that must be validated as well.
Event Expression—the regular expression that specifies the triggering condition for the Auto Clear, Auto Fill, Set Visible, and Set Invisible Event Types.
Event Type—the event type that triggers the validation routine. Event Types include:
   On Key Stroke—called for every key stroke.
   On Mouse Over—called when placing the mouse pointer on the field.
   On Mouse Click—called when clicking in the field.
   On Exit—called when focus leaves the field.
   Deferred—called from outside of the field, possibly as a result of validating another field.
Event Action—the action to complete when the trigger is set. In case of field validation, the value is set to Validate.
   Field Validation—performs field validation based on the regular expression defined in the “Event Expression” on the current field and the fields defined in “Related Fields”.
   Cascade List—refreshes the field values of a target field when the value of the triggering field changes.
   Auto Fill—defines the field values of the fields defined in “Related fields” if the expression defined in “Event Expression” evaluates to “true”.
   Auto Clear—clears the field values of the fields defined in “Related fields” if the expression defined in “Event Expression” evaluates to “true”.
   Set Visible—sets the fields defined in “Related fields” to visible if the expression defined in “Event Expression” evaluates to “true”.
   Set Invisible—sets the fields defined in “Related fields” to invisible if the expression defined in “Event Expression” evaluates to “true”.
   Bubble—display a short description in a bubble. The default text is the description of the field or button.

### 4.1.1 Regular Expressions

Regular expressions are used for field validation and data loading purposes. The following are examples of regular expressions for field validation:
[A-Z]*—text field, may be empty, uppercase only
[A-Z][a-z,0-9]*—text field; starts with an uppercase letter, followed by zero or more lower case letters or numeric characters
[1-9][0-9][0-9]−[0-9][0-9][0-9]−[0-9][0-9][0-9][0-9]—U.S. Phone Number
[1-9][0-9][0-9]−[0-9][0-9]−[0-9][0-9][0-9][0-9]—U.S. Social Security Number
[+,−]*[0-9]+.[0-9]+—decimal point number
$[0-9]+.[0-9][0-9]—dollar amount
[ ]+—field must have a value (required field)

4.2 Server Events

In some embodiments there are three types of Server events. These include attribute-based, method-based, and time-based Server events.
Attribute-Based Server Events—these events are triggered when changes are performed to Entity Property values, whether single or multi-valued. Such events can be pre-triggers (i.e., OnChanging, OnAdding, and OnRemoving) or post-triggers (i.e., OnChanged, OnAdded, and OnRemoved). That said, Attribute-based events can be used to relate Property values, monitor Property value changes, and enforce permission control.
Method-Based Server Events—these events are triggered when Entity Methods are invoked. A method-based event may be a pre-trigger or a post-trigger. That said, Method-based events can be used to override, qualify, or modify the behavior of a default method.
Time-Based Server Events—these events are triggered at a specific time. Time-based events can be used to schedule background jobs. Note that since the Data Engine (ref., section 2.2) is an in-process component that runs as part of a Web service, then time-based events can be triggered only when the Web service is active.

4.3 Schema Support

### 4.3.1 Changes to Existing Types

The following Property is added to the EntityType Type (ref, section 2.2.1.4):
Events—a list of all events for the current type.

The following Properties are added to the Attribute Type (ref, section 2.2.1.2):
OnChanging—triggered before the Property value is being modified; for both single-value and multi-value Properties.
OnChanged—triggered after the Property value is being modified; for both single-value and multi-value Properties.
OnAdding—triggered before a new element is being added to a multi-value Property value set.
OnAdded—triggered after a new element is being added to a multi-value Property value set.
OnRemoving—triggered before an element is being removed from a multi-value Property value set.
OnRemoved—triggered after an element is being removed from a multi-value Property value set.

The following Properties are modified in the Method Type:
pre trigger—triggered before the method is being invoked.
post trigger—triggered after the method is being invoked.

### 4.3.2 New Types

There may be two Entity Types to manage events. These include the EventType and EventParameterType Entity Types.
EventType—records all information about an event. This Type derives from ValueEntity, and defines the following Properties:
   SameTransaction—indicates whether the event action is executed in the same transaction as the base method.
   UponSuccess—For pre-trigger, indicates whether the base method needs to be executed if the pre-trigger fails; for post-trigger, indicates whether the post-trigger needs to be executed if the base method fails.
   Handler—event handler or event action.
   Parameters—event handler parameters.
EventParameterType—records all information about a parameter to an event handler. This Type derives from ValueEntity, and defines the following Properties:
   ParameterCategory—the parameter's category (i.e., variable, parameter name, or constant).
   Variable Type—the variable data type.
   Parameter Name—the parameter name.
   Value—the Constant value.

### 5. MULTIPLE SCHEMA SUPPORT

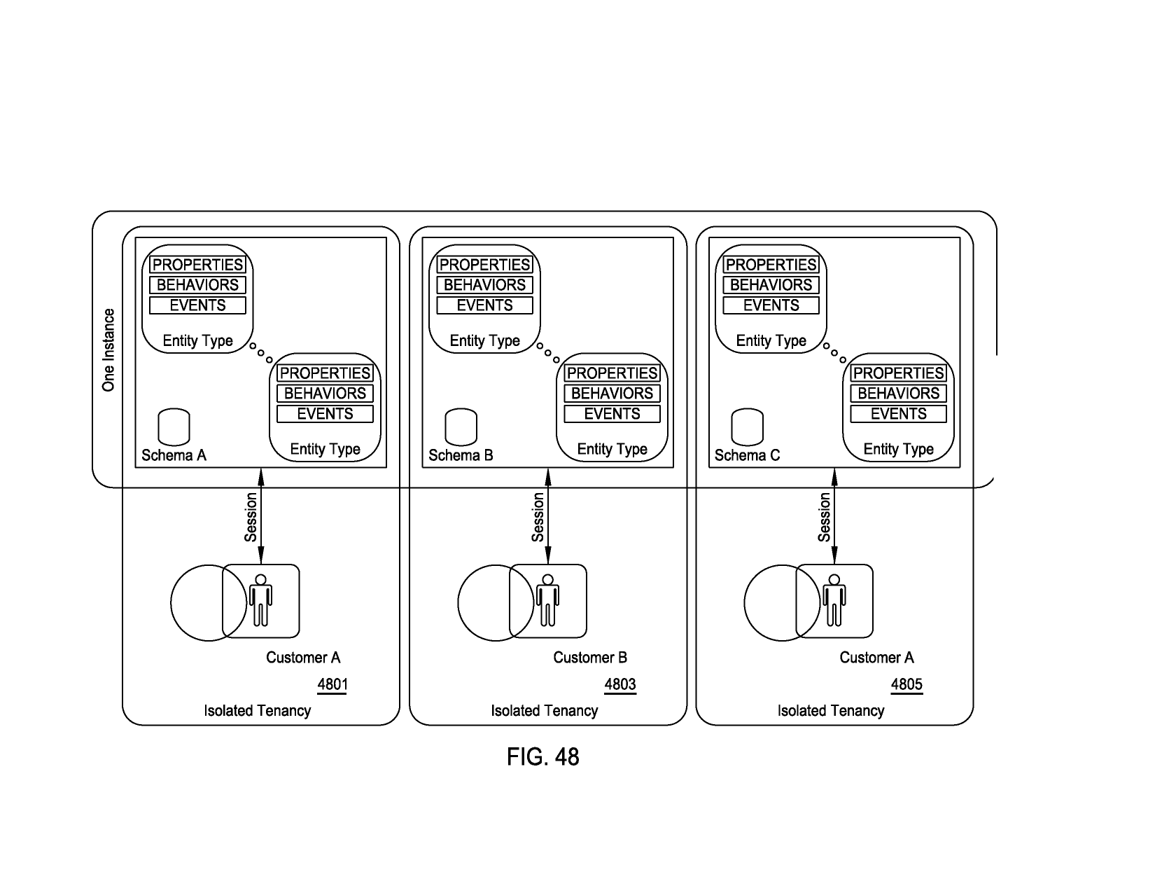

In some embodiments, Entity Type hierarchies belong to unique schemas (ref., section 2.2.1.5). Different schemas can belong to the same deployment. As shown in FIG. 48, a user establishes a session with one specific Entity Type hierarchy. Multiple customers 4801, 4803 and 4805 with distinct Business Entities, References, and Services can share the same deployment.

### 6. METHOD INVOCATION

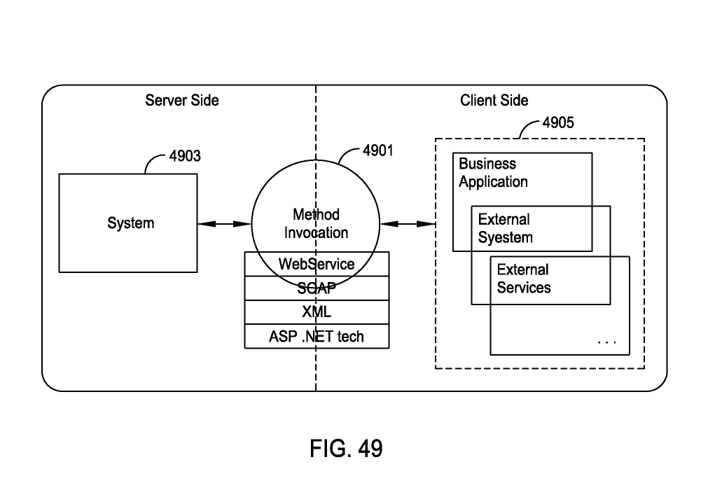

As shown in FIG. 49, in some embodiments a Method Invocation module 4901 is the only point of entry into the system 4903 and user-defined methods from the client application 4905. It defines the public interface for all client and external applications (e.g., rich clients or Web clients) and service-to-service communication.

The Method Invocation module provides encapsulation of the following areas:
Transaction Management—the Method Invocation module abstracts transaction management concerns (ref., section 2.2.7) for client applications that invoke a method through the Method Invocation API. Alternatively, when client applications must control their own transactions, then multiple method invocation requests are grouped into a batch operation and sent to the Method Invocation module. Either way, client requests cannot leave transaction boundaries open or uncommitted for the duration of a request.
Batch Operations—batch operations are used when clients need to group multiple method invocation requests within the same transaction boundary. While this enables the Universant Business Server to preserve transaction integrity, it also reduces network roundtrips between the client and server.
Client—Side Locally Callable Interface—the Method Invocation module provides an optional and limited set of client-side locally callable interfaces. The following public methods are examples of such interfaces, as defined in the EntityProxy.dll binary:

// Reload schema from the service layer
public void ReloadSchema( ) { }
// get schema entities in C# object
public Cschema GetSchema( ) { }
// Login to Web Service
public void Login(string url, string u, string p, string sc) { }
// Logoff system
public void Logoff( ) { }
// Invoke any service-side method
public CArg DispatchMethod(string typename, string mthname, CArg
arg) { }

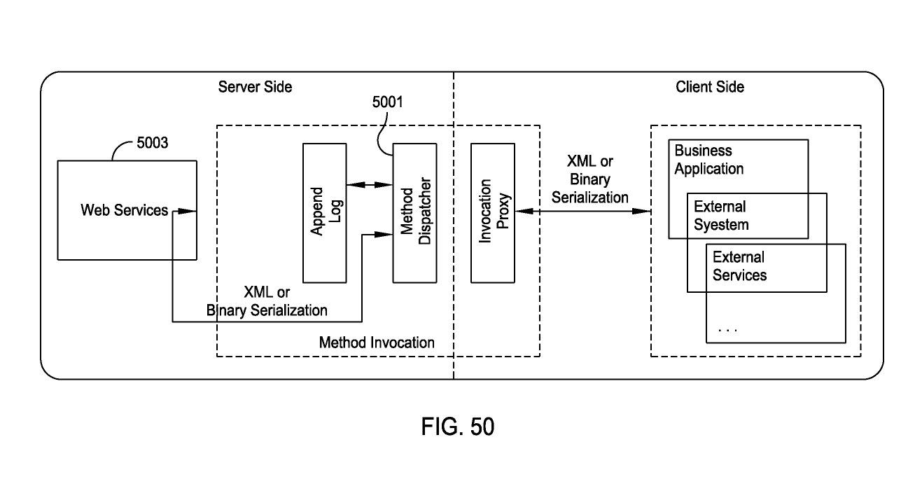

Auto-generated Client Side Method Stub—In some embodiments the code generation tool (ref, section 2.3) can optionally generate client-side method stubs that support formal argument lists, as opposed to an encapsulated CArg argument, for user-defined Entity Types.
Web Service Connectivity—Web service accessiblity is achieved through a proxy instance of a Microsoft Visual Studio .Net CWService class. In some embodiments this class code is automatically generated when a Web reference is added.
Web Method Publishing. As shown in FIG. 50, a Web method dispatcher 5001 helps limit changes in client-side proxies whenever public Web methods change. System and user-defined methods are not callable directly by the client. Instead, they are indirectly invoked by the Web method dispatcher that assures proper extensibility and flexibility of Web services 5003. The dispatcher implements the following public methods:
   Login—initiates a client session and performs an authentication check for the client session.
   public CArg Login(string username, string password, string schema) { }
   DispatchNoState—initiates a client session, performs an authentication check for the client session, invokes a service-side method, and terminates the client session.
   public CArg DispatchNoState(string username, string password, string schema, string entityName, string methodName, CArg arg)
   Dispatch—invokes a service-side method.
   public CArg Dispatch(string entityName, string methodName, CArg arg)
   Logoff—terminates a client session.
   public void Logoff(CArg arg)
Method Discovery—the method invocation module implements a method discovery mechanism used by the method dispatcher to find the appropriate service-side method and call it.
Methods are implemented in Method Entities and thus have meta-data associated with them. Method Entity Types are considered schema Entity Types and their instances reside in the schema cache at runtime. The Method Entity Type defines the following method discovery-related Properties:
   Location—the location of the method implementation.
   Typename—the Entity Type name that hosts the method.
   Name—the name of the method in the “<type name>.<method name>” format to support method overrides (note that method overloading is not allowed).
That said, when a client session invokes a service-side method, the following steps are performed:
   1. Call the Dispatch method, passing in the Entity Name, Method Name, and an argument structure, if any.
   2. Find the method's Entity using the given Entity Type name and Method name.
   3. Load into memory the assembly which name matches the Location Property value defined above-if it has not already been loaded.
   4. Loop through each Entity Type in the assembly found in the previous step using C#¹ reflection, and find an Entity Type whose name matches the Typename Property value defined above.
   5. Loop through each method in the Entity Type using C#¹ reflection and find a method whose name matches the Name Property value defined above.
   6. Call Activator.CreateInstance( ) to instantiate a C#¹ object (ref, the Method Invocations section below).
   7. Call Methodinfo.Invoke( ) to invoke the method (ref, the Method Invocations section below).
Method Timeout Interrupt—service-side method completion can sometimes take too long to complete. The Method Invocation component accounts for method execution delays and potential time-outs by allowing the client to asynchronously call the Web methods. A client session is provided with the following time-out methods:
   BeginDispatch—begins the method call.
   WaitOne—waits for a particular timeout value. If the method returns a timeout error value, then the client application can stop waiting for a Web service response.
   EndDispatch—completes the method call.
Method Invocation—In some embodiments all system and user-defined service-side public methods must share the same method signature:
   public CArg SomeMethod(CArg arg);
This common method signature assures a uniform method invocation scheme, allowing the method dispatcher to use the following code to invoke a service-side method:

object obj = Activator.CreateInstance(t);
CArg result = m.Invoke(obj, new object[ ] (arg));
return result;

In the above code, “t” is the Entity Type instance whose name matches the Typename
Property value, “m” is the Method Entity information instance whose name matches the Name Property value, and “arg” is the parameter structure provided by the caller.
The method invocation mechanism will try to locate a method entity based on the given Typename Property value. If one is not available, the invocation process will go up the Entity Type hierarchy until it finds the Method Entity with the right name.
Method Parameter & Return Transmission—service-side public methods, both system and user-defined, must use the CArg argument structure for method arguments and returns. The following details the class definition of CArg:

```
public class CArg
{
          public CCookie Cookie { get; set; }
          public ArrayList Args { get; set; }
          public long ErrorCode { get; set; }
          public string ErrorMessage { get; set; }
          public object GetParameter(string name) { }
          public void SetParameter(string name, object param) { }
}
```

The following details the Properties defined in the CArg public class:
   Cookie—used to identify the client session.
   Args—used to pass any number of parameters of any type.
   ErrorCode—an error code number that values to 0 if the method invocation is successful.
   ErrorMessage—a description of the error code generated. A message is not generated if the ErrorCode value to 0.
Method Pre-Triggers and Post-Triggers—Method Entities can define pre and post-trigger Methods. The method invocation process implements the following algorithm when calling the Dispatch method:

```
public static CArg Dispatch( )
{
          Check privilege;
          if pre-trigger is available, then call pre-trigger;
          if method is available, then call method;
          if post-trigger is available, then call post-trigger;
}
```

Integration with XML Transformation—the Method Invocation module provides the ability to transform regular and schema Entities into XML format during the roundtrip communication flow between the client and service-side layer. In contrast with Binary Serialization, an XML transformation capability makes a system agnostic to underlying platforms and format standards. That said, the Method Invocation modules implements the following public methods:
   CEntityToXML—transforms Entities into XML format file representations.
   XMLToEntity—returns Entities based on XML format file representations.
Integration with Binary Serialization—the Method Invocation module provides the ability to serialize binary C# objects into a byte array stream, in turn serializable into XML. The Method Invocation module applies binary serialization to all parameters passed between the client and service-side layer, and all method returns.
Integration with Access Control—the Access Control Enabling Service implements the Demand method to determine whether the current client request has the required permission to invoke the service-side method. The Demand method is called for in the Method Invocation's Dispatch method.

### 7. ILLUSTRATIVE EXAMPLE

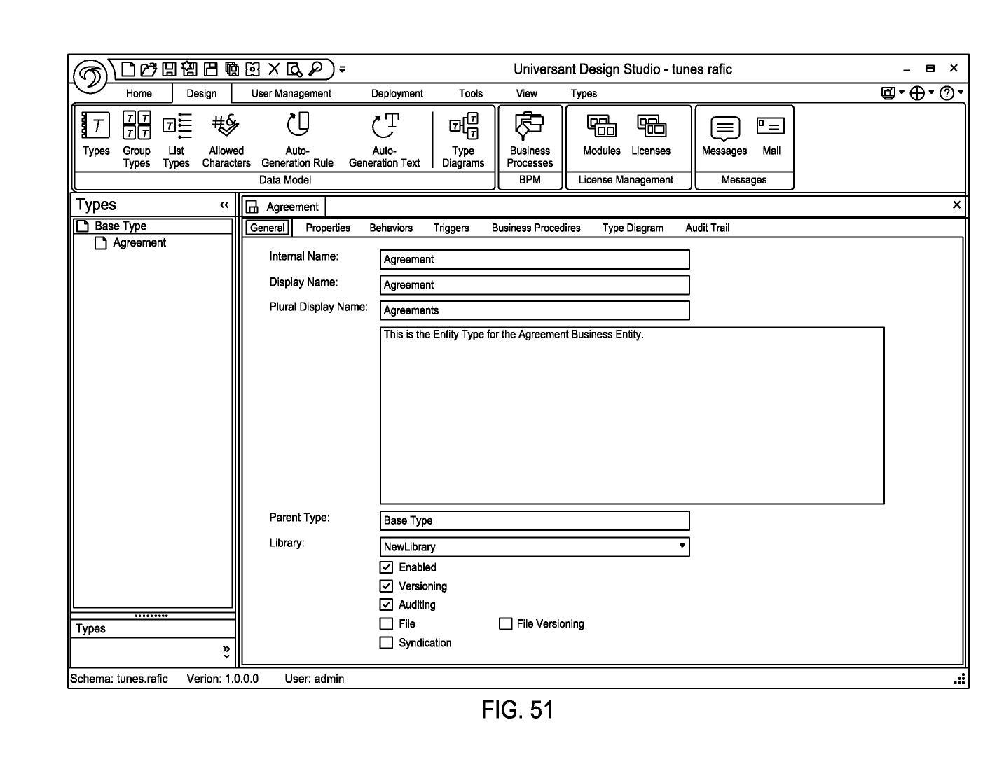

FIGS. 51 through 57 are screen shots illustrating an example of an embodiment of the invention in use. As shown in FIG. 51, the Agreement entity type, derived from its parent Base Type, is defined using the an embodiment referred to herein as the Universant Application Design Studio. The Agreement is defined with General attributes as well as Properties, Behaviors, Triggers, and Business Processes. The Agreement type is enabled. The Versioning business service and the Auditing business service are turned on.

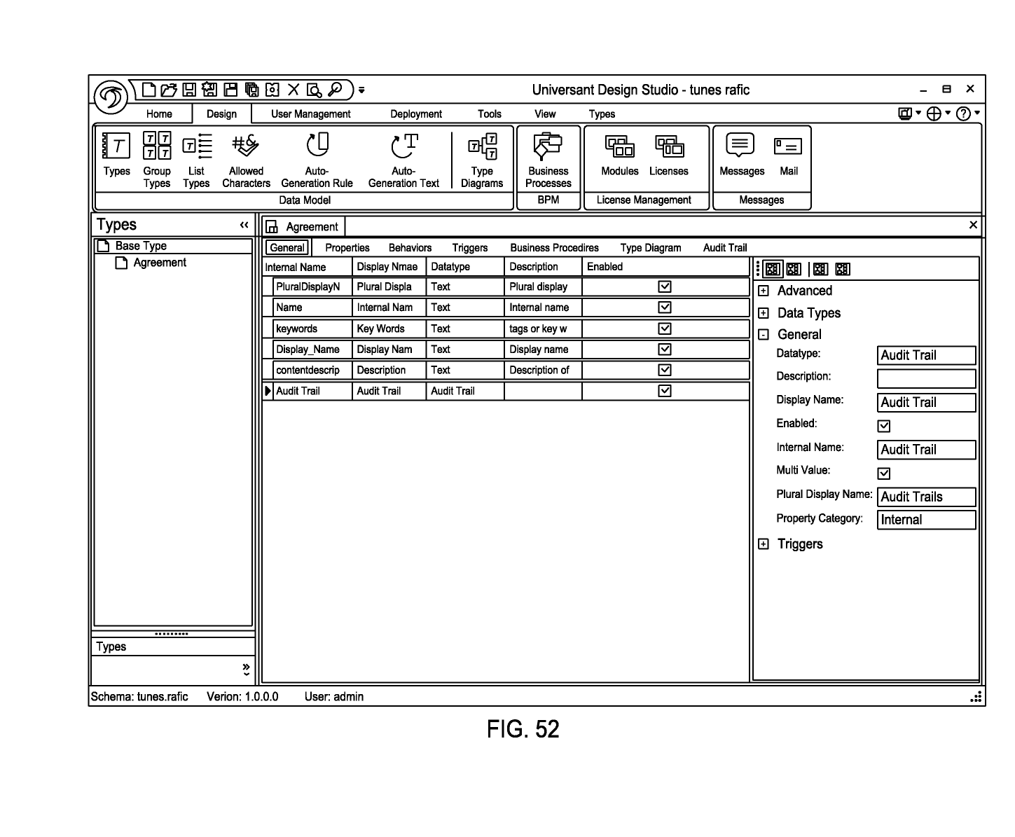

As shown in FIG. 52, the Properties of the Agreement entity type are defined using the Universant Application Design Studio. Properties have internal names that are used by the System and user-friendly Display Names that are displayed programmatically by the user of the System. The AuditTrail (of the data type “Audit Trail”) is made a property of the Agreement. Once the AuditTrail is enabled, and since the Auditing business service is turned on, every action such as Save, Save As, Edit, Checkin, Checkout and more that is taken on a particular Agreement is logged in a history audit trail.

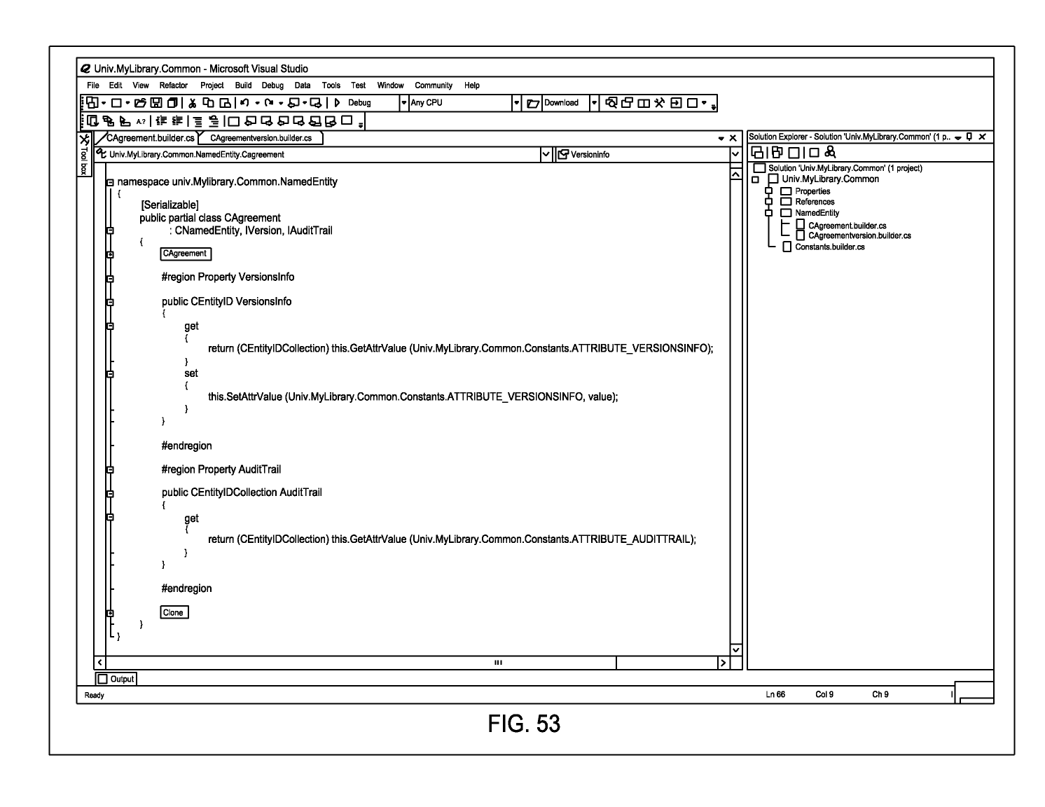

As shown in FIG. 53, the Universant Application Design studio, based on a user command, generated a programmatic interface in the form of C# APIs, giving access to the Agreement entity, its properties, behaviors, triggers, business processes, and any other business services associated with it.

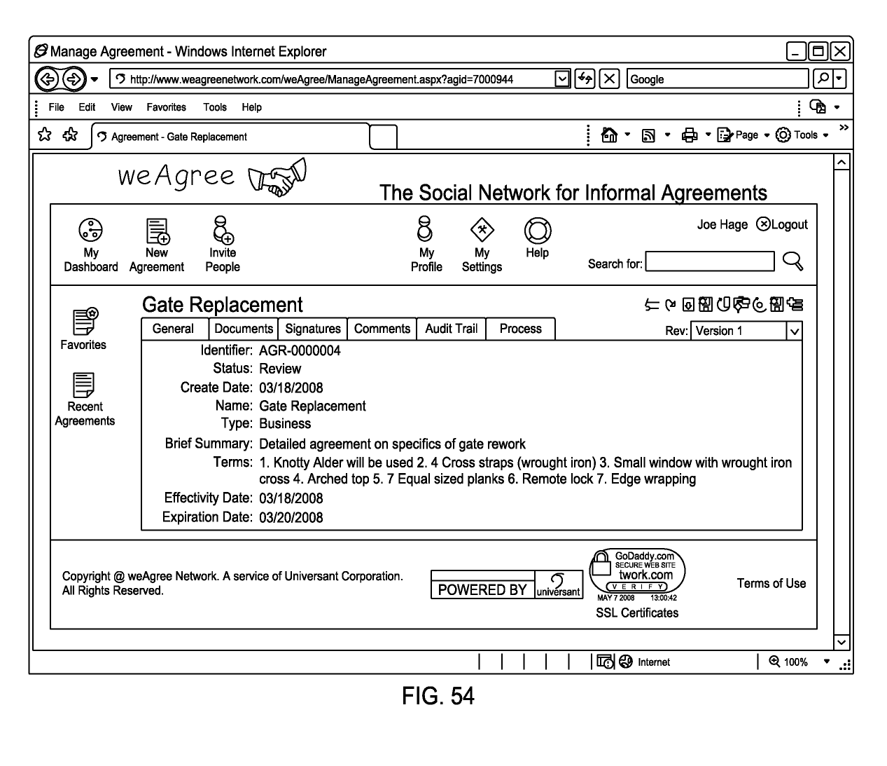

As shown in FIG. 54, the application graphical user interface is created to enable an end user to interact with a business solution that allows people to document their informal agreements. In this case of the Gate Replacement agreement, a tabbed interface is shown, with General attributes such as an Identifier, Status, Name, Brief Summary, Terms, and more. The Properties of an Agreement are defined in the Universant system and accessible by the User Interface layer through the programmatic interface. In this case, we are viewing the “Uncommited” version of the Gate Replacement agreement.

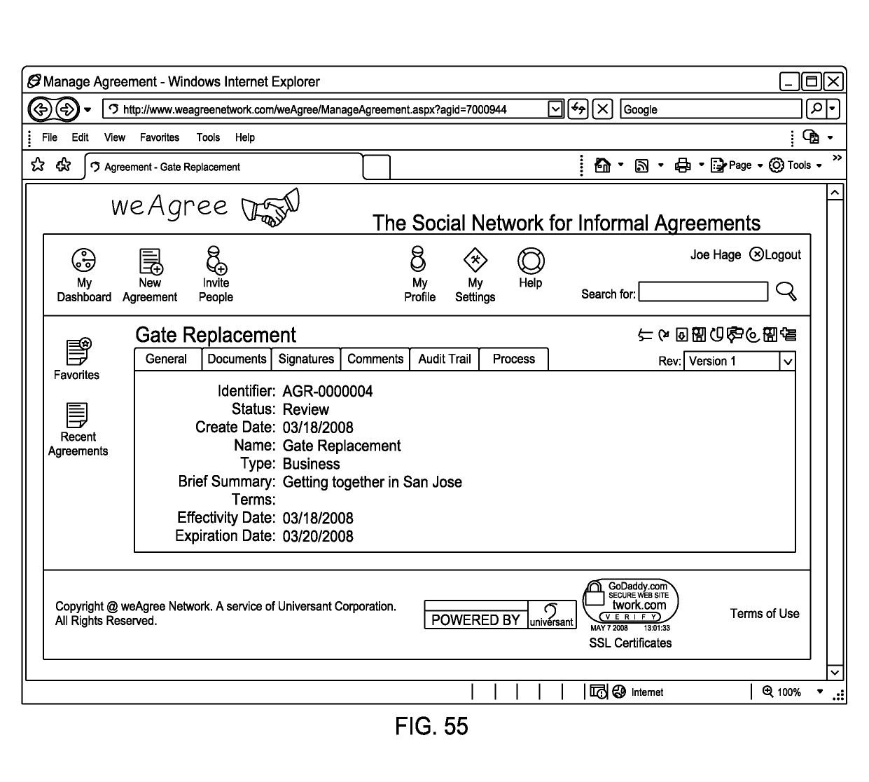

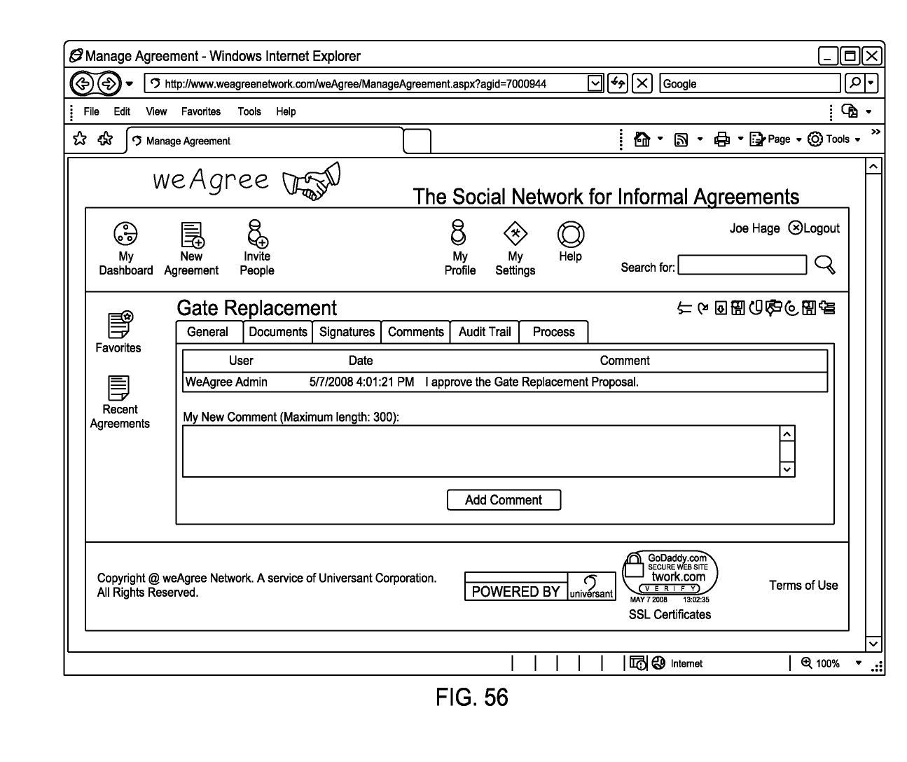

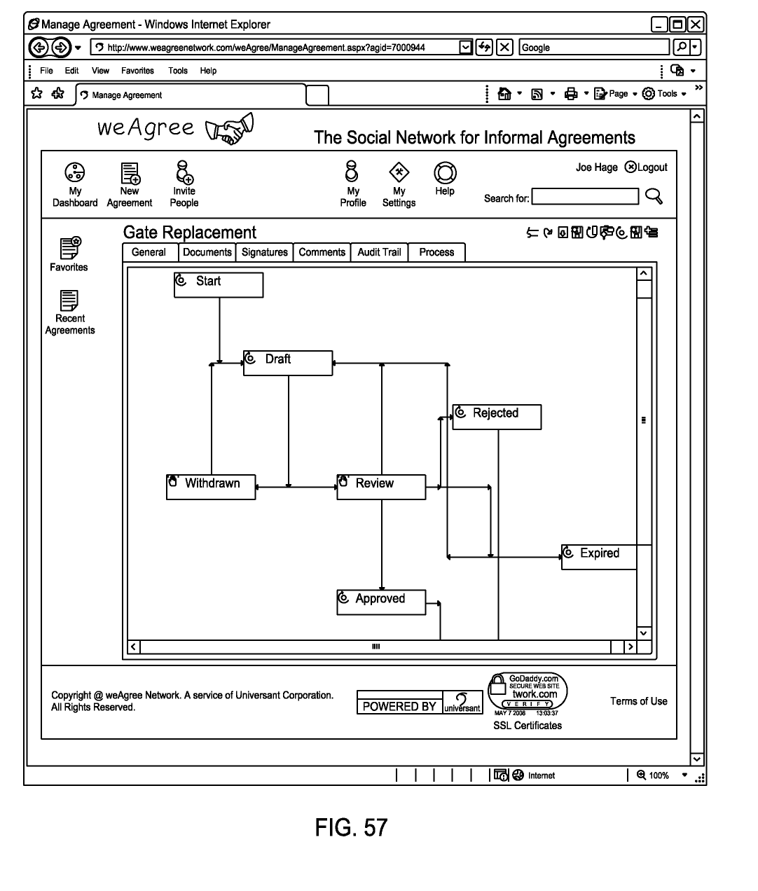

As shown in FIG. 55, the application graphical user interface is now showing “Version 1” of the Gate Replacement agreement. Note that some of the General attributes are unchanged while others, such as Brief Summary and Terms, are different between the “Uncommited” and “Version 1” versions of the Gate Replacement agreement. This is made possible because the Versioning business service was enabled on the Agreement type as shown in FIG. 51. As shown in FIG. 56, end user Comments are captured from Approvers during the execution of the business process as defined for the Gate Replacement agreement. As shown in FIG. 57, end users are sown the business process that the Gate Replacement agreement is going through as an approval workflow. The current state is REVIEW. This business process is defined by clicking on the Business Processes tab in the Universant Application Design Studio shown in FIG. 51.

### 8. GLOSSARY

The following is an alphabetically sorted glossary of terms used in this patent application:

| Term | Definition |
|---|---|
| API | See “Application Programming Interface” |
| Application | An API is a source code interface that a service provides to |
| Programming Interface | support requests made by computer programs. |
| Behavior | A set of actions that can be taken by entity or another object. |
| Business Concept | A “Contract” is a Business Concept, and the actual physical |
| | Contract you draft is a Business Entity, i.e., an instance of the |
| | “Contract” Business Concept. |
| Business Entity | A conceptual representation of objects that are used in |
| | operational contexts. For example, a “Contract” is a Business |
| | Concept, and the actual physical Contract a lawyer drafts is a |
| | Business Entity, i.e., an instance of the “Contract” Business |
| | Concept. |
| Business Service | A set of operations that can be attributed to Business Concepts. |
| | “Routing” and “Auditing” are examples of Business Services. |
| | A “Contract” Business Concept now has value because its |
| | attached Business Services make it useful. Existing Business |
| | Services can be extended, or new ones can be added. |
| Concept | A well-defined understanding of a model in a given context. A |
| | Concept is An Entity is a granular representation—an |
| | instance—of a Concept. In that respect, a “Contract” is a |
| | Business Concept, and the actual physical Contract you draft is |
| | a Business Entity, i.e., an instance of the “Contract” Business |
| | Concept. |
| Enabling Service | An operation that can be performed on a Business Entity is |
| | defined in a set of Enabling Services. Enabling Services |
| | embody different operational capabilities, such as Auditing, |
| | Versioning, Workflow, and Access Control. Existing enabling |
| | Services can be extended, or new ones can be added. |
| Entity | An Entity is of little value when defined alone. Services are |
| | attributed to Entities in order for the latter to generate value. |
| Event | An action which can be initiated by an entity, or other objects. |
| | The application's business logic may ignore the event or handle |
| | certain types of events with event handlers which are relevant to |
| | the application. |
| eXtensible Markup | XML is a general-purpose specification for creating custom |
| Language | markup languages. XML is classified as an extensible language |
| | because it allows its users to define their own elements. Its |
| | primary purpose is to facilitate the sharing of structured data |
| | across different information systems, particularly via the |
| | Internet, and it is used both to encode documents and to |
| | serialize data. |
| HTTP | See “HyperText Transfer Protocol” |
| HTTPS | See “HyperText Transfer Protocol Secure” |
| Hyper Text Transfer | HTTPS is identical to HTTP with an encryption/authentication |
| Protocol Secure | layer. |
| HyperText Transfer | HTTP is a communications protocol for the transfer of |
| Protocol | information on intranets and the World Wide Web. Its original |
| | purpose was to provide a way to publish and retrieve hypertext |
| | pages over the Internet. |
| Property | Data used to describe the attributes of a type, an entity, or other |
| | objects. |
| Simple Object Access | A protocol for exchanging XML-based messages over |
| Protocol | computer networks, normally using HTTP/HTTPS. SOAP |
| | forms the foundation layer of the Web services protocol stack |
| | providing a basic messaging framework upon which abstract |
| | layers can be built. |
| SOAP | See “Simple Object Access Protocol” |
| Type System | The foundation layer that enables users to transform abstract |
| | business concepts into self-contained and maintainable |
| | Business Entities that can, in turn, benefit from numerous |
| | system-predefined and user-defined services. |
| UADS | See “Universant Application Design Studio” |
| Universant Application | An application that enables a business analyst to design, model, |
| Design Studio | develop, and deploy a business application. |
| Universant Business | The Universant Business Server implements Business Concepts |
| Server | within a Type System. At its core is a set of Enabling Services |
| | to support the creation and extension of Business Services, and |
| | an integration framework that dynamically creates inherent |
| | relations across all Business Components, Enabling Services |
| | and Business Services within the Business Server. The Business |
| | Server includes embodiments of the invention. |
| Web Service | A software system designed to support interoperable Machine |
| | to Machine interaction over a network. Web services are |
| | frequently just Web Application Programming Interfaces that |
| | can be accessed over a network, such as the Internet, and |
| | executed on a remote system hosting the requested services. |
| XML | See “eXtensible Markup Language” |

### 9. REFERENCES

The following are the documents filed with the Provisional Patent on May 10, 2007.
DMS000041—Software Design specification (Master)
DMS000042—Software Design Specification (Type System)
DMS000043—Software Design Specification (Data Engine)
DMS000044—Software Design Specification (Rule Engine)
DMS000045—Software Design Specification (Access Control)
DMS000046—Software Design Specification (Localization)
DMS000047—Software Design Specification (Method Invocation)
DMS000048—Software Design Specification (Notification)
DMS000049—Software Design Specification (Resources)
DMS000050—Software Design Specification (Search Engine)
DMS000051—Software Design Specification (Traceability)
DMS000052—Software Design Specification (Document Management)
DMS000053—Software Design Specification (File Management)
DMS000054—Software Design Specification (Version Control)
DMS000055—Software Design Specification (Workflow)
DMS000056—Software Design Specification (Code Generation)
DMS000063—Event Management
DMS000066—Universant Application Component API Documentation
DMS000068—Software Design Specification (Container Management)

We claim:

1. A method of developing a programmatic interface comprising:
defining an application framework that includes a plurality of property, behavior and event elements;
creating in the application framework a plurality of enabling services each being a conceptual representation of an operational capability, each such service including among its characteristics at least one of said plurality of elements;
creating in the application framework a plurality of system entities each being a conceptual representation of an object, each such entity including among its characteristics at least one of said plurality of elements;
including said services and entities among said plurality of elements such that any of said services and entities can include among its characteristics any other of said services and entities;
providing in the application framework a user interface that enables a user to:
define a plurality of business entities each of which can include among its characteristics any of said plurality of elements,
include any such business entity among said plurality of elements whereby such business entity can be included as a characteristic of any other business entity defined by the user, and
define relationships among any business entities defined by the user and any of the plurality of elements; and
generating a software application that includes the user-defined relationships and business entities and their characteristic elements so as to provide the programmatic interface.

2. In a computer system, an environment for developing a programmatic interface comprising:
a plurality of predefined enabling services in the computer system, each such service being a conceptual representation of an operational capability, each such service having at least one element selected from among a plurality of properties, behaviors and events;
a plurality of predefined system entities in the computer system, each such entity being a conceptual representation of an object, each such entity having at least one element selected from among said plurality of properties, behaviors and events, the predefined system entities and enabling services themselves being among said plurality of properties, behaviors and events such that any of such entities and services can include as one of its elements any other such entity and service;
a user interface in the computer system, the user interface including a feature by which a user can define a business entity that has at least one element selected from among said plurality of properties, behaviors and events and that once defined can itself be included among said plurality of properties, behaviors and events;
a feature in the user interface by which the user can define a relationship between any business entity defined by the user and any of the plurality of properties, behaviors and events; and
an engine that generates a software application implementing any business entities and relationships defined by the user in the programmatic interface.
